(19) United States
(12) Patent Application Publication
(10) Pub. No.: US 2026/0128315 A1
(43) Pub. Date: May 7, 2026

(54) DISPERSANT POLYMER FOR NON-AQUEOUS SECONDARY BATTERY, COMPOSITION FOR NON-AQUEOUS SECONDARY BATTERY, SHEET FOR ALL-SOLID-STATE SECONDARY BATTERY AND ALL-SOLID-STATE SECONDARY BATTERY, AND MANUFACTURING METHOD OF SHEET FOR ALL-SOLID-STATE SECONDARY BATTERY AND ALL-SOLID-STATE SECONDARY BATTERY

(71) Applicant: FUJIFILM Corporation, Tokyo (JP)

(72) Inventors: Koji YASUDA, Kanagawa (JP); Yuzo Nagata, Kanagawa (JP); Ikuo Kinoshita, Kanagawa (JP)

(73) Assignee: FUJIFILM Corporation, Tokyo (JP)

(21) Appl. No.: 19/424,174

(22) Filed: Dec. 18, 2025

Related U.S. Application Data
(63) Continuation of application No. PCT/JP2024/023136, filed on Jun. 26, 2024.

(30) Foreign Application Priority Data
Jun. 30, 2023 (JP) 2023-108490

(51) Int. Cl. H01M 4/62; C08G 81/02; H01M 4/02; H01M 4/38; H01M 4/525; H01M 10/0562; H01M 10/058

(52) U.S. Cl. CPC H01M 4/622; C08G 81/028; H01M 4/386; H01M 4/525; H01M 4/625; H01M 10/0562; H01M 10/058; H01M 2004/027; H01M 2004/028

(57) ABSTRACT

Provided are a dispersant polymer for a non-aqueous secondary battery, which has a constitutional component (X) including a polymerized chain and having a molecular weight of 400 or more, in which a viscosity at a temperature of 25° C. and a shear rate of 1 s⁻¹ is 0.10 to 10,000 Pa·s; a composition for a non-aqueous secondary battery containing the dispersant polymer for a non-aqueous secondary battery; a sheet for an all-solid-state secondary battery and an all-solid-state secondary battery; and a manufacturing method of a sheet for an all-solid-state secondary battery and an all-solid-state secondary battery.

### CROSS-REFERENCE TO RELATED APPLICATIONS

This application is a Continuation of PCT International Application No. PCT/JP2024/023136 filed on Jun. 26, 2024, which claims priority under 35 U.S.C. § 119 (a) to Japanese Patent Application No. 2023-108490 filed in Japan on Jun. 30, 2023. Each of the above applications is hereby expressly incorporated by reference, in its entirety, into the present application.

### BACKGROUND OF THE INVENTION

### 1. Field of the Invention

The present invention relates to a dispersant polymer for a non-aqueous secondary battery, a composition for a non-aqueous secondary battery, a sheet for an all-solid state secondary battery and an all-solid-state secondary battery, and a manufacturing method of a sheet for an all-solid-state secondary battery and an all-solid-state secondary battery.

### 2. Description of the Related Art

A non-aqueous electrolyte secondary battery (also referred to as a non-aqueous secondary battery) is a storage battery which includes a negative electrode, a positive electrode, and a non-aqueous solution-based electrolyte between the negative electrode and the positive electrode, and is capable of charging and discharging by the reciprocal migration of specific metal ions such as lithium ions between both electrodes. As such a non-aqueous secondary battery, a non-aqueous electrolytic solution secondary battery which uses an organic electrolytic solution, and an all-solid-state secondary battery which uses a solid electrolyte layer are used in a wide range of use applications. In particular, in the all-solid-state secondary battery, all of the negative electrode, the electrolyte, and the positive electrode consist of solid, and the non-aqueous electrolytic solution secondary battery can greatly improve safety and reliability, which are said to be problems to be solved in a secondary battery in which an organic electrolytic solution is used. It is also said to be capable of extending battery life. Furthermore, the all-solid-state secondary battery can be provided with a structure in which the electrodes and the solid electrolyte are directly arranged in series. Therefore, with the all-solid-state secondary battery, it is possible to highly increase the energy density as compared with a non-aqueous electrolytic solution secondary battery, and thus the application to an electric vehicle or a large-sized storage battery is expected.

In consideration of improving productivity and the like, a constituent layer (an electrode layer of a negative electrode active material layer and a positive electrode active material layer) in the non-aqueous electrolytic solution secondary battery and a constituent layer (a solid electrolyte layer, a negative electrode active material layer, a positive electrode active material layer, and the like) in the all-solid-state secondary battery are usually formed of a composition (constituent layer-forming material) containing a raw material compound constituting each layer, such as an active material and an inorganic solid electrolyte, a dispersant dispersing the raw material compound, a binder binding the raw material compound, and the like. Therefore, studies on the dispersant, the binder, and the constituent layer-forming material have been carried out.

For example, JP2022-071849A discloses a (meth)acrylic polymer having a hydroxy group, which improves dispersibility of graphene used in combination with a positive electrode active material for the purpose of improving the battery service life of a lithium ion battery, and a graphene dispersion liquid containing the same. That is, JP2022-071849A discloses a graphene dispersion liquid containing, with respect to 100 parts by weight of graphene having an average thickness of 0.3 nm or more and 10 nm or less and a dispersion medium, a (meth)acrylic polymer having a hydroxy group in a proportion of 10 parts by weight or more and 300 parts by weight or less, in which a viscosity at a temperature of 25° C. and a shear rate of 1.0 s⁻¹ is 0.1 Pa·s or more and 100 Pa or less. Specifically, a (meth)acrylic polymer-10 obtained by copolymerizing 2-hydroxyethyl methacrylate, BLEMMER PME-200, ethylhexyl acrylate, and acrylic acid is disclosed as the (meth)acrylic polymer.

WO2023/068237A discloses “an inorganic solid electrolyte-containing composition containing: an inorganic solid electrolyte having an ion conductivity of a metal belonging to Group 1 or Group 2 in the periodic table; a polymer binder; and a dispersion medium, in which the polymer binder includes a graft polymer having a mass average molecular weight of 1,000 to 30,000 and dissolves in the dispersion medium, where graft polymer has a constitutional component (A) that contains at least one functional group of an amide group, an imide group, or a sulfonamide group, in a molecular chain that serves as a side chain of the polymer”.

### SUMMARY OF THE INVENTION

As described above, since the constituent layer of the non-aqueous electrolytic solution secondary battery and the all-solid-state secondary battery is formed of solid particles (active material, conductive auxiliary agent, inorganic solid electrolyte, and the like), an interfacial contact state between the solid particles and an interfacial contact state between the solid particles and the collector are restricted, and as a result, an interface resistance is likely to increase. The increase in the interface resistance causes not only an increase in the battery resistance of the all-solid-state secondary battery (decrease in ion conductivity) but also degradation of the solid particles due to overcurrent generated during discharge, which also causes a decrease in the cycle characteristics.

The increase in the interface resistance, which is a factor in the decrease in the battery characteristics, is caused not only by the interfacial contact state of the solid particles but also by the characteristics of the constituent layer-forming material. Therefore, the constituent layer-forming material is required to have characteristics (dispersion stability; also referred to as storage stability in the present invention) of stably maintaining excellent dispersibility (initial dispersibility) of the solid particles immediately after preparation (initial) and being able to be dispersed again into an excellent dispersion state immediately after preparation even in a case where the solid particles aggregate or precipitate.

Here, the dispersibility of the solid particles can be improved by increasing the dispersion energy applied in a case of dispersing the solid particles in the dispersion medium, and more specifically, by increasing a treatment time (dispersion time) in a case of dispersing the solid particles in the dispersion medium. In addition, from the viewpoint of improving productivity and reducing manufacturing costs, a constituent layer-forming material having a high concentration of solid contents such as solid particles (thickening of a slurry) is desired, but in order to improve the dispersibility of the solid particles in the constituent layer-forming material having a high concentration of solid contents, it is necessary to further increase the dispersion energy, and it is impossible to avoid increasing the dispersion time. However, in a case where the dispersion time is increased, a large load is applied to the solid particles during the dispersion, and for example, damage such as degradation and decomposition of the solid particles proceeds, which causes the increase in the interface resistance.

In addition, in recent years, research and development of high performance and practicality of electric vehicles have been rapidly progressing, and the performance required for the non-aqueous secondary battery has also been increasing. Therefore, a dispersant which improves the initial dispersibility and the dispersion stability (hereinafter, may be referred to as “dispersion characteristics”) of the solid particles while reducing the dispersion energy or the load during the dispersion is required for the constituent layer-forming material.

However, in the constituent layer-forming material and the dispersant in the related art, studies on reducing the load applied to the solid particles during mixing from the above-described viewpoint have not been carried out.

An object of the present invention is to provide a dispersant polymer for a non-aqueous secondary battery, which can prepare a composition for a non-aqueous secondary battery, having excellent dispersion characteristics of solid particles while shortening a dispersion time of the solid particles, and a composition for a non-aqueous secondary battery containing the dispersant polymer for a non-aqueous secondary battery. Another object of the present invention is to provide a sheet for an all-solid-state secondary battery and an all-solid-state secondary battery, using the composition for a non-aqueous secondary battery. Still another object of the present invention is to provide a manufacturing method of a sheet for an all-solid-state secondary battery and an all-solid-state secondary battery, using the composition for a non-aqueous secondary battery.

As a result of various studies on the constituent layer-forming material and the dispersant of the solid particles, the present inventors have found that, in a case where a polymer which has, as an essential constitutional component, an constitutional component (X) having a molecular weight of 400 or more and including a polymerized chain is adopted as the dispersant used in combination with the solid particles in a case of preparing the constituent layer-forming material, and a viscosity at a temperature of 25° C. and a shear rate of 1 s⁻¹ is set to a range of 0.10 to 10,000 Pa·s, a dispersion time required to achieve the desired dispersion characteristics of the solid particles can be shortened. In addition, the present inventors have found that, by using the composition for a non-aqueous secondary battery containing the specific polymer as the constituent layer-forming material, a sheet for a non-aqueous secondary battery, having a constituent layer with low resistance, and a non-aqueous secondary battery having excellent cycle characteristics and low resistance can be realized. The present invention has been completed by further repeating studies on the basis of the above-described finding.

That is, the above-described object has been achieved by the following method.

<1> A dispersant polymer for a non-aqueous secondary battery, comprising:
a constitutional component (X) which includes a polymerized chain and has a molecular weight of 400 or more,
in which a viscosity at a temperature of 25° C. and a shear rate of 1 s⁻¹ is 0.10 to 10,000 Pa·s.

<2> The dispersant polymer for a non-aqueous secondary battery according to <1>, further comprising:
a constitutional component (A) which has at least one polar functional group of the following group (a) of functional groups,
(Group (a) of functional groups)
a sulfonic acid group, a phosphoric acid group, a phosphonic acid group, a hydroxy group, a carboxy group, an oxetane group, an epoxy group, a dicarboxylic acid group, a thiol group, an ether group, a thioether group, a thioester group, an ester group, an amide group, a urethane group, a urea group, an imide group, a fluoroalkyl group, and salts of these groups.

<3> The dispersant polymer for a non-aqueous secondary battery according to <1> or <2>,
in which an SP value of a polymer chain in the dispersant polymer for a non-aqueous secondary battery is 15.0 to 25.0 MPa^{1/2}.

<4> The dispersant polymer for a non-aqueous secondary battery according to any one of <1> to <3>,
in which the dispersant polymer has a multibranched structure having a core portion and at least three polymeric arm portions.

<5> The dispersant polymer for a non-aqueous secondary battery according to any one of <1> to <4>,
in which the dispersant polymer is a multibranched polymer represented by Formula (1),

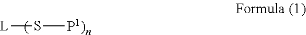

in Formula (1), L represents an n-valent linking group,
P¹ represents a polymer chain, where n pieces of P¹'s may be the same or different from each other, and
n represents an integer of 3 or more.

<6> A composition for a non-aqueous secondary battery, comprising:
the dispersant polymer for a non-aqueous secondary battery according to any one of <1> to <5>.

<7> The composition for a non-aqueous secondary battery according to <6>, further comprising:
an inorganic solid electrolyte having ionic conductivity of a metal belonging to Group 1 or Group 2 in the periodic table.

<8> The composition for a non-aqueous secondary battery according to <7>, in which the inorganic solid electrolyte is a sulfide-based inorganic solid electrolyte.

<9> The composition for a non-aqueous secondary battery according to any one of <6> to <8>, further comprising:
an active material.

<10> A sheet for an all-solid-state secondary battery, comprising:
a layer formed of the composition for a non-aqueous secondary battery according to any one of <6> to <9>.

<12> An all-solid-state secondary battery comprising, in the following order:
a positive electrode active material layer;
a solid electrolyte layer; and
a negative electrode active material layer,
in which at least one of the positive electrode active material layer, the solid electrolyte layer, or the negative electrode active material layer is a layer formed of the composition for a non-aqueous secondary battery according to any one of <6> to <9>.

<13> A manufacturing method of a sheet for an all-solid-state secondary battery, comprising:
forming the composition for a non-aqueous secondary battery according to any one of <6> to <9> into a film.

<14> A manufacturing method of an all-solid-state secondary battery, comprising:
manufacturing an all-solid-state secondary battery through the manufacturing method according to <13>.

According to the present invention, it is possible to provide a dispersant polymer for a non-aqueous secondary battery, which can prepare a composition for a non-aqueous secondary battery, having excellent dispersion characteristics of solid particles while shortening a dispersion time of the solid particles, and a composition for a non-aqueous secondary battery containing the dispersant polymer for a non-aqueous secondary battery. In addition, according to the present invention, it is possible to provide a sheet for an all-solid-state secondary battery and an all-solid-state secondary battery, using the composition for a non-aqueous secondary battery. Furthermore, according to the present invention, it is possible to provide a manufacturing method of a sheet for an all-solid-state secondary battery and an all-solid-state secondary battery, using the composition for a non-aqueous secondary battery.

The above-described and other features and advantages of the present invention will become more apparent from the following description, appropriately referring to the accompanying drawing.

### BRIEF DESCRIPTION OF THE DRAWINGS

FIG. 1 is a vertical cross-sectional view schematically showing an all-solid-state secondary battery according to a preferred embodiment of the present invention.

FIG. 2 is a vertical cross-sectional view schematically showing a coin-type all-solid-state secondary battery produced in Examples.

### DESCRIPTION OF THE PREFERRED EMBODIMENTS

In the present invention, in a case where a numerical range is shown to describe a content, physical properties, or the like of a component, any upper limit value and any lower limit value can be appropriately combined to obtain a specific numerical range in a case where an upper limit value and a lower limit value of the numerical range are described separately. On the other hand, in a case where a numerical range expressed using “to” is described by setting a plurality of numerical ranges, the upper limit value and the lower limit value forming the numerical range are not limited to a specific numerical range before and after “to” in a specific combination, and the upper limit value and the lower limit value of each numerical range can be appropriately combined. In the present invention, a numerical range represented by using “to” means a range including numerical values described before and after “to” as a lower limit value and an upper limit value.

In the present invention, an expression of a compound (for example, in a case where a compound is represented by an expression with “compound” added to the end) refers to not only the compound itself but also a salt or an ion thereof. In addition, the expression also refers to a derivative obtained by modifying a part of the compound, for example, by introducing a substituent into the compound within a range where the effect of the present invention is not impaired.

In the present invention, (meth)acryl means one or both of acryl and methacryl. The same applies to (meth)acrylate.

In the present invention, a substituent, a linking group, or the like (hereinafter, referred to as a substituent or the like), which is not specified regarding whether to be substituted or unsubstituted, may have an appropriate substituent. Accordingly, even in a case where a YYY group is simply described in the present invention, this YYY group includes not only an aspect having a substituent but also an aspect not having a substituent. The same is applied to a compound which is not specified regarding whether to be substituted or unsubstituted. Preferred examples of the substituent include a substituent Z described later.

In the present invention, in a case where a plurality of substituents or the like represented by a specific reference numeral are present or a plurality of substituents or the like are simultaneously defined, the respective substituents or the like may be the same or different from each other. In addition, unless specified otherwise, in a case where a plurality of substituents or the like are adjacent to each other, the substituents may be linked or fused to each other to form a ring.

In the present invention, the polymer means a polymeric substance.

In the present invention, the main chain of the polymer (including a polymerized chain) and the polymer chain refers to all molecular chains constituting the polymer which is a linear molecular chain that can be regarded as branched chains or pendant groups with respect to the main chain. Although it depends on a weight-average molecular weight of a branch chain regarded as the branched chain or the pendant group, the longest chain among the molecular chains constituting the polymer is typically the main chain. However, the main chain does not include a terminal group included in the terminal of the polymer. On the other hand, the side chain of the polymer refers to a branched chain other than the main chain, and includes a short chain and a long chain (graft chain). The terminal group of the polymer is not particularly limited, and an appropriate group can be adopted depending on a polymerization method or the like. Examples of the terminal group include a hydrogen atom, an alkyl group, an aryl group, a hydroxy group, and a residue of a polymerization initiator.

### [Dispersant Polymer for Non-Aqueous Secondary Battery]

The dispersant polymer for a non-aqueous secondary battery according to the embodiment of the present invention (hereinafter, may be simply referred to as “polymer according to the embodiment of the present invention”) contains a constitutional component (X) which includes a polymerized chain and has a molecular weight of 400 or more, in which a viscosity at a temperature of 25° C. and a shear rate of 1 s⁻¹ is 0.10 to 10,000 Pa·s.

Even in a case where a concentration of solid contents of the composition for a non-aqueous secondary battery (constituent layer-forming material) to be prepared is increased, the polymer according to the embodiment of the present invention can disperse solid particles in a dispersion medium in a short time, and can reduce a dispersion energy and a load applied to the solid particles during the dispersion, thereby suppressing, for example, damage such as degradation and decomposition of the solid particles. As a result, the polymer according to the embodiment of the present invention can realize a composition for a non-aqueous secondary battery having excellent dispersion characteristics of solid particles, and further having excellent characteristics (handleability) of being able to form a favorable coating film having a moderate viscosity and high fluidity. In a case where the excellent composition for a non-aqueous secondary battery is used as the constituent layer-forming material, a sheet for a non-aqueous secondary battery having a constituent layer with low resistance (high conductivity), and further preferably flat surface properties, and a non-aqueous secondary battery having low resistance and excellent cycle characteristics can be realized.

As described above, the polymer according to the embodiment of the present invention functions as a dispersant which disperses the solid particles in the dispersion medium while reducing the load applied to the solid particles and shortening the dispersion time in the preparation of the composition for a non-aqueous secondary battery. That is, the dispersant polymer for a non-aqueous secondary battery according to the embodiment of the present invention can be a dispersant which contains a polymer having a constitutional component (X) including a polymerized chain and having a molecular weight of 400 or more, and has a viscosity of 0.10 to 10,000 Pa·s at a temperature of 25° C. and a shear rate of 1 s⁻¹.

In addition, the polymer according to the embodiment of the present invention can also function as a binder which adsorbs to the solid particles to bind the solid particles and further binds the collector and the solid particles in the constituent layer formed of the composition for a non-aqueous secondary battery. In the composition for a non-aqueous secondary battery, the polymer according to the embodiment of the present invention may or may not have a function of binding the solid particles. The adsorption of the polymer according to the embodiment of the present invention to the solid particles includes not only physical adsorption but also chemical adsorption (adsorption by chemical bond formation, adsorption by electron transfer, and the like).

The polymer according to the embodiment of the present invention, which exhibits the above-described excellent action and effect, can be preferably used as a constituent layer-forming material of a sheet for a non-aqueous secondary battery (including an electrode sheet for a non-aqueous secondary battery) or a non-aqueous secondary battery.

### <Polymer According to Embodiment of Present Invention>

First, constitutional components of the polymer according to the embodiment of the present invention will be described.

The polymer according to the embodiment of the present invention contains a constitutional component (X) including a polymerized chain and having a molecular weight of 400 or more.

### Constitutional Component (X)

The constitutional component (X) of the polymer according to the embodiment of the present invention is a constitutional component including a polymerized chain, and is a constitutional component having a molecular weight of 400 or more. In the present invention, in a case where a constitutional component having a molecular weight of 400 or more includes a polymerized chain and has a polar functional group included in a group (a) of functional groups, which is defined by the constitutional component (A) described later, the constitutional component is regarded as the constitutional component (X). The constitutional component (X) is preferably a constitutional component having no polar functional group, and one of preferred aspects is, for example, that the constitutional component has no polar functional group in a partial structure other than the polymerized chain. By having the constitutional component (X), the polymer according to the embodiment of the present invention can increase an excluded volume effect between the polymers according to the embodiment of the present invention, and can achieve excellent dispersion characteristics even in a case where the dispersibility of the solid particles is improved and the dispersion time is shortened.

In the constitutional component (X), the polymerized chain may be included in a partial structure which is a main chain of the polymer according to the embodiment of the present invention, but is preferably included in a molecular chain which is a side chain of the polymer according to the embodiment of the present invention, and for example, more preferably incorporated into the inside or the terminal of the molecular chain which is a side chain of the polymer according to the embodiment of the present invention. Such a constitutional component (X) can incorporate a graft structure into the chemical structure of the polymer according to the embodiment of the present invention, and can increase the above-described excluded volume effect.

In the present invention, the molecular chain which is a side chain of the polymer according to the embodiment of the present invention refers to a molecular chain constituting the side chain of the polymer according to the embodiment of the present invention in which the constitutional component (X) is incorporated, and is a molecular chain other than a molecular chain constituting the main chain of the polymer according to the embodiment of the present invention, usually a molecular chain bonded to the molecular chain (atomic group) constituting the main chain.

The type of the polymerized chain included in one constitutional component (X) may be at least one type, and is preferably one type or two types. In addition, the number of polymerized chains included in one constitutional component (X) is not particularly limited, but is usually 1.

Examples of the constitutional component (X) include a constitutional component derived from a polycondensable compound having a polycondensable group and a polymerized chain. The polycondensable group is appropriately determined depending on the main chain structure of the polymer according to the embodiment of the present invention. For example, in a case where the polymer according to the embodiment of the present invention is a step-polymerization polymer, a condensable functional group is selected, and in a case where the polymer according to the embodiment of the present invention is a chain-polymerization polymer, a polymerizable group (ethylenically unsaturated group) is selected. In a case where the polymer according to the embodiment of the present invention is a multibranched polymer having a core portion described later, in addition to the above, examples of the polycondensable group include a reactive group for a sulfanyl group, such as an ethylenically unsaturated group capable of a thiol-ene reaction or a radical polymerization, a carboxyl group capable of a condensation reaction, and a halogenated alkyl group capable of thio-etherification. Examples of the ethylenically unsaturated group include a vinyl group.

Here, examples of the step-polymerization polymer include polymers obtained by polycondensation, polyaddition, or addition condensation of raw material compounds; and examples thereof include polyurethane, polyurea, polyamide, polyimide, polyester, polysiloxane, and copolymers thereof. Examples of the chain-polymerization polymer include polymers having a polymerized chain of carbon-carbon double bonds as a main chain; and examples thereof include a hydrocarbon polymer, a vinyl polymer, a (meth)acrylic polymer, and copolymers thereof, where a (meth)acrylic polymer is preferable. Here, examples of the (meth)acrylic polymer include a polymer consisting of a (co)polymer containing 50% by mass or more of a constitutional component derived from a (meth)acrylic compound (M1) described later. Examples of the vinyl polymer include a polymer consisting of a copolymer containing 50% by mass or more of a constitutional component derived from a vinyl-based compound (M2) described later (where a content of a constitutional component derived from the (meth)acrylic compound (M1) is less than 50% by mass). In the present invention, the polymerized chain of carbon-carbon double bonds refers to a polymerized chain which is obtained by polymerizing carbon-carbon double bonds (ethylenically unsaturated groups), and specifically, it refers to a polymerized chain obtained by polymerizing (homopolymerizing or copolymerizing) a monomer having a carbon-carbon unsaturated bond.

The polymerized chain is a molecular chain in which two or more repeating units of one or two or more kinds are bonded. Such a polymerized chain is not particularly limited, and a chain consisting of a general polymer, for example, the above-described step-polymerization polymer or chain-polymerization polymer can be applied thereto without particular limitation. In the present invention, a polymerized chain having a repeating unit represented by Formula (L_{P}) is preferable; a polymerized chain consisting of polyester, a polymerized chain consisting of polyether, a polymerized chain consisting of polysiloxane, or a polymerized chain consisting of a (meth)acrylic polymer is more preferable; and a polymerized chain consisting of polysiloxane is still more preferable.

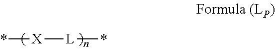

In Formula (L_{P}), X represents a divalent substituent, L represents a single bond or a linking group, and n represents an (average) degree of polymerization.

The substituent which can be adopted as X is not particularly limited, and examples thereof include a group obtained by further removing one hydrogen atom from a group appropriately selected from the substituent Z or the like described later, and it preferably represents a hydrocarbon group or an alkylsilylene group from the viewpoint of dispersion characteristics. The hydrocarbon group which can be adopted as X is not particularly limited, and examples thereof include an alkylene group, an alkenyl group, and an arylene group, where an alkylene group is preferable. Examples of the alkylene group and the like, which can be adopted as X, include a group obtained by further removing one hydrogen atom from each of the corresponding groups of the substituent Z described later. However, the number of carbon atoms in the alkylene group is more preferably 1 to 8. In a case where the repeating unit represented by Formula (L_{P}) is an alkyleneoxy group, the number of carbon atoms in the alkylene group is still more preferably 1 to 6. The alkylsilylene group which can be adopted as X is not particularly limited, and examples thereof include a —Si(R^{S}₂)— group in a polymerized chain consisting of polysiloxane described later. The X may have a substituent.

L is selected depending on the kind of polymerized chain. For example, in a case of a chain consisting of a chain-polymerization polymer, a single bond is adopted, and in a case of a chain consisting of a step-polymerization polymer, a linking group is adopted. The linking group which can be adopted as L is not particularly limited as long as it is a group which can be bonded to another repeating unit, and it is appropriately selected depending on the kind of the polymerized chain. The linking group is generally a linking group having a heteroatom, and examples thereof include an ester bond (—CO—O—), an ether bond (—O—), a carbonate bond (—O—CO—), an amide bond (—CO—N(R^{N})—), a urethane bond (—N(R^{N})—CO—), a urea bond (—N(R^{N})—CO—N(R^{N})—), and an imide bond (—CO—N(R^{N})—CO—). In each of the above-described bonds, R^{N} represents a hydrogen atom, an alkyl group having 1 to 6 carbon atoms, or an aryl group having 6 to 10 carbon atoms. Any bonding portion of the above-described linking group may be bonded to X described above. The linking group is more preferably an ester bond, an ether bond, a carbonate bond, or the like.

n represents an (average) degree of polymerization and may be 2 or more, and it is appropriately determined in consideration of the number-average molecular weight of the polymerized chain described later. For example, the degree of polymerization n is as described later.

Two or more repeating units included in the polymerized chain may be the same or different from each other. In a case where two or more repeating units are different from each other, a bonding mode thereof is not particularly limited and may be a random type, an alternating type, or a block type.

Examples of the polymerized chain having the repeating unit represented by Formula (L_{P}) include a chain consisting of a chain-polymerization polymer, and a polymer chain consisting of a step-polymerization polymer; and more specific examples thereof include a polymerized chain consisting of a (meth)acrylic polymer, a polymerized chain consisting of polystyrene, a polymerized chain consisting of polyether, a polymerized chain consisting of polyester, a polymerized chain consisting of polycarbonate, and a polymerized chain consisting of polysiloxane. From the viewpoint of shortening the dispersion time and improving the dispersion characteristics, a polymerized chain consisting of polysiloxane is more preferable.

The group bonded to the terminal of the above-described polymerized chain is not particularly limited, and an appropriate group can be adopted according to a polymerization method or the like. Examples thereof include a hydrogen atom, an alkyl group, an aryl group, and a hydroxy group, and examples thereof also include a substituent which can be adopted as R^{16A} in Formula 4 described later. Preferred examples of the group bonded to the terminal of the polymerized chain include an alkyl group (preferably having 1 to 20 carbon atoms, more preferably 4 to 20 carbon atoms, and still more preferably 4 to 12 carbon atoms) from the viewpoint of dispersion characteristics. The group may further have a substituent, but it is preferably unsubstituted.

Examples of the polymerized chain consisting of polyether include a polyalkyleneoxy chain and a polyaryleneoxy chain. Examples of the alkylene group and the arylene group include a group obtained by further removing one hydrogen atom from an alkyl group or aryl group appropriately selected from the substituent Z described later, and preferred examples thereof include an alkylene group and an arylene group, which can be adopted as X described above.

The polymerized chain consisting of polysiloxane is preferably a polymerized chain having a structure represented by —(Si(R^{S}₂)—O)ₙₛ—. R^{S} represents a hydrogen atom or a substituent, and it is preferably a substituent. The substituent is not particularly limited; and examples thereof include substituents selected from the substituent Z described later, for example, a hydroxy group, an alkyl group (preferably having 1 to 12 carbon atoms, more preferably 1 to 6 carbon atoms, and particularly preferably 1 to 3 carbon atoms), an alkenyl group (preferably having 2 to 12 carbon atoms, more preferably 2 to 6 carbon atoms, and particularly preferably 2 or 3 carbon atoms), an alkoxy group (preferably having 1 to 24 carbon atoms, more preferably 1 to 12 carbon atoms, still more preferably 1 to 6 carbon atoms, and particularly preferably 1 to 3 carbon atoms), an aryl group (preferably having 6 to 22 carbon atoms, more preferably 6 to 14 carbon atoms, and particularly preferably 6 to 10 carbon atoms), an aryloxy group (preferably having 6 to 22 carbon atoms, more preferably 6 to 14 carbon atoms, and particularly preferably 6 to 10 carbon atoms), an aralkyl group (preferably having 7 to 23 carbon atoms, more preferably 7 to 15 carbon atoms, and particularly preferably 7 to 11 carbon atoms), and a group represented by Formula Z described later. Among these, an alkyl group having 1 to 3 carbon atoms, a phenyl group, or a group represented by Formula Z described later is more preferable, and an alkyl group having 1 to 3 carbon atoms is still more preferable. ns represents a polymerization degree (average repetition number) of the siloxane structure, and is appropriately determined in consideration of the number-average molecular weight of the polymerized chain described later and the molecular weight of the constitutional component (X), and is preferably as described later. The polysiloxane structure has a terminal group bonded to a terminal thereof. The terminal group is not particularly limited, and examples thereof include a hydrogen atom and a substituent. The substituent which can be adopted as the terminal group is as described above, and examples thereof include the substituent which can be adopted as R^{S}.

The polysiloxane structure is preferably a polysiloxane structure included in a chemical structure represented by Formula 4A.

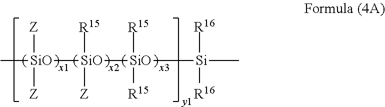

In Formula 4A, R¹⁵ and R¹⁶ represent an alkyl group or an aryl group, and Z represents a group represented by Formula (Z) described later. R¹⁵, R¹⁶, and Z in Formula 4A are the same as R¹⁵, R¹⁶, and Z in Formula 4 described later, respectively.

In Formula 4A, x1, x2, and x3 are integers of 0 or more, and y1 is an integer of 1 to 30. x1, x2, x3, and y1 in Formula 4A are the same as x1, x2, x3, and y1 in Formula 4 described later, respectively.

Examples of the polymerized chain consisting of polyester include a chain consisting of known polyester. Examples thereof include a polyester polymerized chain obtained by a reaction of a polyol such as an alkylene glycol with a polybasic acid such as an aromatic dicarboxylic acid or an aliphatic dicarboxylic acid; and a polyester polymerized chain obtained by ring-open polymerization of a cyclic ester compound such as a caprolactone monomer.

Preferred examples of the chain consisting of a chain-polymerization polymer include a polymerized chain consisting of a (meth)acrylic polymer and a polymerized chain consisting of polystyrene.

As the polymerized chain consisting of a (meth)acrylic polymer, it is preferable to have a constitutional component derived from a (meth)acrylic compound (M1) such as a (meth)acrylic acid compound, a (meth)acrylic acid ester compound, a (meth)acrylamide compound, and a (meth)acrylonitrile compound, which will be described later; and a constitutional component derived from a vinyl-based compound (M2), which will be described later. Among these, a polymerized chain having a constitutional component derived from one or two or more (meth)acrylic acid ester compounds is more preferable, and a polymerized chain having a constitutional component derived from a (meth)acrylic acid alkyl ester compound is still more preferable. The (meth)acrylic acid alkyl ester compound preferably includes an ester compound of a long-chain alkyl group having 4 or more carbon atoms (preferably 6 or more carbon atoms), and can further include an ester compound of a short-chain alkyl group having 3 or less carbon atoms. A content of each constitutional component in the polymerized chain is not particularly limited and is appropriately set. For example, a content of the constitutional component derived from the (meth)acrylic compound (M1) in the polymerized chain is 30% to 100% by mass, and it can also be set to 50% to 80% by mass. A content of the constitutional component derived from a (meth)acrylic acid alkyl ester compound is preferably 50% to 100% by mass, and it can also be set to 60% to 80% by mass. In addition, in a case where a constitutional component derived from a (meth)acrylic acid long-chain alkyl ester compound and a constitutional component derived from a (meth)acrylic acid short-chain alkyl ester compound are included, a content of the constitutional component derived from a (meth)acrylic acid long-chain alkyl ester compound is preferably 20% to 100% by mass and more preferably 50% to 100% by mass, and a content of the constitutional component derived from a (meth)acrylic acid short-chain alkyl ester compound is preferably 5% to 80% by mass and more preferably 5% to 40% by mass.

It is preferable that the above-described polymerized chain is bonded to the above-described polycondensable group directly or through a linking group.

Such a linking group L^{A1} is not particularly limited, and examples thereof include an alkylene group (preferably having 1 to 12 carbon atoms, more preferably 1 to 6 carbon atoms, and still more preferably having 1 to 3 carbon atoms), an alkenylene group (preferably having 2 to 6 carbon atoms and more preferably having 2 or 3 carbon atoms), an arylene group (preferably having 6 to 24 carbon atoms and more preferably having 6 to 10 carbon atoms), an oxygen atom, a sulfur atom, an imino group (—NR^{N}—; R^{N} represents a hydrogen atom, an alkyl group having 1 to 6 carbon atoms or an aryl group having 6 to 10 carbon atoms), a carbonyl group, a phosphate linking group (—O—P(OH)(O)—O—), a phosphonate linking group (—P)(OH)(O)—O—), and a group of a combination thereof. However, the linking group L^{A1} is preferably a group which does not correspond to each polar functional group defined by the constitutional component (A) described later.

The linking group L^{A1} is preferably a group formed by a combination of an alkylene group, an arylene group, a carbonyl group, an oxygen atom, a sulfur atom, and an imino group, more preferably a group formed by a combination of an alkylene group, an arylene group, a carbonyl group, an oxygen atom, a sulfur atom, and an imino group, and still more preferably a group including a —CO—O— group; and examples thereof include a —CO—O— group and a —CO—O-alkylene group.

Preferred examples of the linking group L^{A1} include a linking group including a structural part derived from a chain transfer agent (for example, 3-mercaptopropionic acid), a polymerization initiator, or the like, which is used in the synthesis of the above-described polymerized chain; and a linking group obtained by bonding the structural part to a structural part derived from the (meth)acrylic compound (M1) which reacts with the chain transfer agent.

The number of atoms constituting the above-described linking group L^{A1} is preferably 1 to 36, more preferably 1 to 24, and still more preferably 1 to 12. The number of linking atoms of the linking group L^{A1} is preferably 12 or less, more preferably 10 or less, and particularly preferably 8 or less. The lower limit thereof is 1 or more. The above-described number of linking atoms refers to the minimum number of atoms linking predetermined structural moieties. For example, in a case of —O—C(═O)—CH₂—CH₂—, the number of atoms constituting the linking group is 9 and the number of linking atoms is 4.

The constitutional component (X) is preferably a constitutional component derived from a compound having a polymerized chain consisting of polyester, a polymerized chain consisting of polysiloxane, or a polymerized chain consisting of a (meth)acrylic polymer, which has an ethylenically unsaturated group as a polycondensable group and includes —C(═O)—O— as a linking group; and more preferably a constitutional component having a polymerized chain consisting of polysiloxane, which is represented by Formula 4.

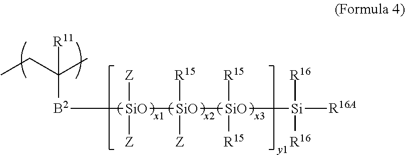

In Formula 4, R¹¹ represents a hydrogen atom or methyl.

B² represents a linking group. The linking group which can be adopted as B² is not particularly limited, and examples thereof include the linking groups which can be adopted as the linking group L^{A1} described above. The linking group as B² is preferably an alkylene group, an alkenylene group, an arylene group, an oxygen atom, a sulfur atom, a carbonyl group, or a group of a combination thereof, more preferably a group including a —CO—O— group, and particularly preferably a —CO—O— group or a —CO—O-alkylene group.

R¹⁵ represents an alkyl group or an aryl group, preferably an alkyl group. The alkyl group and the aryl group, which can be adopted as R¹⁵, have the same definitions and the same preferred ranges as those of the alkyl group and the aryl group which can be adopted as R^{S} in the above-described polysiloxane structure, respectively. Here, R¹⁵ particularly preferably represents methyl. Two R¹⁵'s bonded to the same silicon atom may be the same or different from each other, and preferably represent methyl.

R¹⁶ represents an alkyl group or an aryl group, preferably an alkyl group. Two R¹⁶'s bonded to the same silicon atom may be the same or different from each other. The alkyl group and the aryl group, which can be adopted as R¹⁶, have the same definitions and the same preferred ranges as those of the alkyl group and the aryl group which can be adopted as R^{S} in the above-described polysiloxane structure, respectively. Here, R¹⁶ particularly preferably represents methyl.

R^{16A} represents a hydrogen atom or a substituent. The substituent which can be adopted as R^{16A} is not particularly limited, and examples thereof include the substituent Z described later; and a substituent which can be adopted as R^{S} described above is preferable. Here, the substituent which can be adopted as R^{16A} is more preferably an alkyl group, an alkenyl group, an aralkyl group, an aryl group, an alkoxy group, or an aryloxy group, and still more preferably an alkyl group or the like.

Z represents a group represented by Formula (Z).

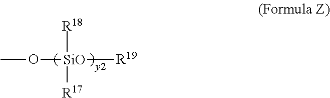

In Formula (Z), R¹⁷ and R¹⁸ each represent an alkyl group or an aryl group. The alkyl group and the aryl group, which can be adopted as R¹⁷ and R¹⁸, have the same definitions and the same preferred ranges as those of the alkyl group and the aryl group which can be adopted as R^{S} in the above-described polysiloxane structure, respectively. R¹⁷ and R¹⁸ may be the same or different from each other. R¹⁹ represents an unsubstituted alkyl group having 1 to 4 carbon atoms. y2 represents an integer of 1 to 100, preferably an integer of 1 to 50 and more preferably an integer of 1 to 20.

In the constitutional component represented by Formula 4, x1, x2, x3, y1, and y2 are appropriately determined in consideration of the number-average molecular weight of the polymerized chain described later and the molecular weight of the constitutional component (X), the total (polymerization degree) of x1, x2, x3, y1, and y2 is as described later, and it is preferable that a value of (x1+x2+x3)×y1 is the same as the polymerization degree described later.

For example, in Formula 4, x1, x2, and x3 each represent an integer of 0 or more.
x1 is preferably an integer of 0 to 50 and more preferably an integer of 0 to 20.
x2 is preferably an integer of 0 to 50 and more preferably an integer of 0 to 20.
x3 is preferably an integer of 1 to 100 and more preferably an integer of 1 to 30.

The sum of x1, x2, and x3 is an integer of 1 to 100, preferably an integer of 2 to 70 and more preferably an integer of 2 to 50.

In a case where x1 and x3 each represent an integer of 2 or more, two Z's or R¹⁵'s bonded to the same silicon atom in Formula 4 may be the same or different from each other.

y1 represents an integer of 1 to 30, preferably an integer of 1 to 20 and more preferably an integer of 1 to 10.

x1, x2, x3, y1, and y2 are preferably x1=x2=y2=0, x3=integer of 1 to 100, and y1=integer of 1 to 30.

The constitutional component (X) is not particularly limited, but is preferably a constitutional component derived from a compound in which the polymerized chain is introduced (substituted) into the following polycondensable compound.

The polycondensable compound is not particularly limited as long as it is a polycondensable compound having an ethylenically unsaturated bond, and examples thereof include (meth)acrylic compounds (M1) such as a (meth)acrylic acid compound, a (meth)acrylic acid ester compound, a (meth)acrylamide compound, and a (meth)acrylonitrile compound; vinyl compounds (M2) including vinyl aromatic compounds such as a styrene compound, a vinyl naphthalene compound, and a vinyl carbazole compound, allyl compounds, vinyl ether compounds, vinyl ester compounds, cyclic olefin compounds, diene compounds, and vinyl carboxylic acid ester compounds; and compounds such as a dialkyl itaconate compound and an unsaturated carboxylic acid anhydride. Among these, a styrene compound, a (meth)acrylic acid compound, a (meth)acrylic acid ester compound, or a (meth)acrylamide compound is preferable.

Examples of the (meth)acrylic acid ester compound include a (meth)acrylic acid alkyl ester compound and a (meth)acrylic acid aryl ester compound, and a (meth)acrylic acid alkyl ester compound is preferable. The number of carbon atoms in the alkyl group constituting the (meth)acrylic acid alkyl ester compound is not particularly limited, but it can be set to, for example, 1 to 24, preferably 1 to 12, more preferably 1 to 6, and still more preferably 1 to 4. The number of carbon atoms in the aryl group constituting the aryl ester is not particularly limited, but it can be set to, for example, 6 to 24, preferably 6 to 10 and more preferably 6.

In the present invention, the polymerized chain of the constitutional component (X) may include a polar functional group included in the group (a) of functional groups described later as a linking group, for example, the linking group L of Formula (L_{P}); but this polar functional group functions as the linking group and is not the polar functional group selected from the group (a) of functional groups. In addition, in a case where the constitutional component (X) is derived from a compound having the above-described polycondensable group and the above-described polymerized chain, even in a case where the constitutional component (X) has a polar functional group included in the group (a) of functional groups described later in the above-described linking group L^{A1} which links the above-described polycondensable group and the above-described polymerized chain, the polar functional group does not sufficiently exhibit an adsorption or adhesion function to the solid particles, and thus it is included in an aspect in which the constitutional component (X) does not have a polar functional group (constitutional component which does not correspond to the constitutional component (A)).

Specific examples of the constitutional component (X) include the following examples, but the present invention is not limited thereto. In the specific examples, R^{Y} and R^{Z} represent a linking group or a substituent. In the following specific examples, although the degree of polymerization of the repeating unit is specifically indicated, it can be appropriately changed in the present invention. In addition, specific examples of the constitutional component (X) represented by Formula 4 include a terminal (meth)acrylic-modified silicone compound, specifically, those shown in each polymer synthesized in Examples described later, but the present invention is not limited thereto.

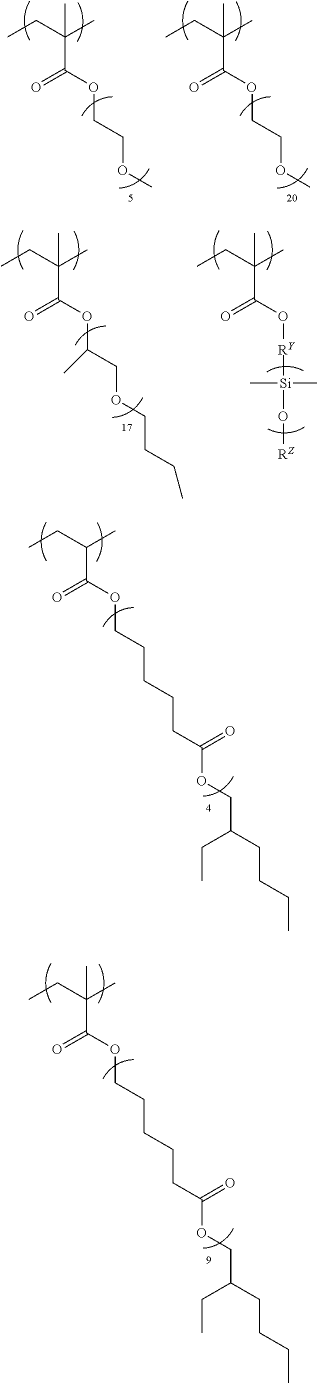

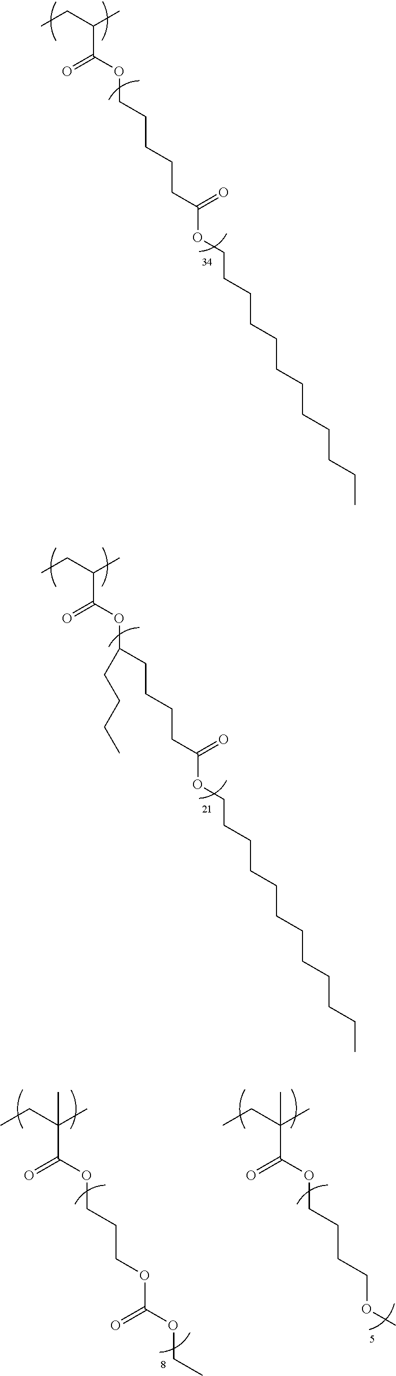

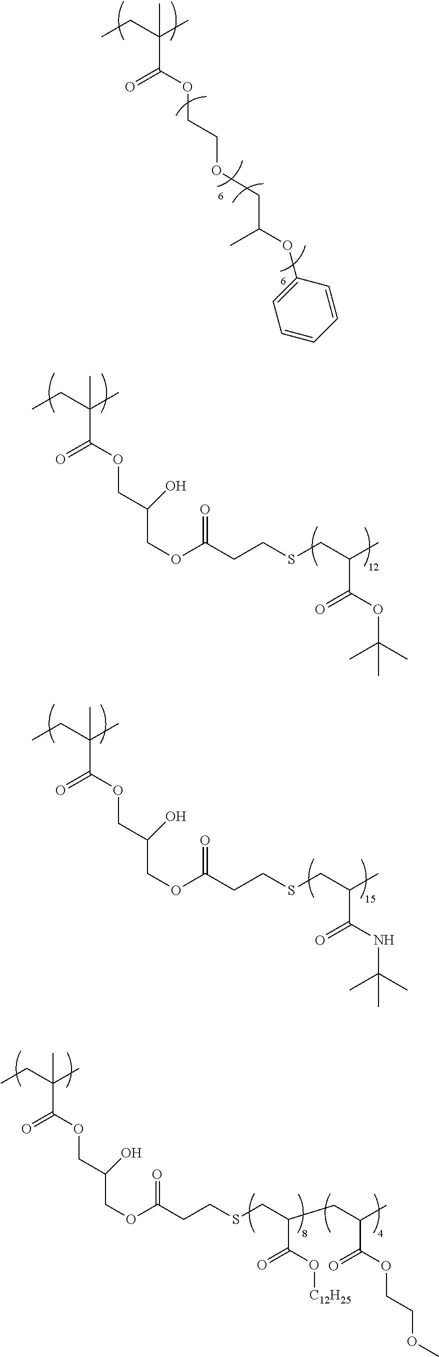

As the constitutional component (X), a degree of polymerization of repeating units may be 2 or more, and the constitutional component (X) is a constitutional component which is derived from a macromonomer having a polymerized chain and has a molecular weigh of 400 or more. In a case where the constitutional component (X) includes a polymerized chain and has a molecular weight of 400 or more, the dispersibility of the solid particles is improved, and the dispersion time can be shortened and the dispersion characteristics can be improved.

The molecular weight of the constitutional component (X) is appropriately determined in consideration of the molecular weight of the polymer according to the embodiment of the present invention, the content of the constitutional component (X), and the like; and is, for example, preferably 600 or more, more preferably 800 or more, still more preferably 2,000 or more, and particularly preferably 3,000 or more from the viewpoint of being able to achieve both the shortening of the dispersion time and the improvement of the dispersion characteristics. The upper limit thereof is not particularly limited, but is preferably 200,000 or less, more preferably 50,000 or less, still more preferably 20,000 or less, particularly preferably 7,000 or less, and most preferably 5,000 or less from the viewpoint of being able to achieve both the shortening of the dispersion time and the improvement of the dispersion characteristics.

In the present invention, the molecular weight of the constitutional component (X) means a total molecular weight of the number-average molecular weight of the polymerized chain and the molecular weight of the other partial structure. The number-average molecular weight of the polymerized chain can be measured as a standard polystyrene-equivalent number-average molecular weight in the same manner as the weight-average molecular weight of the polymer according to the embodiment of the present invention.

The number-average molecular weight of the polymerized chain and the degree of polymerization of the total structural unit forming the polymerized chain are not particularly limited, and are appropriately determined in consideration of the molecular weight of the constitutional component (X), the molecular weight of the polymer according to the embodiment of the present invention, and the like. The degree of polymerization of the total structural unit forming the polymerized chain is, for example, preferably 2 to 1,000, more preferably 2 to 200, and still more preferably 6 to 80.

An SP value of the constitutional component (X) is not particularly limited, and is appropriately determined in consideration of an SP value of the polymer according to the embodiment of the present invention, which will be described later.

### Constitutional Component (A)

From the viewpoint of being able to improve the dispersion characteristics of the solid particles without impairing the effect of shortening the dispersion time, it is preferable that the polymer according to the embodiment of the present invention has a constitutional component (A) having at least one polar functional group of the group (a) of functional groups, in which adsorptivity or adhesiveness to the solid particles is enhanced. In a case where a molecular weight of the constitutional component (A) is 400 or more, the constitutional component (A) is preferably a constitutional component having no polymerized chain defined by the constitutional component (X) in the molecular structure; and the constitutional component (A) is more preferably a constitutional component having no polymerized chain defined by the constitutional component (X) in the molecular structure regardless of the molecular weight.

In the constitutional component (A), the polar functional group is preferably included in a molecular chain which is a side chain of the polymer according to the embodiment of the present invention, and for example, more preferably incorporated into the inside or the terminal of the molecular chain which is a side chain of the polymer according to the embodiment of the present invention.

In the present invention, the molecular chain which is a side chain of the polymer according to the embodiment of the present invention refers to a molecular chain constituting the side chain of the polymer according to the embodiment of the present invention in which the constitutional component (A) is incorporated, and is a molecular chain other than a molecular chain constituting the main chain of the polymer according to the embodiment of the present invention, usually a molecular chain bonded to the molecular chain (atomic group) constituting the main chain. For example, it refers to a molecular chain (—CONH₂) which is bonded to an ethylenic double bond which is a polymerizable group in a case where the polycondensable compound from which the constitutional component (A) is derived is acrylamide.

It is sufficient that the constitutional component (A) has at least one polar functional group, and it usually preferably has one to three kinds of polar functional groups. The number of polar functional groups included in the polymer according to the embodiment of the present invention is not particularly limited, and is appropriately determined according to the number of polar functional groups included in the constitutional component (A) itself, the content of the constitutional component (A), the molecular weight of the polymer according to the embodiment of the present invention, and the like.

It is sufficient that the constitutional component (A) has the polar functional group, and examples thereof include a constitutional component derived from a polycondensable compound having at least one kind of polar functional group of the following group (a) of functional groups. The polycondensable compound is, for example, preferably a compound having a polycondensable group, a polar functional group or a substituent having a polar functional group, and a linking group L^{A2} appropriately linking the polycondensable group and the substituent, and more preferably a low-molecular-weight compound. A molecular weight of the constitutional component (A) is not particularly limited, but one of preferred aspects is that the molecular weight is less than 400. In the preferred aspect in which the molecular weight of the constitutional component (A) is less than 400, the constitutional component (A) may have or may not have a repeating structure in a partial structure other than the polycondensable group. On the other hand, in an aspect in which the molecular weight of the constitutional component (A) is 400 or more, the constitutional component (A) is preferably a compound having no repeating structure in a partial structure other than the polycondensable group.

The polycondensable group has the same meaning as the polycondensable group in the constitutional component (X) described above. A substituent forming the substituent having a polar functional group is not particularly limited, and examples thereof include a group selected from the substituent Z described later and a polymerized chain. Preferred examples of the polymerized chain which can be adopted as the substituent include a polymerized chain having a degree of polymerization of number-average molecular weight such that the molecular weight of the constitutional component (X) is less than 400. Such a polymerized chain (however, the number-average molecular weight thereof is limited to that the molecular weight of the constitutional component (A) is less than 400) is not particularly limited, and examples thereof include a polymerized chain having the repeating unit represented by Formula (L_{P}) in the constitutional component (X) described above; and a polymerized chain consisting of polyether is preferable, and a polyalkyleneoxy chain is more preferable.

The substituent is preferably an alkyl group or a polyalkyleneoxy chain. In the present invention, in a case where the substituent forming the substituent having a polar functional group can also correspond to the linking group L^{A2}, the substituent is interpreted as the substituent forming the substituent having a polar functional group.

As the linking group L^{A2}, the above-described linking group L^{A1} which links the above-described polycondensable group and the above-described polymerized chain in the constitutional component (X) can be applied without particular limitation.

### <Group (a) of Functional Groups>

a sulfonic acid group (sulfo group), a phosphoric acid group (phosphoryl group), a phosphonic acid group, a hydroxy group, a carboxy group, an oxetane group, an epoxy group, a dicarboxylic acid group, a thiol group (sulfanyl group), an ether group, a thioether group, a thioester group, an ester group, an amide group, a urethane group, a urea group, an imide group, a fluoroalkyl group, and salts thereof

The sulfonic acid group, the phosphoric acid group, the phosphonic acid group, and the like, which are included in the group (a) of functional groups, are not particularly limited, and are synonymous with corresponding groups of the substituent Z described later.

The dicarboxylic acid group is not particularly limited, and includes a group formed by removing one or more hydrogen atoms from a dicarboxylic acid anhydride, a constitutional component itself, which is formed by copolymerization of a polymerizable dicarboxylic acid anhydride as a polymerizable compound, and a group formed by a dicarboxylic acid anhydride reacting with an active hydrogen compound to cleave an anhydride group. The group obtained by removing one or more hydrogen atoms from a dicarboxylic acid anhydride is preferably a group obtained by removing one or more hydrogen atoms from a cyclic dicarboxylic acid anhydride. Examples the dicarboxylic acid anhydride include acyclic dicarboxylic acid anhydrides such as acetic acid anhydride, propionic acid anhydride, and benzoic acid anhydride; and cyclic dicarboxylic acid anhydrides such as maleic acid anhydride, phthalic acid anhydride, fumaric acid anhydride, succinic acid anhydride, and itaconic acid anhydride. The polymerizable dicarboxylic acid anhydride is not particularly limited, and examples thereof include a dicarboxylic acid anhydride having an unsaturated bond in the molecule, where a polymerizable cyclic dicarboxylic acid anhydride is preferable. Specific examples thereof include maleic acid anhydride and itaconic acid anhydride.

The active hydrogen compound is not particularly limited as long as it is a compound which reacts with a dicarboxylic acid anhydride group, and examples thereof include an alcohol compound, an amine compound, and a thiol compound.

The ether group (—O—), the thioether group (—S—), and the thioester group (*—CO—S—**, *—CS—O—**, *—CS—S—**) respectively mean a bond shown in the parentheses. In addition, the ester group (*—CO—O—**), the amide group (*—CONR^{NA1}—**), the urethane group (*—NR^{NA1}—CO—O—**), the urea group (—NR^{NA1}—CO—NR^{NA1}—) and the imide group (*—CO—NR^{NA2}—CO**) respectively mean a bond shown in the parentheses. Here, * and ** represent a bonding portion, R^{NA1} represents a hydrogen atom or a substituent, and R^{NA2} represents a bonding portion, a hydrogen atom, or a substituent. The substituent which can be adopted as R^{NA1} and R^{NA2} is not particularly limited, and examples thereof include the group selected from the substituent Z described later, and an alkyl group (including a cycloalkyl group), an aryl group, a heterocyclic group, or the like is preferable. The number of carbon atoms in the alkyl group is preferably 1 to 20, more preferably 1 to 12, and still more preferably 1 to 6. The number of carbon atoms in the aryl group is preferably 6 to 26, more preferably 6 to 20, and still more preferably 6 to 12. Two R^{NA1}'s in the urea group may be the same or different from each other. R^{NA1} is preferably a hydrogen atom, and R^{NA2} is preferably a bonding portion or a hydrogen atom.

In each of the above-described groups, any of the two bonding portions * and ** may be bonded to the main chain side of the polymer according to the embodiment of the present invention, but it is preferable that the bonding portion * is bonded to the main chain side of the polymer according to the embodiment of the present invention.

However, in a case where the constitutional component (A) is incorporated into the polymer according to the embodiment of the present invention, the ester group is excluded from a partial structure which forms the main chain of the polymer according to the embodiment of the present invention, for example, an ester group directly bonded to the polymerized chain of carbon-carbon double bonds.

The terminal group bonded to each of these groups is not particularly limited, and represents a hydrogen atom or a substituent. Examples of the substituent which can be adopted as the terminal group include the group selected from the substituent Z described later. Among these, an alkyl group (including a cycloalkyl group), an aryl group, or a heterocyclic group is preferable, and an alkyl group or an aryl group is more preferable. The number of carbon atoms in the alkyl group is preferably 1 to 20, more preferably 2 to 12, and still more preferably 3 to 8. The number of carbon atoms in the aryl group is the same as the number of carbon atoms in the aryl group which can be adopted as R^{NA1}.

In the present invention, in a case where any one of R^{NA1} or the terminal group is a hydrogen atom, the hydrogen atom is interpreted as R^{NA1}.

The ether group is found in the carboxy group, the hydroxy group, the oxetane group, the epoxy group, the dicarboxylic acid anhydride group, the ester group, and the like, but —O— contained in these groups is not regarded as the ether group. The same applies to the thioether group. In addition, the ester group is found in the urethane group, but —CO—O— included in the urethane group is not interpreted as the ester group. Furthermore, the amide group is found in the urethane group, the urea group, the imide group, and the like, but —CO—N^{RN}— included in these groups is not interpreted as the amide group.

The polar functional group may form a cyclic structure. For example, the imide group may form a cyclic imide group, specifically, a cyclic imide group derived from maleimide or phthalimide.

The fluoroalkyl group is a fluoroalkyl group in which at least one hydrogen atom in the alkyl group is replaced with a fluorine atom, and a molecular structure thereof may be linear, branched, or cyclic, and is preferably linear or branched. The number of carbon atoms in the fluoroalkyl group is not particularly limited, but is preferably 1 to 20, more preferably 1 to 12, still more preferably 2 to 8, and particularly preferably 2 to 7. An aspect in which the lower limit of carbon atoms is 3 or more is a preferred aspect, and in a case where the fluoroalkyl group is linear, an aspect in which the lower limit of carbon atoms is 4 or more is a preferred aspect.

In the fluoroalkyl group, a part of hydrogen atoms may be replaced with fluorine atoms, or all hydrogen atoms may be replaced with fluorine atoms. In the present invention, a fluoroalkyl group in which a part of hydrogen atoms are replaced with fluorine atoms is preferable, a fluoroalkyl group in which a carbon atom bonded to the polymer according to the embodiment of the present invention on the main chain side is not substituted with a fluorine atom and includes a methylene group (—CH₂—) is more preferable, and a fluoroalkyl group in which two or three continuous carbon atoms including the carbon atom bonded to the polymer according to the embodiment of the present invention on the main chain side are not substituted with fluorine atoms and includes an ethylene group (—CH₂—CH₂—) or a propylene group (—CH₂—CH₂—CH₂—) is still more preferable. In the fluoroalkyl group in which a part of hydrogen atoms is replaced with a fluorine atom, it is preferable that the remaining alkyl group bonded to a carbon atom not substituted with a fluorine atom is a perfluoroalkyl group in which all hydrogen atoms are replaced with fluorine atoms.

The fluoroalkyl group may have a substituent other than the fluorine atom, for example, may have the substituent (other than the fluorine atom) which can be adopted as R^{f} described later.

A group which can form a salt, such as the sulfonic acid group (sulfo group), the phosphoric acid group, the phosphonic acid group, the hydroxy group, the carboxy group, and the dicarboxylic acid group, may form a salt together with a cation. The cation is not particularly limited, and examples thereof include various metal salts and salts of ammonium or amine. In addition, the amide group, the urethane group, the urea group, the imide group, and the like may form a salt together with an anion. The anion is not particularly limited, and examples thereof include anions of various inorganic acids or organic acids.

The polar functional group included in the constitutional component (A) is preferably a sulfonic acid group, a phosphoric acid group, a phosphonic acid group, a hydroxy group, a carboxy group, an oxetane group, an epoxy group, a dicarboxylic acid group, an ether group, an amide group, or a salt of these groups, and more preferably an amide group, a hydroxy group, or the like from the viewpoint of shortening the dispersion time and improving the dispersion characteristics.

In a case where the constitutional component (A) has two or more kinds of polar functional groups, the combination thereof is not particularly limited and can be appropriately determined. For example, a combination including an amide group is preferable, and specifically, a combination of an amide group and a dicarboxylic acid group is preferable.

The constitutional component (A) usually has one polar functional group, but two or more polar functional groups may be linked to each other to form a repeating structure as long as the molecular weight is less than 400. In the present invention, as described above, it is preferable that the constitutional component (A) has one polar functional group.

The constitutional component (A) is not particularly limited, but is preferably a constitutional component derived from the above-described polycondensable compound, a constitutional component derived from the above-described polycondensable compound in which the above-described polar functional group is introduced (substituted), a constitutional component derived from a compound in which the above-described polar functional group is introduced into a polymerized chain (where the molecular weight is less than 400), or a constitutional component derived from a maleimide compound, an N-vinyl-substituted imide compound, or a vinyl succinimide compound; more preferably a constitutional component derived from a (meth)acrylic acid compound, a constitutional component derived from a compound in which the above-described polar functional group is introduced into a (meth)acrylic acid ester compound, or a constitutional component derived from a (meth)acrylamide compound; and still more preferably a constitutional component derived from a compound in which the above-described polar functional group is introduced into a (meth)acrylic acid alkyl ester or a (meth)acrylamide compound.

Examples of the (meth)acrylamide compound include (meth)acrylamide compounds such as an N-unsubstituted (meth)acrylamide compound and an N-monosubstituted or N-disubstituted (meth)acrylamide compound; and specifically, an N-unsubstituted (meth)acrylamide compound, an N-alkyl (meth)acrylamide compound, an N,N-dialkyl (meth)acrylamide compound, an N-aryl (meth)acrylamide compound, an N,N-diaryl (meth)acrylamide compound, or the like is preferable. Examples of the substituent which substitutes a nitrogen atom in the acrylamide compound include R^{NA1} or the terminal group bonded to the terminal of the amide bond described above, and an alkyl group or an aryl group is preferable. As the (meth)acrylamide compound, a compound which derives a group having a chemical structure represented by Formula (A1) described later is also preferable.

Examples of the compound which derives the constitutional component (A) including an amide group include a vinyl-based compound containing an amide group, a (meth)acrylate compound containing an amide group, and a (meth)acrylamide compound containing an amide group, in addition to the (meth)acrylamide compound.

The amide group contained in the constitutional component (A) may be a sulfonamide group. Examples of a compound which derives the constitutional component (A) including a sulfonamide group include a vinyl aromatic sulfonamide compound and a (meth)acrylic compound (M1) containing a sulfonamide group. Among these, a compound in which a sulfonamide group is introduced into a vinyl aromatic compound such as a styrene compound and a vinyl naphthalene compound is preferable, and vinylbenzenesulfonamide is more preferable. The compound which derives the constitutional component (A) including a sulfonamide group may be an N-monosubstituted or N-disubstituted sulfonamide compound, and examples of the substituent which substitutes a nitrogen atom of the sulfonamide group include R^{NA1} or the terminal group bonded to the terminal of the amide bond described above, and an alkyl group is preferable.

Examples of the (meth)acrylic acid ester compound from which the constitutional component (A) is derived include a (meth)acrylic acid alkyl ester compound and a (meth)acrylic acid aryl ester compound, and a (meth)acrylic acid alkyl ester compound is preferable. The number of carbon atoms in the alkyl group constituting the (meth)acrylic acid alkyl ester compound is not particularly limited, and it can be set to, for example, 1 to 24. In general, the number of carbon atoms in the alkyl group is preferably 1 to 12, more preferably 1 to 6, and still more preferably 1 to 4. From the viewpoint of solubility in the dispersion medium and the like, the number of carbon atoms in the alkyl group is preferably 3 to 16 and more preferably 6 to 14. The number of carbon atoms in the aryl group constituting the aryl ester is not particularly limited, but it can be set to, for example, 6 to 24, preferably 6 to 10 and more preferably 6.

Examples of the compound in which the above-described polar functional group is introduced into the polymerized chain include a compound having a molecular weight of less than 400 in a case of being used as a constitutional component; and examples thereof include a compound in which the above-described polymerized chain, preferably a polyalkyleneoxy chain is introduced into the above-described polycondensable compound, and the above-described polar functional group is further introduced into the polymerized chain.

As the constitutional component (A), a constitutional component represented by Formula (A1) is particularly preferable from the viewpoint of shortening the dispersion time and improving the dispersion characteristics.

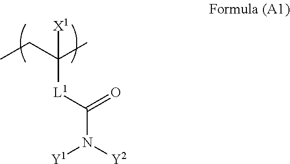

In Formula (A1), X¹ represents a hydrogen atom or a substituent. The substituent which can be adopted as X¹ is not particularly limited, and examples thereof include a group selected from the substituent Z described later; and among these, an alkyl group is preferable. X¹ is preferably a hydrogen atom or a methyl group.

L¹ represents a single bond or a linking group, and is preferably a single bond. The linking group which can be adopted as L¹ is not particularly limited, and the above-described linking group L^{A2} can be applied without particular limitation. Here, the linking group which can be adopted as L¹ does not form a urethane group, a urea group, or an imide group together with the amide group in Formula (A1).

Y¹ and Y² each represent a hydrogen atom or a substituent. The substituent which can be adopted as Y¹ and Y² is not particularly limited, and has the same meaning as R^{NA1} described above or the above-described terminal group bonded to the terminal of the amide bond, and it is preferable that Y¹ is a hydrogen atom and Y² is an alkyl group. However, the substituents which can be adopted as Y¹ and Y² do not form an imide group together with the amide group in Formula (A1). Y¹ and Y² may be the same or different from each other.

In a case where both Y¹ and Y² are alkyl groups, a preferred aspect of the alkyl group which can be adopted as Y¹ and Y² is an aspect which is synonymous with the alkyl group which can be adopted as R^{NA1} described above or as the terminal group bonded to the terminal of the amide bond; and examples thereof include methyl, ethyl, normal propyl, isopropyl, normal butyl, tertiary butyl, a linear or branched octyl group, and a linear or branched dodecyl group. The alkyl group which can be adopted as Y¹ and Y² may have a substituent, but it preferably has no hydroxy group and more preferably has no polar functional group described above. A combination of the alkyl groups which can be adopted as Y¹ and Y² is not particularly limited, and the above-described alkyl groups can be appropriately combined with each other.

The constitutional component represented by Formula (A1) may have a substituent. For example, in Formula (A1), a carbon atom bonded to a carbon atom having X¹ is represented as an unsubstituted carbon atom (methylene group; —CH₂—), but may have a substituent. Such a substituent is not particularly limited, and examples thereof include the above-described substituent which can be adopted as X¹.

Specific examples of the constitutional component (A) include each constitutional component included in the polymer synthesized in Examples and a constitutional component derived from an acrylamide compound, but the present invention is not limited thereto.

The molecular weight of the constitutional component (A) is appropriately determined in consideration of the molecular weight of the polymer according to the embodiment of the present invention, the content of the constitutional component (A), and the like, and is not particularly limited.

An SP value of the constitutional component (A) is not particularly limited, and is appropriately determined in consideration of an SP value of the polymer according to the embodiment of the present invention, which will be described later.

In the present invention, the constitutional component (X) and the constitutional component (A) are different constitutional components. As a result, it is possible to shorten the dispersion time and improve the dispersion characteristics.

### Other Constitutional Components

The polymer according to the embodiment of the present invention may have other constitutional components in addition to the constitutional component (X) and the constitutional component (A). It is sufficient that the other constitutional components do not correspond to the respective constitutional components described above, and examples thereof include constitutional components having no polymerized chain and no polar functional group. Examples thereof include constitutional components derived from a low-molecular-weight polycondensable compound having an ethylenically unsaturated group and having no polar functional group, and more specific examples thereof include a constitutional component derived from the above-described (meth)acrylic acid compound (M1) or the above-described vinyl-based compound (M2). A constitutional component derived from a styrene compound, a (meth)acrylic acid ester compound, or a (meth)acrylonitrile compound is preferable, and a constitutional component derived from a (meth)acrylic acid unsubstituted alkyl ester compound or a (meth)acrylic acid aryl group-substituted alkyl ester compound is preferable. As the other constitutional components, one of more preferred aspects is a constitutional component derived from an acrylic acid ester compound having a long-chain unsubstituted alkyl group. The number of carbon atoms in the long-chain unsubstituted alkyl group can be set to, for example, 4 to 20, and it is preferably 4 to 16 and more preferably 6 to 14. As the other constitutional components, one of more preferred aspects is a constitutional component derived from an acrylic acid ester compound having a short-chain unsubstituted alkyl group and a constitutional component derived from an acrylic acid ester compound having a short-chain alkyl group substituted with an aryl group. The number of carbon atoms in the short-chain alkyl group is, for example, preferably 1 to 3.

The polymer according to the embodiment of the present invention preferably does not contain the other constitutional components.

The polymer according to the embodiment of the present invention may have one or two or more of each of the above-described constitutional components.

A content of each constitutional component in the polymer according to the embodiment of the present invention is not particularly limited, and is appropriately determined in consideration of the physical properties of the entire polymer according to the embodiment of the present invention, and is set to, for example, the following range.

The content of each constitutional component in the polymer according to the embodiment of the present invention is set, for example, in the following range such that the total content of all constitutional components is 100% by mass. In a case of containing two or more constitutional components corresponding to the specific constitutional component, the total content of these constitutional components is defined.

The total content of the constitutional component (X) in the polymer according to the embodiment of the present invention is not particularly limited, and can be appropriately determined in consideration of shortening of the dispersion time, improvement of the dispersion characteristics, and the like. The total content of the constitutional component (X) is, for example, preferably 50 to 99% by mass, more preferably 55 to 95% by mass, still more preferably 60 to 90% by mass, and particularly preferably 65 to 80% by mass with respect to the total content of all constitutional components, from the viewpoint of shortening the dispersion time and improving the dispersion characteristics.

The total content of the constitutional component (A) in the polymer according to the embodiment of the present invention is not particularly limited, and can be appropriately determined in consideration of shortening of the dispersion time, improvement of the dispersion characteristics, and the like. In general, as the total content of the constitutional component (A) increases, the viscosity of the polymer according to the embodiment of the present invention tends to increase. From the viewpoint of easily setting the viscosity of the composition for a non-aqueous secondary battery to a range described later, the total content of the constitutional component (A) is, for example, preferably 0 to 50% by mass, more preferably 1 to 50% by mass, still more preferably 5 to 45% by mass, particularly preferably 10 to 40% by mass, and most preferably 20 to 35% by mass with respect to the total content of all constitutional components, from the viewpoint of shortening the dispersion time and improving the dispersion characteristics.

In the polymer according to the embodiment of the present invention, a ratio [Total content of the constitutional component (X)/Total content of the constitutional component (A)] of the total content of the constitutional component (X) to the total content of the constitutional component (A) is not particularly limited, and can be, for example, 1.0 to 99, preferably 1.2 to 19, more preferably 1.5 to 9.0, and still more preferably 1.9 to 4.0, from the viewpoint of shortening the dispersion time and improving the dispersion characteristics.

The total content of the other constitutional components is not particularly limited, and is preferably 0% to 50% by mass, more preferably 0% to 30% by mass, and still more preferably 0% to 10% by mass with respect to the total content of all constitutional components.

The polymer according to the embodiment of the present invention may have a substituent other than the polar functional group included in the above-described group (a) of functional groups. Examples of the substituent which may be included in the polymer according to the embodiment of the present invention include a substituent Z described later (excluding a polar functional group).

One of preferred aspects is that the polymer according to the embodiment of the present invention does not have a hydroxy group among the polar functional group and the substituent.

Next, a molecular structure of the polymer according to the embodiment of the present invention will be described.

The polymer according to the embodiment of the present invention is not particularly limited in the molecular structure as long as the polymer has the above-described constitutional component (X), but usually has a branched structure or a multibranched structure, in which the polymerized chain of the constitutional component (X) is a branched chain (side chain). In the present invention, the branched structure refers to a branched structure which is contained in a polymerized chain of a polymer, and it refers to, for example, a structure in which one or a plurality of other polymerized chains (side chains) are bonded to the main chain. Examples of the branched structure include a graft structure, a star structure (also referred to as a star-shaped structure), and a dendritic structure. Here, the graft structure refers to a polymer in which a plurality of polymerized chains are branchedly bonded (as side chains) to one main chain without usually having a core portion; and the star structure refers to a polymer having a multibranched structure in which a plurality, usually three or more of polymeric arm portions are bonded to a core portion. The polymeric arm portion constituting the star structure may have a linear structure or a graft structure. Here, the polymeric arm portion refers to a partial structure including a polymer chain, which is bonded to the core portion to form an arm portion of the multibranched polymer.

A primary structure (bonding mode of the constitutional component) of the main chain and the graft chain in the graft structure and a primary structure (bonding mode of the constitutional component) of the polymeric arm portion in the star structure are not particularly limited, and any bonding mode of a random structure, a block structure, an alternating structure, or the like can be adopted.

The polymer according to the embodiment of the present invention preferably has a graft structure or a star structure.

In a case where the polymer according to the embodiment of the present invention has a graft structure, the compound from which the above-described constitutional component (X) is derived can be synthesized by homopolymerization or copolymerization.

In a case where the polymer according to the embodiment of the present invention has a star structure, the polymer according to the embodiment of the present invention is preferably a multibranched polymer represented by Formula (1).

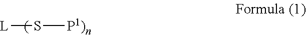

In Formula (1), L represents an n-valent linking group,
P¹ represents a polymer chain as the polymeric arm portion, where n pieces of P's may be the same or different from each other, and
n represents an integer of 3 or more.

### (L of Formula (1))

In Formula (1), L is an n-valent linking group, and is usually a linking group consisting of an organic group including a skeleton in which carbon atoms are bonded to each other by a covalent bond, and it is preferably a linking group further including an oxygen atom. A molecular weight of the linking group is not particularly limited, and for example, is preferably 200 or more and more preferably 300 or more. The upper limit of the molecular weight is preferably 5,000 or less, more preferably 4,000 or less, and particularly preferably 3,000 or less. It is preferable that the linking group does not consist of only one tetravalent carbon atom.

The valence of the linking group is 3 to 10, and has the same definition and the same preferred range as those of n described below.

It is preferable that the linking group has a group represented by Formula 1a. It is preferable that the number of groups represented by Formula 1a in the linking group L is the same as n which is the valence of L. In a case where the linking group has a plurality of the groups, the groups may be the same or different from each other.

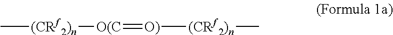

In Formula (1a), n is an integer of 0 to 10, preferably an integer of 1 to 6, and more preferably 1 or 2. Two n's may be the same or different from each other.

R^{f} represents a hydrogen atom or a substituent, and is preferably a hydrogen atom. The substituent which can be adopted as R^{f} is not particularly limited, and examples thereof include the substituent Z described later; and specific examples thereof include a halogen atom (for example, a fluorine atom, a chlorine atom, an iodine atom, or a bromine atom), an alkyl group (preferably having 1 to 12 carbon atoms, more preferably 1 to 6 carbon atoms, and particularly preferably 1 to 3 carbon atoms), an alkoxy group (preferably having 1 to 12 carbon atoms, more preferably 1 to 6 carbon atoms, and particularly preferably 1 to 3 carbon atoms), an acyl group (preferably having 2 to 12 carbon atoms, more preferably 2 to 6 carbon atoms, and particularly preferably 2 or 3 carbon atoms), an aryl group (preferably having 6 to 22 carbon atoms and more preferably 6 to 10 carbon atoms), an alkenyl group (preferably having 2 to 12 carbon atoms and more preferably 2 to 5 carbon atoms), a hydroxy group, a nitro group, a cyano group, a mercapto group, an amino group, an amide group, and an acidic group (a carboxyl group, a phosphate group, a sulfonate group, or the like). The acidic group may be a salt. Examples of a counter ion forming the salt include an alkali metal ion, an alkaline earth metal ion, an ammonium ion, and an alkylammonium ion.

The linking group L is preferably a linking group represented by Formula 1A or Formula 1B.

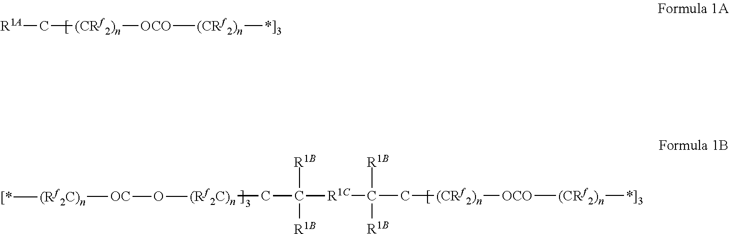

In both the formulae, R^{f} and n have the same definitions and the same preferred ranges as those of R^{f} and n in Formula 1a. * represents a bonding portion to a sulfur atom in Formula 1.

In Formula 1A, R^{1A} represents a hydrogen atom or a substituent. The substituent which can be adopted as R^{1A} is not particularly limited, and examples thereof include the respective substituents which can be adopted as R^{f} and the above-described group represented by Formula 1a. Among these, an alkyl group or the above-described group represented by Formula 1a is preferable. The number of carbon atoms in the alkyl group is preferably 1 to 12, more preferably 1 to 6, and particularly preferably 1 to 3. The substituent which can be adopted as R^{1A} may have one or two or more substituents, and the substituent which may be further included is not particularly limited; and examples thereof include the respective substituents which can be adopted as R^{f}. Among these, a hydroxy group is preferable. Examples of the substituent which may further have one or two or more substituents include a hydroxyalkyl group (the number of carbon atoms is as described above), and specifically, hydroxymethyl is preferable.

In Formula 1B, R^{1C} represents a linking group. The linking group which can be adopted as R^{1C} is not particularly limited, and is preferably an alkylene group having 1 to 30 carbon atoms, a cycloalkylene group having 3 to 12 carbon atoms, an arylene group having 6 to 24 carbon atoms, a heteroarylene group having 3 to 12 carbon atoms, an ether group (—O—), a sulfide group (—S—), a phosphinidene group (—PR—; R represents a hydrogen atom or an alkyl group having 1 to 6 carbon atoms), a silylene group (—SiR^{S1}R^{S2}—; R^{S1} and R^{S2} represent a hydrogen atom or an alkyl group having 1 to 6 carbon atoms), a carbonyl group, an imino group (—NR^{N}—; R^{N} represents a bonding site, a hydrogen atom, an alkyl group having 1 to 6 carbon atoms, or an aryl group having 6 to 10 carbon atoms), or a linking group of a combination of two or more (preferably 2 to 10) thereof. Among these, an alkylene group, an ether group, a sulfide group, a carbonyl group, or a linking group of a combination of two or more (preferably 2 to 5) thereof is preferable, and an ether group is more preferable. R^{1B} represents a hydrogen atom or a substituent, and is preferably a hydrogen atom. The substituent which can be adopted as R^{1B} is not particularly limited, and examples thereof include the respective substituents which can be adopted as R^{f}.

In Formula 1A and Formula 1B, groups represented by the same reference numeral may be the same or different from each other.

In addition to the above-described linking groups, as the linking group L, for example, a linking group in Formula 1B in which one or two or more of the groups represented by Formula 1a are substituted with each of the substituents which can be adopted as R^{f}, in particular, hydroxymethyl is also a preferred aspect.

As the linking group R¹, a linking group represented by any one of Formulae 1C to 1H is also preferable. In each of the formulae, * represents a bonding portion to S in Formula 1.

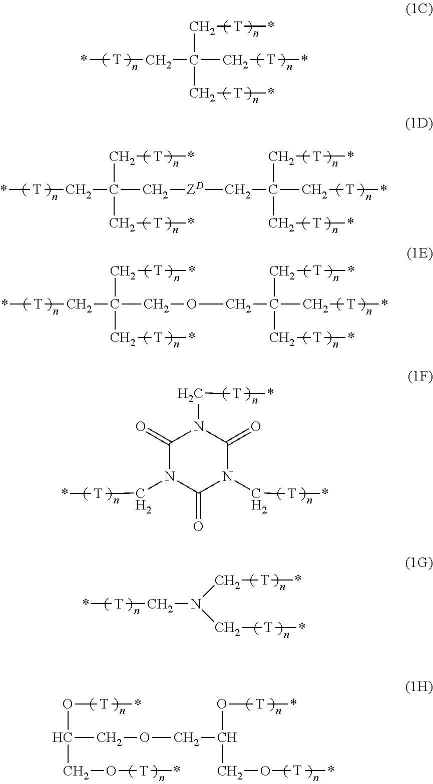

In Formulae 1C to 1H, T represents a linking group, preferably a group represented by any one of Formulae T1 to T6 or a linking group of a combination of two or more (preferably 2 or 3). Examples of the linking group of the combination include a linking group (—OCO-alkylene group) of a combination of the linking group represented by Formula T6 and the linking group represented by Formula T1. In the group represented by any one of Formulae T1 to T6, a sulfur atom in Formula 1 may be bonded to any bonding portion. However, in a case where T represents an oxyalkylene group (the group represented by any one of Formulae T2 to T5) or an —OCO-alkylene group, it is preferable that a sulfur atom in Formula 1 is bonded to a carbon atom (bonding portion) at a terminal.

A plurality of T's present in each of the above formulae may be the same or different from each other.

In each of Formulae 1C to 1H, n represents an integer, preferably an integer of 0 to 14, more preferably an integer of 0 to 5, and particularly preferably an integer of 1 to 3.

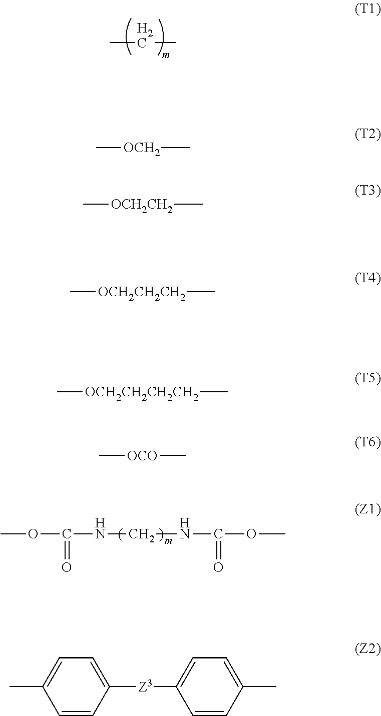

Z^{D} represents a linking group, and is preferably a group represented by Z1 or Z2.

In each of Formula T1 and Formula Z1, m represents an integer of 1 to 8, more preferably an integer of 1 to 5 and particularly preferably an integer of 1 to 3.

In Formula Z2, Z³ is a linking group, and is preferably an alkylene group having 1 to 12 carbon atoms and more preferably an alkylene group having 1 to 6 carbon atoms. Among these, a 2,2-propanediyl group is particularly preferable.

Hereinafter, specific examples of the linking group L are shown, but the present invention is not limited thereto. In each of the specific examples, * represents a bonding portion to a sulfur atom in Formula 1.

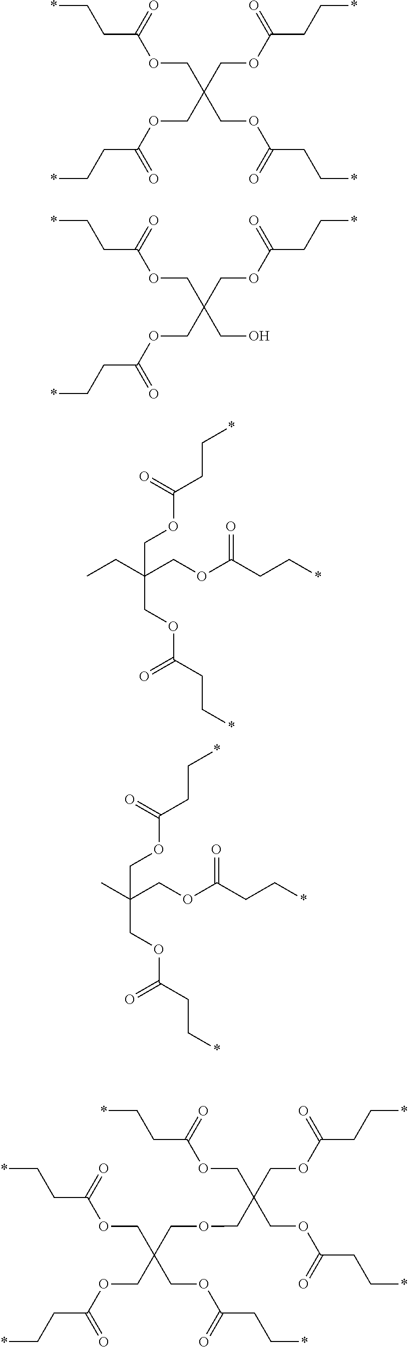

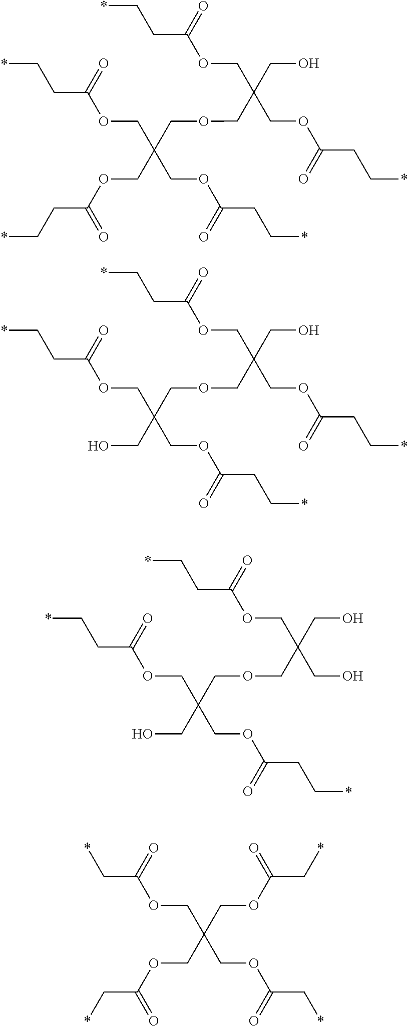

### (P¹ of Formula (1))

P¹ of Formula (1) is a polymer chain which forms a polymeric arm portion of the star structure.

The polymer chain P¹ includes the above-described constitutional component (X) as a whole, preferably includes the above-described constitutional component (A), and may appropriately include the above-described other constitutional components, but it is preferable to not include the other constitutional components.

In the multibranched polymer represented by Formula (1) (hereinafter, may be simply referred to as “polymer (1)”), n polymer chains P¹'s each include the above-described constitutional component (X), preferably include the above-described constitutional component (A), and may appropriately include the above-described other constitutional components, and may include the constitutional component (X) or the constitutional component (A) and appropriately include the other constitutional components.

n polymer chains P¹ may be the same or different from each other, and from the viewpoint of shortening the dispersion time and the dispersion characteristics, it is preferable that at least one polymer chain P¹ is a polymer chain including the above-described constitutional component (X) (hereinafter, also referred to as “polymer chain P^{1X}”) and at least one other polymer chain P¹ is a polymer chain including the above-described constitutional component (A) (hereinafter, also referred to as “polymer chain P^{1A}”). From the viewpoint of shortening the dispersion time and the dispersion characteristics, the polymer chain P^{1X} preferably does not include the above-described constitutional component (A), may include the other constitutional components, but more preferably does not include the other constitutional components, that is, the polymer chain P^{1X} is more preferably a homopolymerized chain of the constitutional component (X), still more preferably a homopolymerized chain of a constitutional component having a polymerized chain consisting of polysiloxane, and particularly preferably a homopolymerized chain of the (meth)acrylic compound (M1) having a polymerized chain consisting of polysiloxane. From the viewpoint of shortening the dispersion time and the dispersion characteristics, the polymer chain P^{1A} preferably does not include the above-described constitutional component (X), may include the other constitutional components, but more preferably does not include the other constitutional components, that is, the polymer chain P^{1A} is more preferably a homopolymerized chain of the constitutional component (A), and particularly preferably a homopolymerized chain of a (meth)acrylamide compound.

In the polymer (1), the number of polymer chains P^{1X} and the number of polymer chains P^{1A} are appropriately determined within the range indicated by n of Formula (1), and can be, for example, the same as nA and mX of Formula (2) described later.

In a case where the polymer chain P¹ includes two or more kinds of constitutional components, a primary structure of the polymer chain P¹ is not particularly limited, and any bonding mode of a random structure, a block structure, an alternating structure, or the like may be adopted, but a random structure or a block structure is preferable.

The group bonded to the terminal of the polymer chain P¹ is not particularly limited, and an appropriate group can be adopted depending on the polymerization method or the like as described above.

A content of the constitutional component (X) in the polymer chain P^{1X} is not particularly limited, but from the viewpoint of shortening the dispersion time and the dispersion characteristics, it is preferably 50% by mass or more, preferably 75% by mass or more, more preferably 90% by mass or more, still more preferably 95% by mass or more, and a case in which the content is 100% by mass is one of preferred aspects.

A content of the constitutional component (A) in the polymer chain P^{1X} is not particularly limited, but from the viewpoint of shortening the dispersion time and the dispersion characteristics, it is preferably 50% by mass or less, preferably 10% by mass or less, more preferably 5% by mass or less, and a case in which the content is 0% by mass is one of preferred aspects.

A content of the other constitutional components in the polymer chain P^{1X} is not particularly limited, but from the viewpoint of shortening the dispersion time and the dispersion characteristics, it is preferably 50% by mass or less, preferably 30% by mass or less, more preferably 10% by mass or less, and a case in which the content is 0% by mass is one of preferred aspects.

A content of the constitutional component (A) in the polymer chain P^{1A} is not particularly limited, but from the viewpoint of shortening the dispersion time and the dispersion characteristics, it is preferably 50% by mass or more, preferably 75% by mass or more, more preferably 90% by mass or more, still more preferably 95% by mass or more, and a case in which the content is 100% by mass is one of preferred aspects.

A content of the constitutional component (X) in the polymer chain P^{1A} is not particularly limited, but from the viewpoint of shortening the dispersion time and the dispersion characteristics, it is preferably 50% by mass or less, preferably 10% by mass or less, more preferably 5% by mass or less, and a case in which the content is 0% by mass is one of preferred aspects.

A content of the other constitutional components in the polymer chain P^{1A} is not particularly limited, but from the viewpoint of shortening the dispersion time and the dispersion characteristics, it is preferably 50% by mass or less, preferably 30% by mass or less, more preferably 10% by mass or less, and a case in which the content is 0% by mass is one of preferred aspects.

A weight-average molecular weight Mw^{P1} of the polymer chain P¹ (average value of weight-average molecular weights of n polymer chains P¹) is not particularly limited, and is appropriately set in consideration of the weight-average molecular weight of the polymer (1) which is an example of the polymer according to the embodiment of the present invention, and is, for example, preferably 500 to 20,000 and more preferably 1,000 to 10,000. In addition, a polymerization degree of all constitutional components in the polymer chain P¹ (average value of polymerization degrees of n polymer chains P¹) is not particularly limited, and is preferably 5 to 300 and more preferably 8 to 150.

A weight-average molecular weight Mw^{P1X} of the polymer chain P^{1X} (average value of weight-average molecular weights of all polymer chains P^{1X}) is not particularly limited, and is appropriately set in consideration of the weight-average molecular weight of the polymer (1) which is an example of the polymer according to the embodiment of the present invention, and is, for example, preferably 400 to 50,000 and more preferably 1,000 to 20,000. In addition, a polymerization degree of all constitutional components in the polymer chain P^{1X} (average value of polymerization degrees of all polymer chains P^{1X}) is not particularly limited, and is preferably 1 to 10 and more preferably 1 to 3.

A weight-average molecular weight Mw^{P1A} of the polymer chain P^{1A} (average value of weight-average molecular weights of all polymer chains P^{1A}) is not particularly limited, and is appropriately set in consideration of the weight-average molecular weight of the polymer (1) which is an example of the polymer according to the embodiment of the present invention, and is, for example, preferably 100 to 10,000 and more preferably 200 to 3,000. In addition, a polymerization degree of all constitutional components in the polymer chain P^{1A} (average value of polymerization degrees of all polymer chains P^{1A}) is not particularly limited, and is preferably 1 to 100 and more preferably 2 to 30.

In the polymer represented by Formula (1), a combination of the polymer chain A^{1X} and the polymer chain A^{1A} is not particularly limited, and the constitutional component (X) constituting the polymer chain A^{1X} and the constitutional component (A) constituting the polymer chain A^{1X} can be appropriately combined. The combination of the polymer chain A^{1X} and the polymer chain A^{1A} is preferably a combination of the suitable constitutional component which can be adopted as the constitutional component (X) and the suitable constitutional component which can be adopted as the constitutional component (A), and examples thereof include a combination of polymers shown in Examples.

### (n of Formula (1))

In Formula (1), n is an integer of 3 or more, and is preferably an integer of 3 to 10, more preferably an integer of 3 to 8, still more preferably an integer of 3 to 6, and particularly preferably an integer of 4 to 6.

A content of the core portion L in the polymer (1) is not particularly limited, but can be set to 1% to 40% by mass in total with “S” in the polymer (1), and is preferably 2% to 30% by mass, more preferably 2% to 20% by mass, and still more preferably 3% to 10% by mass, from the viewpoint of shortening the dispersion time and improving the dispersion characteristics.

The total content of the polymer chain P¹ in the polymer (1) is not particularly limited, but can be set to 60% to 99% by mass, and is preferably 70% to 98% by mass, more preferably 80% to 98% by mass, and still more preferably 90% to 97% by mass, from the viewpoint of shortening the dispersion time and improving the dispersion characteristics.

The total content of the polymer chain P^{1X} in the polymer (1) can be appropriately determined in consideration of the above-described total content of the polymer chain P¹, and for example, it is preferably the same as the above-described total content of the constitutional component (X) in the polymer according to the embodiment of the present invention, as the total content in the total content of the polymer chain P¹.

The total content of the polymer chain P^{1A} in the polymer (1) can be appropriately determined in consideration of the above-described total content of the polymer chain P¹, and for example, it is preferably the same as the above-described total content of the constitutional component (A) in the polymer according to the embodiment of the present invention, as the total content in the total content of the polymer chain P¹. In the polymer (1), a ratio [Total content of polymer chain P^{1X}/Total content of polymer chain P^{1A}] of the total content of the polymer chain P^{1X} to the total content of the polymer chain P^{1A} is not particularly limited, and is preferably the same as the ratio [Total content of constitutional component (X)/Total content of constitutional component (A)] of the total contents in the polymer according to the embodiment of the present invention.

The multibranched polymer represented by Formula (1) is preferably represented by Formula (2).

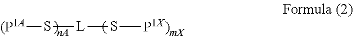

In Formula (2), L represents an (nA+mX)-valent linking group, and is the same as L in Formula (1) described above.

P^{1A} represents the above-described polymer chain P^{1A} including the above-described constitutional component (A), and nA pieces of P^{1A}'s may be the same or different from each other.

P^{1X} represents the above-described polymer chain P^{1X} including the above-described constitutional component (X), and nX pieces of P^{1X}s may be the same or different from each other.

In Formula (2), nA is an integer of 1 to 8, preferably an integer of 1 to 4, more preferably an integer of 1 to 3, and still more preferably 1 or 2.

mX represents an integer of 2 to 9, preferably an integer of 2 to 5 and more preferably an integer of 3 to 5.

Here, nA+mX represents an integer of 3 to 10, preferably an integer of 3 to 8, more preferably an integer of 3 to 6, and still more preferably an integer of 4 to 6.

The contents of L, P^{1A}, and P^{1X} in the polymer (1) are the same as the contents of L, P^{1A} and P^{1X} in Formula (1) described above.

Specific examples of the polymer represented by Formula (1) or Formula (2) include polymers synthesized in Examples described later, but the present invention is not limited thereto.

As the polymer according to the embodiment of the present invention, a commercially available product can be used, or a synthesized product can also be used. The polymer (1) can be synthesized by selecting a raw material compound by a known method. For example, the polymer (1) can be synthesized by condensation, homopolymerization, or copolymerization by a normal synthesis method using a surfactant, an emulsifier or a dispersant, a polycondensable compound from which the constitutional component (X) is derived, a polycondensable compound from which the constitutional component (A) is derived, a polycondensable compound from which the other constitutional components are derived, and the like. In addition, the multibranched polymer represented by Formula (1) or Formula (2) can be synthesized, for example, by an addition reaction of a polyvalent thiol compound corresponding to the core portion L with the above-described raw material compounds. Specifically, the multibranched polymer represented by Formula (1) or Formula (2) can be synthesized by a method described in Examples later.

A method of incorporating the polar functional group into the polymer according to the embodiment of the present invention is not particularly limited, and examples thereof include a method of copolymerizing with a compound having the functional group, a method of using a polymerization initiator or a chain transfer agent, having (generating) the above-described functional group, a method of using a polymeric reaction, an ene reaction or thiol-ene reaction with a double bond, and an atom transfer radical polymerization (ATRP) method using a copper catalyst. In addition, the functional group can be introduced by using a functional group which is present in the main chain, the side chain, or the terminal of the polymer, as a reaction point. For example, the functional group can be introduced by various reactions with a dicarboxylic acid anhydride group in a polymerized chain using a compound having the functional group.

### Substituent Z

Examples of the substitutent Z include an alkyl group (preferably an alkyl group having 1 to 20 carbon atoms; for example, methyl, ethyl, isopropyl, tert-butyl, pentyl, heptyl, 1-ethylpentyl, benzyl, 2-ethoxyethyl, 1-carboxymethyl, and the like); an alkenyl group (preferably an alkenyl group having 2 to 20 carbon atoms; for example, vinyl, allyl, oleyl, and the like); an alkynyl group (preferably an alkynyl group having 2 to 20 carbon atoms, for example, ethynyl, adynyl, phenylethynyl, and the like); a cycloalkyl group (preferably a cycloalkyl group having 3 to 20 carbon atoms; for example, cyclopropyl, cyclopentyl, cyclohexyl, 4-methylcyclohexyl, and the like; in the present invention, the alkyl group generally has a meaning including a cycloalkyl group in a case of being referred to, however, it will be described separately here); an aryl group (preferably an aryl group having 6 to 26 carbon atoms; for example, phenyl, 1-naphthyl, 4-methoxyphenyl, 2-chlorophenyl, 3-methylphenyl, and the like); an aralkyl group (preferably an aralkyl group having 7 to 23 carbon atoms; for example, benzyl, phenethyl, and the like); a heterocyclic group (preferably a heterocyclic group having 2 to 20 carbon atoms and more preferably a 5- or 6-membered heterocyclic group having at least one oxygen atom, one sulfur atom, or one nitrogen atom; the heterocyclic group includes an aromatic heterocyclic group and an aliphatic heterocyclic group; for example, a tetrahydropyran ring group, a tetrahydrofuran ring group, 2-pyridyl, 4-pyridyl, 2-imidazolyl, 2-benzimidazolyl, 2-thiazolyl, 2-oxazolyl, a pyrrolidone group, and the like); an alkoxy group (preferably an alkoxy group having 1 to 20 carbon atoms; for example, methoxy, ethoxy, isopropyloxy, benzyloxy, and the like); an aryloxy group (preferably an aryloxy group having 6 to 26 carbon atoms; for example, phenoxy, 1-naphthyloxy, 3-methylphenoxy, 4-methoxyphenoxy, and the like); a heterocyclic oxy group (a group in which an —O— group is bonded to the heterocyclic group); an alkoxycarbonyl group (preferably an alkoxycarbonyl group having 2 to 20 carbon atoms; for example, ethoxycarbonyl, 2-ethylhexyloxycarbonyl, dodecyloxycarbonyl, and the like); an aryloxycarbonyl group (preferably an aryloxycarbonyl group having 7 to 26 carbon atoms; for example, phenoxycarbonyl, 1-naphthyloxycarbonyl, 3-methylphenoxycarbonyl, 4-methoxyphenoxycarbonyl, and the like); a heterocyclic oxycarbonyl group (a group in which an —O—CO— group is bonded to the heterocyclic group); an amino group (preferably an amino group having 0 to 20 carbon atoms; including an alkylamino group and an arylamino group; for example, amino (—NH₂), N,N-dimethylamino, N,N-diethylamino, N-ethylamino, anilino, and the like); a sulfamoyl group (preferably a sulfamoyl group having 0 to 20 carbon atoms; for example, N,N-dimethylsulfamoyl, N-phenylsulfamoyl, and the like); an acyl group (including an alkylcarbonyl group, an alkenylcarbonyl group, an alkynylcarbonyl group, an arylcarbonyl group, and a heterocyclic carbonyl group; preferably an acyl group having 1 to 20 carbon atoms; for example, acetyl, propionyl, butyryl, octanoyl, hexadecanoyl, acryloyl, methacryloyl, crotonoyl, benzoyl, naphthoyl, nicotinoyl, and the like); an acyloxy group (including an alkylcarbonyloxy group, an alkenylcarbonyloxy group, an alkynylcarbonyloxy group, and a heterocyclic carbonyloxy group; preferably an acyloxy group having 1 to 20 carbon atoms; for example, acetyloxy, propionyloxy, butyryloxy, octanoyloxy, hexadecanoyloxy, acryloyloxy, methacryloyloxy, crotonyloxy, nicotinoyloxy, and the like); an aryloyloxy group (preferably an aryloyloxy group having 7 to 23 carbon atoms; for example, benzoyloxy, naphthoyloxy, and the like);
a carbamoyl group (preferably a carbamoyl group having 1 to 20 carbon atoms; for example, N,N-dimethylcarbamoyl, N-phenylcarbamoyl, and the like); an acylamino groups (preferably an acylamino group having 1 to 20 carbon atoms; for example, acetylamino, benzoylamino, and the like); an alkylthio group (preferably an alkylthio group having 1 to 20 carbon atoms; for example, methylthio, ethylthio, isopropylthio, benzylthio, and the like); an arylthio group (preferably an arylthio group having 6 to 26 carbon atoms; for example, phenylthio, 1-naphthylthio, 3-methylphenylthio, 4-methoxyphenylthio, and the like); a heterocyclic thio groups (a group in which an —S— group is bonded to the heterocyclic group); an alkylsulfonyl group (preferably an alkylsulfonyl group having 1 to 20 carbon atoms; for example, methyl sulfonyl, ethyl sulfonyl, and the like); an arylsulfonyl group (preferably an arylsulfonyl group having 6 to 22 carbon atoms; for example, benzenesulfonyl and the like); an alkylsilyl group (preferably an alkylsilyl group having 1 to 20 carbon atoms; for example, monomethylsilyl, dimethylsilyl, trimethylsilyl, triethylsilyl, and the like); an arylsilyl group (preferably an arylsilyl group having 6 to 42 carbon atoms; for example, triphenylsilyl and the like); an alkoxysilyl group (preferably an alkoxysilyl group having 1 to 20 carbon atoms; for example, monomethoxysilyl, dimethoxysilyl, trimethoxysilyl, triethoxysilyl, and the like); an aryloxysilyl groups (preferably an aryloxysilyl group having 6 to 42 carbon atoms; for example, triphenyloxysilyl and the like); a phosphoryl group (preferably a phosphate group having 0 to 20 carbon atoms; for example, —OP(═O)(RP)₂); a phosphonyl group (preferably a phosphonyl group having 0 to 20 carbon atoms; for example, —P(═O)(RP)₂), a phosphinyl group (preferably a phosphinyl group having 0 to 20 carbon atoms; for example, —P(RP)₂), a phosphonic acid group (preferably a phosphonic acid group having 0 to 20 carbon atoms; for example, —PO(ORP)₂); a sulfo group (sulfonic acid group), a carboxy group, a hydroxy group, a sulfanyl group, a cyano group, and a halogen atom (for example, a fluorine atom, a chlorine atom, a bromine atom, an iodine atom, and the like). RP is a hydrogen atom or a substituent (preferably, a group selected from the substituent Z).

In addition, each group exemplified in the substituent Z may be further substituted with the substituent Z.

The alkyl group, the alkylene group, the alkenyl group, the alkenylene group, the alkynyl group, the alkynylene group, and/or the like described above may be cyclic or chain-like, and may be linear or branched.

### Physical Properties, Characteristics, and the Like of Polymer According to Embodiment of Present Invention

The polymer according to the embodiment of the present invention has a viscosity of 0.10 to 10,000 Pa·s at a temperature of 25° C. and a shear rate of 1 s⁻¹. In a case where the viscosity of the polymer according to the embodiment of the present invention is within the above-described range, the polymer is liquid at 25° C., and thus the solid particles can be easily dispersed in the dispersion medium, and the dispersion time of the solid particles can be shortened. In addition, even in a case where the dispersion time of the solid particles is shortened, the solid particles can be dispersed in the dispersion medium with excellent dispersion characteristics.

From the viewpoint of shortening the dispersion time and improving the dispersion characteristics, the above-described viscosity of the polymer according to the embodiment of the present invention is preferably 0.50 to 9,000 Pa·s. In a case where the polymer according to the embodiment of the present invention has a graft structure, the viscosity thereof is more preferably 10 to 8,000 Pa·s and still more preferably 105 to 6,000 Pa·s within the above-described range. On the other hand, in a case where the polymer according to the embodiment of the present invention has a multibranched structure, the viscosity thereof is more preferably 10 to 9,000 Pa·s, still more preferably 100 to 8,000 Pa·s, particularly preferably 1,500 to 7,500 Pa·s, and most preferably 2,000 to 6,300 Pa·s within the above-described range. The viscosity of the polymer according to the embodiment of the present invention can be measured using a rheometer under conditions of a temperature of 25° C. and a shear rate of 1 s⁻¹. In the present invention, the viscosity is measured using RhoeStress RS6000 (product name, manufactured by HAAKE) as a rheometer.

The viscosity of the polymer according to the embodiment of the present invention can be appropriately adjusted by changing the molecular structure of the polymer, the kind and content of the polycondensable compound, the weight-average molecular weight, and the like.

The polymer according to the embodiment of the present invention preferably has the following physical properties, characteristics, and the like.

From the viewpoint of shortening the dispersion time and improving the dispersion characteristics, an SP value of the polymer chain in the polymer according to the embodiment of the present invention is preferably 15.0 to 25.0 MPa^{1/2}, more preferably 17.0 to 22.0 MPa^{1/2}, and still more preferably 17.5 to 20.0 MPa^{1/2}.

In the present invention, the SP value of the polymer chain refers to an SP value calculated from all constitutional components derived from the polycondensable compound constituting the polymer according to the embodiment of the present invention, and a compound from which a partial structure other than the polymerizable compound is derived is not considered. For example, the SP value is calculated without including the terminal group of the polymer chain, the core portion of the multibranched polymer, and the like.

In the present invention, the SP value of the constitutional component and the polymer according to the embodiment of the present invention is a value calculated by OKITSU method. The OKITSU method is described in detail in, for example, Journal of the Adhesion Society of Japan, 1993, Vol. 29, No. 6, pp. 249 to 259, and Textile Machinery Society Journal, 1994, Vol. 50, No. 6, pp. 273 to 277. The SP value of the constitutional component is a value calculated based on a structure in which the constitutional component is incorporated into the polymer according to the embodiment of the present invention. The SP value of the polymer according to the embodiment of the present invention is a value calculated from the SP value of each constitutional component and a mass fraction of the constitutional component.

The SP value of the polymer according to the embodiment of the present invention can be appropriately adjusted by changing the kind and content of the polycondensable compound, and the like.

A weight-average molecular weight of the polymer according to the embodiment of the present invention is not particularly limited, and is, for example, preferably 3,000 or more, more preferably 5,000 or more, and still more preferably 7,000 or more. The upper limit of the weight-average molecular weight is substantially 100,000 or less, but is preferably 50,000 or less, more preferably 30,000 or less, still more preferably 20,000 or less, and particularly preferably 15,000 or less, from the viewpoint of shortening the dispersion time and improving the dispersion characteristics.

In a case where the polymer according to the embodiment of the present invention has a graft structure, the weight-average molecular weight thereof can be appropriately set to a weight-average molecular weight within the above-described range, but is preferably 3,000 to 30,000 and more preferably 4,000 to 15,000 in a preferred aspect. On the other hand, in a case where the polymer according to the embodiment of the present invention has a multibranched structure, the weight-average molecular weight thereof can be appropriately set to a weight-average molecular weight within the above-described range, but is preferably 5,000 to 70,000 and more preferably 10,000 to 30,000 in a preferred aspect.

The weight-average molecular weight of the polymer according to the embodiment of the present invention can be appropriately adjusted by changing the kind and content of the polymerization initiator and the like, polymerization time, polymerization temperature, and the like.

### Measurement of Molecular Weight

In the present invention, a molecular weight of the polymer and the polymer chain means a weight-average molecular weight or a number-average molecular weight in terms of standard polystyrene, which is measured by gel permeation chromatography (GPC), unless otherwise specified. A measuring method thereof includes, basically, a method in which conditions are set to Condition 1 or Condition 2 (preferential) described below. In this case, an appropriate eluant may be selected and used depending on the type of the polymer and the polymer chain.

### (Condition 1)

Column: two connected columns of TOSOH TSKgel Super AWM-H (trade name, manufactured by Tosoh Corporation)
Carrier: 10 mM LiBr/N-methylpyrrolidone
Measurement temperature: 40° C.
Carrier flow rate: 1.0 ml/min
Sample concentration: 0.1 mass %
Detector: refractive index (RI) detector

### (Condition 2)

Column: column obtained by connecting TOSOH TSKgel Super HZM-H, TOSOH TSKgel Super HZ4000, and TOSOH TSKgel Super HZ2000 (all of which are trade names, manufactured by Tosoh Corporation)
Carrier: tetrahydrofuran
Measurement temperature: 40° C.
Carrier flow rate: 1.0 ml/min
Sample concentration: 0.1 mass %
Detector: refractive index (RI) detector

The polymer according to the embodiment of the present invention preferably has no flash point. By the polymer according to the embodiment of the present invention having no flash point, a detailed mechanism is not clear, but a high dispersion effect is obtained. In the present invention, the fact that the polymer according to the embodiment of the present invention has no flash point means that the flash point is 250° C. or higher. In other words, the polymer according to the embodiment of the present invention preferably has a flash point of 250° C. or higher.

The fact that the polymer according to the embodiment of the present invention has no flash point can be identified by measuring the flash point according to Japanese Industrial Standards (JIS) K 2265-1, ASTM D3278, JIS K 2265-3, and the like, usually according to JIS K 2265-1.

The polymer according to the embodiment of the present invention has the above-described constitutional component (A) having the polar functional group, but preferably has a small acid value, and for example, preferably has an acid value of 3 mgKOH/g or less. It is considered that, in a case where the acid value is 3 mgKOH/g or less, excessive aggregation and precipitation of the polymer according to the embodiment of the present invention and the solid particles can be suppressed. The acid value of the polymer according to the embodiment of the present invention is still more preferably 2 mgKOH/g or less, particularly preferably 1 mgKOH/g or less, and most preferably 0.5 mgKOH/g or less. The lower limit value of the acid value of the polymer according to the embodiment of the present invention is preferably 0 mgKOH/g.

The acid value of the polymer according to the embodiment of the present invention indicates the number of milligrams of potassium hydroxide required to neutralize an acidic group present in 1 g of the polymer according to the embodiment of the present invention, and can be measured by the following method.

The acidic group is not particularly limited as long as it is neutralized with potassium hydroxide, and examples thereof include a carboxylic acid group (carboxy group), a sulfonic acid group (sulfo group), a phosphoric acid group (phospho group), a phosphonic acid group, a phosphinic acid group, and salts thereof.

### (Measuring Method)

1 g of the polymer according to the embodiment of the present invention is dissolved in 25 g of tetrahydrofuran, and is titrated with a 0.01 N-KOH solution using a potential difference titration device to be determined.

The polymer according to the embodiment of the present invention has the above-described constitutional component (A) having the polar functional group, but preferably has a small base value, and for example, preferably has a base value of 2 mgKOH/g or less. It is considered that, in a case where the base value is 2 mgKOH/g or less, excessive aggregation and precipitation of the polymer according to the embodiment of the present invention and the solid particles can be suppressed. The base value of the polymer according to the embodiment of the present invention is more preferably 1 mgKOH/g or less, and still more preferably 0.5 mgKOH/g or less. The lower limit value of the base value of the polymer according to the embodiment of the present invention is preferably 0 mgKOH/g.

The base value of the polymer according to the embodiment of the present invention indicates the number of milligrams of potassium hydroxide corresponding to the number of moles of acid required to neutralize a basic group present in 1 g of the polymer according to the embodiment of the present invention, and can be measured by the following method.

The basic group is not particularly limited as long as it is neutralized with HCl, and examples thereof include a group having a basic nitrogen atom, preferably a group having a basic nitrogen atom bonded to a hydrogen atom. Specific examples thereof include an amino group, a pyridyl group, an imino group, an amidine group, and the above-described urea group or urethane group having a hydrogen atom bonded to a nitrogen atom.

### (Measuring Method)

1 g of the polymer according to the embodiment of the present invention is dissolved in 25 g of tetrahydrofuran, and is titrated with a 1 N—HCl solution using a potential difference titration device to be determined. The number of moles of HCl required for the neutralization is converted into the number of milligrams of potassium hydroxide.

The acid value and the base value in the polymer according to the embodiment of the present invention may be within the above-described ranges, but it is still more preferable that the acid value is 0.5 mgKOH/g or less and the base value is 0.5 mgKOH/g or less.

The polymer according to the embodiment of the present invention may be a non-crosslinked polymer or a crosslinked polymer. In addition, in a case where crosslinking of the polymer according to the embodiment of the present invention progresses due to heating or voltage application, the molecular weight may be higher than the above-described molecular weight. It is preferable that the polymer according to the embodiment of the present invention has a weight-average molecular weight in the above-described range at the start of use of the all-solid-state secondary battery.

The polymer according to the embodiment of the present invention is preferably amorphous. In the present invention, the description that a polymer is “amorphous” typically refers to that no endothermic peak due to crystal melting is observed in a case where the measurement is carried out at the glass transition temperature.

A watery moisture concentration of the polymer according to the embodiment of the present invention is preferably 100 ppm (in terms of mass) or less. In addition, the polymer according to the embodiment of the present invention may be dried by crystallization, or a polymer dispersion liquid may be used as it is.

### <Other Components>

The polymer according to the embodiment of the present invention usually consists of the above-described polymer according to the embodiment of the present invention, but may contain a component used in polymerization, such as a polymerization initiator and a decomposition product thereof. In addition, the polymer according to the embodiment of the present invention can also be used as a polymer solution according to the present invention, in which the polymer is dissolved or dispersed in a dispersion medium or the like described later.

### [Composition for Non-Aqueous Secondary Battery]

The composition for a non-aqueous secondary battery according to the embodiment of the present invention is a composition containing the polymer according to the embodiment of the present invention.

In the present invention, in a case where the composition for a non-aqueous secondary battery is used as a material which forms a constituent layer of an all-solid-state secondary battery, it is referred to as a inorganic solid electrolyte-containing composition; and in a case where composition for a non-aqueous secondary battery is used as a material which forms an electrode layer of a non-aqueous electrolytic solution secondary battery, it is also referred to as an electrode composition of a non-aqueous electrolytic solution secondary battery.

It is preferable that the composition for a non-aqueous secondary battery according to the embodiment of the present invention contains an appropriate component depending on the application or the like, in addition to the polymer according to the embodiment of the present invention. For example, in a case of the electrode composition of a non-aqueous electrolytic solution secondary battery, the composition for a non-aqueous secondary battery according to the embodiment of the present invention contains the polymer according to the embodiment of the present invention and an active material, and appropriately contains a conductive auxiliary agent, other components described later, a dispersion medium, and the like. On the other hand, in a case of the inorganic solid electrolyte-containing composition, the composition for a non-aqueous secondary battery according to the embodiment of the present invention contains the polymer according to the embodiment of the present invention and an inorganic solid electrolyte having ionic conductivity of a metal belonging to Group 1 or Group 2 in the periodic table, and appropriately contains an active material, a conductive auxiliary agent, a dispersion medium, and other components described later.

In the composition for a non-aqueous secondary battery according to the present invention, each component contained in the polymer according to the embodiment of the present invention does not need to be integrally present as the polymer according to the embodiment of the present invention, and each component may be present independently (separately).

As described above, the composition for a non-aqueous secondary battery according to the embodiment of the present invention is dispersed with excellent dispersion characteristics without damaging the solid particles such as the inorganic solid electrolyte even in a case where the concentration of solid contents is increased. A concentration of solid contents in this case is not uniquely determined by changing the temperature of the composition, the kind of the solid particles, and the like, but can be, for example, 40% by mass or more at 25° C., and can be further 50% by mass or more.

By using the composition for a non-aqueous secondary battery according to the embodiment of the present invention, which exhibits the above-described characteristics, as a constituent layer-forming material of a non-aqueous secondary battery, a sheet for a non-aqueous secondary battery having a constituent layer with low resistance and a non-aqueous secondary battery having excellent cycle characteristics with low resistance (high conductivity) can be realized.

Therefore, the composition for a non-aqueous secondary battery according to the embodiment of the present invention can be preferably used as a constituent layer-forming material of a sheet for a non-aqueous secondary battery (including an electrode sheet for a non-aqueous secondary battery) or a non-aqueous secondary battery.

In the composition for a non-aqueous secondary battery according to the embodiment of the present invention, the polymer according to the embodiment of the present invention may be dispersed in a particle shape without exhibiting solubility in the dispersion medium contained in the composition for a non-aqueous secondary battery, and it is preferable to exhibit the solubility. That is, the polymer according to the embodiment of the present invention in the composition for a non-aqueous secondary battery is preferably present in a state of being dissolved in the dispersion medium in the composition for a non-aqueous secondary battery, depending on the content thereof. In a case where the polymer according to the embodiment of the present invention is dissolved, a function of dispersing solid particles in the dispersion medium is stably exhibited, and the dispersion characteristics of the solid particles in the composition for a non-aqueous secondary battery can be further improved.

In the present invention, the polymer according to the embodiment of the present invention being dissolved in the dispersion medium is not limited to an aspect in which all the binders according to the embodiment of the present invention are dissolved in the dispersion medium; and for example, a part of the polymer according to the embodiment of the present invention may be present in an insoluble form in the composition for a non-aqueous secondary battery as long as the following solubility in the dispersion medium is 80% or more.

A measuring method of the solubility is as follows. That is, a specified amount of the polymer according to the embodiment of the present invention as a measurement target is weighed in a glass bottle, 100 g of a dispersion medium which is the same kind as the dispersion medium contained in the composition for a non-aqueous secondary battery is added thereto, and stirring is carried out at a temperature of 25° C. on a mix rotor at a rotation speed of 80 rpm for 24 hours. After stirring for 24 hours, the mixed solution obtained in this way is subjected to a transmittance measurement under the following conditions. The test (transmittance measurement) is carried out by changing the amount of the binder dissolved (the above-described specified amount), and the upper limit concentration X (% by mass) at which the transmittance is 99.8% is defined as the solubility of the binder according to the embodiment of the present invention in the above-described dispersion medium.

### <Transmittance Measurement Conditions>

Dynamic light scattering (DLS) measurement
Device: DLS measuring device DLS-8000 manufactured by Otsuka Electronics Co., Ltd.
Laser wavelength, output: 488 nm/100 mW
Sample cell: NMR tube

In a case where the polymer according to the embodiment of the present invention is in a particulate form (in a case where the polymer according to the embodiment of the present invention is not dissolved in the dispersion medium contained in the composition for a non-aqueous secondary battery), a shape thereof is not particularly limited, and may be flat, amorphous, or the like, but is preferably spherical or granular. In this case, in the composition for a non-aqueous secondary battery, an average particle diameter of the particulate polymer according to the embodiment of the present invention is not particularly limited, but is preferably 1 nm or more, more preferably 10 nm or more, and still more preferably 30 nm or more. The upper limit value thereof is preferably 5 m or less, and more preferably 1 m or less. The average particle diameter of the polymer according to the embodiment of the present invention can be measured in the same manner as the particle diameter of the inorganic solid electrolyte described above. The average particle diameter of the polymer according to the embodiment of the present invention can be adjusted, for example, by the kind of the dispersion medium, the formulation of the polymer, and the like.

In the present invention, the solubility of the polymer according to the embodiment of the present invention in the dispersion medium can be appropriately imparted by the structure, the formulation (the type and the content of the constitutional component), the weight-average molecular weight of the polymer according to the embodiment of the present invention, and the combination with the dispersion medium.

The composition for a non-aqueous secondary battery according to the embodiment of the present invention is preferably a slurry in which the solid particles such as the inorganic solid electrolyte are dispersed in the dispersion medium.

In addition, the composition for a non-aqueous secondary battery according to the embodiment of the present invention is preferably a non-aqueous composition. In the present invention, the non-aqueous composition includes not only an aspect including no watery moisture but also an aspect in which the moisture content (also referred to as the watery moisture content) is preferably 500 ppm or less. In the non-aqueous composition, the moisture content is more preferably 200 ppm or less, still more preferably 100 ppm or less, and particularly preferably 50 ppm or less. In a case where the composition for a non-aqueous secondary battery is a non-aqueous composition, the polymer according to the embodiment of the present invention can be dissolved, and the solid particles, particularly the inorganic solid electrolyte can be suppressed from being deteriorated. The water content refers to the water amount (mass proportion to the composition for a non-aqueous secondary battery) contained in the composition for a non-aqueous secondary battery, and specifically, it is a value measured by carrying out filtration through a 0.02 m membrane filter and then Karl Fischer titration.

The composition for a non-aqueous secondary battery according to the embodiment of the present invention includes an aspect containing not only the inorganic solid electrolyte but also an active material, as well as a conductive auxiliary agent or the like (the composition in this aspect may be referred to as an electrode composition).

Hereinafter, components which are contained in the composition for a non-aqueous secondary battery according to the embodiment of the present invention and components which can be contained therein will be described.

### <Polymer According to Embodiment of Present Invention>

The composition for a non-aqueous secondary battery according to the embodiment of the present invention contains the above-described polymer according to the embodiment of the present invention. The composition for a non-aqueous secondary battery may contain one kind or two or more kinds of the polymers according to the embodiment of the present invention.

A content (in terms of solid contents) of the polymer according to the embodiment of the present invention in the composition for a non-aqueous secondary battery can be appropriately determined, and for example, is preferably 0.1 to 5.0% by mass, more preferably 0.2 to 4.0% by mass, and still more preferably 0.3 to 2.0% by mass, from the viewpoint of suppressing damage to the solid particles and the dispersion characteristics of the solid particles. For the same reason, the content (in terms of solid contents) of the polymer according to the embodiment of the present invention in 100% by mass of the solid content of the composition for a non-aqueous secondary battery is preferably 0.1% to 6.0% by mass, more preferably 0.2% to 5.0% by mass, and still more preferably 0.3% to 2.5% by mass.

In the present invention, in 100% by mass of the solid content, a mass ratio [(Mass of inorganic solid electrolyte+Mass of active material)/(Total mass of polymer according to embodiment of present invention)] of the total mass (total amount) of the inorganic solid electrolyte and the active material to the mass of the polymer according to the embodiment of the present invention is preferably in a range of 2,000 to 1. The ratio is more preferably 1,000 to 10 and still more preferably 500 to 20.

### <Inorganic Solid Electrolyte>

The composition for a non-aqueous secondary battery according to the embodiment of the present invention, particularly the inorganic solid electrolyte-containing composition according to the embodiment of the present invention contains an inorganic solid electrolyte.

In the present invention, the inorganic solid electrolyte is an inorganic solid electrolyte, where the solid electrolyte refers to a solid-form electrolyte capable of migrating ions therein. The inorganic solid electrolyte is clearly distinguished from an organic solid electrolyte (a polymeric electrolyte such as polyethylene oxide (PEO), and an organic electrolyte salt such as lithium bis(trifluoromethanesulfonyl)imide (LiTFSI)) since it does not include any organic substance as a principal ion-conductive material. In addition, the inorganic solid electrolyte is solid in a steady state, and thus, typically, is not dissociated or liberated into cations and anions. From the viewpoint, the inorganic solid electrolyte is also clearly distinguished from an inorganic electrolyte salt in which cations and anions are dissociated or liberated in electrolytic solutions or polymers (LiPF₆, LiBF₄, lithium bis(fluorosulfonyl)imide (LiFSI), LiCl, and the like). The inorganic solid electrolyte is not particularly limited as long as it has ionic conductivity of a metal belonging to Group 1 or Group 2 in the periodic table, and generally does not have electron conductivity. In a case where the all-solid-state secondary battery according to the embodiment of the present invention is a lithium ion battery, the inorganic solid electrolyte preferably has ion conductivity for lithium ions.

As the above-described inorganic solid electrolyte, a solid electrolyte material which is typically used for an all-solid-state secondary battery can be appropriately selected and used. Examples of the inorganic solid electrolyte include (i) a sulfide-based inorganic solid electrolyte, (ii) an oxide-based inorganic solid electrolyte, (iii) a halide-based inorganic solid electrolyte, and (iv) a hydride-based inorganic solid electrolyte. Since the polymer according to the embodiment of the present invention can reduce a load acting on the inorganic solid electrolyte to suppress deterioration and decomposition of the inorganic solid electrolyte in a case of preparing the composition for a non-aqueous secondary battery, a sulfide-based inorganic solid electrolyte which is generally likely to deteriorate and decompose can be used, and a favorable interface between the active material and the inorganic solid electrolyte can be formed to effectively suppress an increase in interface resistance.

### (i) Sulfide-Based Inorganic Solid Electrolyte

The sulfide-based inorganic solid electrolyte is preferably an electrolyte which contains a sulfur atom, has ionic conductivity of a metal belonging to Group 1 or Group 2 in the periodic table, and has electron-insulating properties. The sulfide-based inorganic solid electrolyte is preferably an inorganic solid electrolyte which contains, as elements, at least Li, S, and P and have lithium ion conductivity, but the sulfide-based inorganic solid electrolyte may appropriately contain elements other than Li, S, and P.

Examples of the sulfide-based inorganic solid electrolyte include an inorganic solid electrolyte having ionic conductivity for lithium ions, which satisfies a formulation represented by Formula (S1).

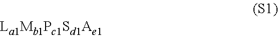

In Formula (Si), L represents an element selected from Li, Na, or K, and is preferably Li. M represents an element selected from B, Zn, Sn, Si, Cu, Ga, Sb, Al, or Ge. A represents an element selected from I, Br, Cl, or F. a1 to e1 represent compositional ratios between the respective elements, and a1:b1:c1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios between the respective elements can be controlled by adjusting the amounts of raw material compounds blended to manufacture the sulfide-based inorganic solid electrolyte as described below.

The sulfide-based inorganic solid electrolyte may be non-crystalline (glass) or crystallized (made into glass ceramic), and may be only partially crystallized. For example, it is possible to use Li—P—S-based glass containing Li, P, and S or Li—P—S-based glass ceramic containing Li, P, and S.

The sulfide-based inorganic solid electrolyte can be manufactured by a reaction of at least two or more raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), and sulfides of an element represented by M described above (for example, SiS₂, SnS, and GeS₂).

A ratio between Li₂S and P₂S₅ in the Li—P—S-based glass and the Li—P—S-based glass ceramic is preferably 60:40 to 90:10 and more preferably 68:32 to 78:22 in terms of a molar ratio between Li₂S:P₂S₅. In a case where the ratio between Li₂S and P₂S₅ is set in the above-described range, it is possible to increase the lithium ion conductivity. Specifically, the lithium ion conductivity can be preferably set to 1×10⁴ S/cm or more, and more preferably set to 1×10³ S/cm or more. The upper limit thereof is not particularly limited, and it is practically 1×10⁻¹ S/cm or less.

As specific examples of the sulfide-based inorganic solid electrolyte, combination examples of raw materials are described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, and Li₁₀GeP₂Si₂. However, a mixing ratio of the respective raw materials is not important. Examples of a method of synthesizing the sulfide-based inorganic solid electrolyte material using the above-described raw material compositions include an amorphization method. Examples of the amorphization method include a mechanical milling method, a solution method, and a melting quenching method. This is because the treatments can be carried out at normal temperature, and it is possible to simplify manufacturing process.

### (ii) Oxide-Based Inorganic Solid Electrolyte

The oxide-based inorganic solid electrolyte is preferably an electrolyte which contains an oxygen atom, has ionic conductivity of a metal belonging to Group 1 or Group 2 in the periodic table, and has electron-insulating properties.

An ion conductivity of the oxide-based inorganic solid electrolyte is preferably 1×10⁻⁶ S/cm or more, more preferably 5×10⁻⁶ S/cm or more, and particularly preferably 1×10⁻⁵ S/cm or more. The upper limit thereof is not particularly limited, and it is practically 1×10⁻¹ S/cm or less.

Specific examples of the compound include LiₓₐLa_{ya}TiO₃ (LLT) [xa satisfies 0.3≤xa≤0.7 and ya satisfies 0.3≤ya≤0.7]; Li_{xb}La_{yb}Zr_{zb}M^{bb}_{mb}O_{nb} (M^{bb} is one or more elements selected from Al, Mg, Ca, Sr, V, Nb, Ta, Ti, Ge, In, and Sn, xb satisfies 5≤xb≤10, yb satisfies 1≤yb≤4, zb satisfies 1≤zb≤4, mb satisfies 0≤mb≤2, and nb satisfies 5≤nb≤20); Li_{xc}B_{yc}M^{cc}_{zc}O_{nc}(M^{cc} is one or more elements selected from C, S, Al, Si, Ga, Ge, In, and Sn, xc satisfies 0<xc≤5, yc satisfies 0<yc≤1, zc satisfies 0<zc≤1, and nc satisfies 0<nc≤6); Li_{xd}(Al,Ga)_{yd}(Ti,Ge)_{zd}Si_{ad}P_{md}O_{nd} (xd satisfies 1≤xd≤3, yd satisfies 0≤yd≤1, zd satisfies 0≤zd≤2, ad satisfies 0≤ad≤1, md satisfies 1≤md≤7, and nd satisfies 3≤nd≤13.); Li₍₃₋₂ₓₑ₎M^{ee}ₓₑD^{ee}O (xe represents a number of 0 or more and 0.1 or less, M^{ee} represents a divalent metal atom, D^{ee} represents a halogen atom or a combination of two or more halogen atoms); Li_{xf}Si_{yf}O_{zf} (xf satisfies 1≤xf≤5, yf satisfies 0≤yf≤3, and zf satisfies 1≤zf≤10); Li_{xg}S_{yg}O_{zg}(xg satisfies 1≤xg≤3, yg satisfies 0<yg≤2, and zg satisfies 1≤zg≤10); Li₃BO₃; Li₃BO₃—Li₂SO₄; Li₂O—B₂O₃—P₂O₅; Li₂O—SiO₂; Li₆BaLa₂Ta₂Oi₂; Li₃PO_{(4-3/2w)}N_{w} (w satisfies w<1); Li_{3.5}Zn_{0.25}GeO₄ having a lithium super ionic conductor (LISICON)-type crystal structure; La_{0.55}Li_{0.35}TiO₃ having a perovskite-type crystal structure; LiTi₂P₃O₁₂ having a natrium super ionic conductor (NASICON)-type crystal structure; Li_{1+xh+yh}(Al, Ga)ₓₕ(Ti, Ge)₂₋ₓₕSi_{yh}P_{3-yh}O₁₂ (xh satisfies 0≤xh≤1 and yh satisfies 0≤yh≤1); and Li₇La₃Zr₂O₁₂ (LLZ) having a garnet-type crystal structure.

In addition, a phosphorus compound containing Li, P, or O is also desirable. Examples thereof include lithium phosphate (Li₃PO₄); LiPON in which a part of oxygen elements in lithium phosphate are replaced with a nitrogen element; and LiPOD¹ (D¹ is preferably one or more elements selected from Ti, V, Cr, Mn, Fe, Co, Ni, Cu, Zr, Nb, Mo, Ru, Ag, Ta, W, Pt, and Au).

Furthermore, it is also possible to preferably use LiA¹ON (A¹ is one or more elements selected from Si, B, Ge, Al, C, and Ga).

(iii) Halide-Based Inorganic Solid Electrolyte

The halide-based inorganic solid electrolyte is preferably a compound which contains a halogen atom, has ionic conductivity of a metal belonging to Group 1 or Group 2 in the periodic table, and has electron-insulating properties.

The halide-based inorganic solid electrolyte is not particularly limited, and examples thereof include LiCl, LiBr, LiI, and compounds such as Li₃YBr₆ and Li₃YCl₆ described in ADVANCED MATERIALS, 2018, 30, 1803075. Among these, Li₃YBr₆ or Li₃YCl₆ is preferable.

### (iv) Hydride-Based Inorganic Solid Electrolyte

The hydride-based inorganic solid electrolyte is preferably a compound which contains a hydrogen atom, has ionic conductivity of a metal belonging to Group 1 or Group 2 in the periodic table, and has electron-insulating properties.

The hydride-based inorganic solid electrolyte is not particularly limited, and examples thereof include LiBH₄, Li₄(BH₄)₃I, and 3LiBH₄—LiCl.

It is preferable that the inorganic solid electrolyte in a particulate form in the composition for a non-aqueous secondary battery. In this case, a particle diameter (volume average particle size) of the inorganic solid electrolyte is not particularly limited, and is preferably 0.01 m or more, and more preferably 0.1 m or more. The upper limit thereof is preferably 100 m or less, and more preferably 50 m or less.

The particle diameter of the inorganic solid electrolyte is measured according to the following procedure. Particles of the inorganic solid electrolyte are diluted using water (heptane in a case where the material is unstable in water) in a 20 mL sample bottle to prepare 1% by mass of a dispersion liquid. The diluted dispersion liquid sample is irradiated with 1 kHz ultrasonic waves for 10 minutes, and then immediately used for test. Data collection is performed 50 times with the dispersion liquid sample using a laser diffraction/scattering-type particle size distribution analyzer LA-920 (product name, manufactured by Horiba Ltd.) and a quartz cell for measurement at a temperature of 25° C., thereby obtaining the volume average particle size. For other detailed conditions and the like, Japanese Industrial Standards (JIS) Z 8828: 2013 “Particle Diameter Analysis-Dynamic Light Scattering” is referred to as necessary. Five samples are produced for each level, and the average value thereof is adopted.

A method of adjusting the particle diameter is not particularly limited, and a known method can be applied. Examples thereof include a method using a typical pulverizer or a classifier. As the pulverizer or the classifier, for example, a mortar, a ball mill, a sand mill, a vibration ball mill, a satellite ball mill, a planetary ball mill, a swirling airflow-type jet mill, or a sieve is suitably used. During the pulverization, it is possible to carry out wet-type pulverization in which water or a dispersion medium such as methanol is allowed to be present together. In order to provide the desired particle diameter, classification is preferably performed. The classification is not particularly limited, and can be carried out using a sieve, a wind power classifier, or the like. Both a dry-type classification and a wet-type classification can be used.

The composition for a non-aqueous secondary battery may contain one kind or two or more kinds of the inorganic solid electrolytes.

A content of the inorganic solid electrolyte in the composition for a non-aqueous secondary battery is not particularly limited, but is preferably 50% by mass or more, more preferably 70% by mass or more, and particularly preferably 90% by mass or more in 100% by mass of the solid content from the viewpoint of the dispersion state of the solid particles and the resistance. From the same viewpoint, the upper limit thereof is preferably 99.9% by mass or less, more preferably 99.5% by mass or less, and particularly preferably 99% by mass or less.

However, in a case where the composition for a non-aqueous secondary battery contains an active material described later, regarding the content of the inorganic solid electrolyte in the composition for a non-aqueous secondary battery, the total content of the active material and the inorganic solid electrolyte is preferably within the above-described range.

In the present invention, the solid content (solid component) refers to components which do not disappear by being volatilized or evaporated in a case where the composition for a non-aqueous secondary battery is subjected to drying treatment at 150° C. for 6 hours in a nitrogen atmosphere at a pressure of 1 mmHg. Typically, the solid content refers to a constitutional component other than the dispersion medium described later.

### <Dispersion Medium>

It is sufficient that the dispersion medium contained in the composition for a non-aqueous secondary battery according to the embodiment of the present invention is an organic compound which is in a liquid state in the use environment, examples thereof include various organic solvents, and specific examples thereof include an alcohol compound, an ether compound, an amide compound, an amine compound, a ketone compound, an aromatic hydrocarbon compound, an aliphatic hydrocarbon compound, a nitrile compound, and an ester compound.

The dispersion medium may be a non-polar dispersion medium (a hydrophobic dispersion medium) or a polar dispersion medium (a hydrophilic dispersion medium), and a non-polar dispersion medium is preferable from the viewpoint that excellent dispersibility can be exhibited. The non-polar dispersion medium generally refers to a dispersion medium having a property of low affinity to water, and in the present invention, examples thereof include an ester compound, a ketone compound, an ether compound, an aromatic hydrocarbon compound, and an aliphatic hydrocarbon compound.

Examples of the alcohol compound include methyl alcohol, ethyl alcohol, 1-propyl alcohol, 2-propyl alcohol, 2-butanol, ethylene glycol, propylene glycol, glycerol, 1,6-hexanediol, cyclohexanediol, sorbitol, xylitol, 2-methyl-2,4-pentanediol, 1,3-butanediol, and 1,4-butanediol.

Examples of the ether compound include alkylene glycols (diethylene glycol, triethylene glycol, polyethylene glycol, dipropylene glycol, and the like), alkylene glycol monoalkyl ethers (ethylene glycol monomethyl ether, ethylene glycol monobutyl ether, diethylene glycol monomethyl ether, propylene glycol monomethyl ether, dipropylene glycol monomethyl ether, tripropylene glycol monomethyl ether, diethylene glycol monobutyl ether, and the like), alkylene glycol dialkyl ethers (ethylene glycol dimethyl ether and the like), dialkyl ethers (dimethyl ether, diethyl ether, diisopropyl ether, dibutyl ether, and the like), and cyclic ethers (tetrahydrofuran, dioxane (including 1,2-, 1,3- or 1,4-isomer), and the like).

Examples of the amide compound include N,N-dimethylformamide, N-methyl-2-pyrrolidone, 2-pyrrolidinone, 1,3-dimethyl-2-imidazolidinone, F-caprolactam, formamide, N-methylformamide, acetamide, N-methylacetamide, N,N-dimethylacetamide, N-methylpropanamide, and hexamethylphosphoric triamide.

Examples of the amine compound include triethylamine, diisopropylethylamine, and tributylamine.

Examples of the ketone compound include acetone, methyl ethyl ketone, methyl isobutyl ketone (MIBK), cyclopentanone, cyclohexanone, cycloheptanone, dipropyl ketone, dibutyl ketone, diisopropyl ketone, diisobutyl ketone (DIBK), isobutyl propyl ketone, sec-butyl propyl ketone, pentyl propyl ketone, and butyl propyl ketone.

Examples of the aromatic hydrocarbon compound include benzene, toluene, xylene, and perfluorotoluene.

Examples of the aliphatic hydrocarbon compound include hexane, heptane, octane, nonane, decane, dodecane, cyclohexane, methylcyclohexane, ethylcyclohexane, cycloheptane, cyclooctane, decalin, paraffin, gasoline, naphtha, kerosene, and light oil.

Examples of the nitrile compound include acetonitrile, propionitrile, and isobutyronitrile.

Examples of the ester compound include ethyl acetate, propyl acetate, propyl butyrate, butyl acetate, ethyl butyrate, isopropyl butyrate, butyl butyrate, isobutyl butyrate, butyl pentanoate, pentyl pentanoate, ethyl isobutyrate, propyl isobutyrate, isopropyl isobutyrate, isobutyl isobutyrate, propyl pivalate, isopropyl pivalate, butyl pivalate, and isobutyl pivalate.

In the present invention, among the above, an ether compound, a ketone compound, an aromatic hydrocarbon compound, an aliphatic hydrocarbon compound, or an ester compound is preferable; and an ester compound, a ketone compound, an aromatic hydrocarbon compound, or an ether compound is more preferable.

The number of carbon atoms in the compound constituting the dispersion medium is not particularly limited, and it is preferably 2 to 30, more preferably 4 to 20, still more preferably 6 to 15, and particularly preferably 7 to 12.

The dispersion medium preferably has a boiling point of 50° C. or higher and more preferably 70° C. or higher at normal pressure (1 atm: 101,325 Pa). The upper limit thereof is preferably 250° C. or lower and more preferably 220° C. or lower.

The composition for a non-aqueous secondary battery may contain one kind or two or more kinds of the dispersion media. Examples of two or more kinds of the dispersion media include xylene (a mixture of xylene isomers in which a mixing molar ratio between isomers is ortho-isomer:para-isomer:meta-isomer=1:5:2) and mixed xylene (a mixture of o-xylene, p-xylene, m-xylene, and ethylbenzene).

In the present invention, a content of the dispersion medium in the composition for a non-aqueous secondary battery is not particularly limited and can be appropriately set. For example, in the composition for a non-aqueous secondary battery, it is preferably 20% to 80% by mass, more preferably 30% to 70% by mass, and particularly preferably 40% to 60% by mass. In a case of being set to a high concentration of solid contents, the content of the dispersion medium can be set to 60% by mass or less, and can also be set to 50% by mass or less.

### <Active Material>

It is one of preferred aspects that the composition for a non-aqueous secondary battery according to the embodiment of the present invention contains an active material capable of intercalating and deintercalating ions of a metal belonging to Group 1 or Group 2 in the periodic table. Examples of the active material include a positive electrode active material and a negative electrode active material, which will be described later.

In the present invention, the composition for a non-aqueous secondary battery, containing an active material (a positive electrode active material or a negative electrode active material), may be referred to as an electrode composition (a positive electrode composition or a negative electrode composition).

### (Positive Electrode Active Material)

The positive electrode active material is an active material capable of intercalating and deintercalating an ion of a metal belonging to Group 1 or Group 2 in the periodic table, and an active material capable of reversibly intercalating and deintercalating lithium ions is preferable. The material is not particularly limited as long as the material has the above-described characteristics, and the material may be a transition metal oxide, an organic substance, an element capable of being complexed with Li, such as sulfur, or the like.

Among these, as the positive electrode active material, transition metal oxides are preferably used, and transition metal oxides having a transition metal element M^{a} (one or more elements selected from Co, Ni, Fe, Mn, Cu, and V) are more preferable. In addition, an element M^{b} (an element of Group 1 (Ia) in the periodic table other than lithium, an element of Group 2 (IIa), or an element such as Al, Ga, In, Ge, Sn, Pb, Sb, Bi, Si, P, or B) may be mixed into the transition metal oxide. A mixing amount thereof is preferably 0% to 30% by mole of the amount (100% by mole) of the transition metal element M^{a}. It is more preferable that the transition metal oxide is synthesized by mixing the above-described components such that a molar ratio Li/M^{a} is 0.3 to 2.2.

Specific examples of the transition metal oxide include (MA) transition metal oxides having a bedded salt-type structure, (MB) transition metal oxides having a spinel-type structure, (MC) lithium-containing transition metal phosphoric acid compounds, (MD) lithium-containing transition metal halogenated phosphoric acid compounds, and (ME) lithium-containing transition metal silicate compounds.

Specific examples of the transition metal oxide having a bedded salt-type structure (MA) include LiCoO₂ (lithium cobalt oxide [LCO]), LiNi₂O₂(lithium nickelate), LiNi_{0.85}Co_{0.10}Al_{0.05}O₂(lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂(lithium manganese nickelate).

Specific examples of the transition metal oxide having a spinel-type structure (MB) include LiMn₂O₄(LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compound (MC) include olivine-type iron phosphate salts such as LiFePO₄ and Li₃Fe₂(PO₄)₃; cobalt phosphates such as LiCoPO₄; iron pyrophosphates such as LiFeP₂O₇; and monoclinic NASICON-type vanadium phosphate salts such as Li₃V₂(PO₄)₃(lithium vanadium phosphate).

Examples of the lithium-containing transition metal halogenated phosphoric acid compound (MD) include iron fluorophosphates such as Li₂FePO₄F, manganese fluorophosphates such as Li₂MnPO₄F, and cobalt fluorophosphates such as Li₂CoPO₄F.

Examples of the lithium-containing transition metal silicate compound (ME) include Li₂FeSiO₄, Li₂MnSiO₄, and Li₂CoSiO₄.

In the present invention, the transition metal oxide having a bedded salt-type structure (MA) is preferable, and LCO or NMC is more preferable.

A shape of the positive electrode active material is not particularly limited, but it is preferably a particulate shape in the composition for a non-aqueous secondary battery. In a case where the positive electrode active material has a particulate shape, a particle diameter (a volume average particle size) of the positive electrode active material is not particularly limited. For example, it can be set to 0.1 to 50 m. The particle diameter of the positive electrode active material particle can be measured using the same method as that of the particle diameter of the inorganic solid electrolyte described above. In order to have a predetermined particle diameter, a normal pulverizer or classifier is used as in the inorganic solid electrolyte.

A positive electrode active material obtained using a baking method may be used after being washed with water, an acidic aqueous solution, an alkaline aqueous solution, or an organic solvent.

The composition for a non-aqueous secondary battery may contain one kind or two or more kinds of the positive electrode active materials.

A content of the positive electrode active material in the composition for a non-aqueous secondary battery is not particularly limited, and it is preferably 10% to 97% by mass, more preferably 30% to 95% by mass, still more preferably 40% to 93% by mass, and particularly preferably 50% to 90% by mass in 100% by mass of the solid content.

### (Negative Electrode Active Material)

The negative electrode active material is an active material capable of intercalating and deintercalating an ion of a metal belonging to Group 1 or Group 2 in the periodic table, and an active material capable of reversibly intercalating and deintercalating lithium ions is preferable. The material is not particularly limited as long as the material has the above-described characteristics, and examples thereof include a carbonaceous material, a metal oxide, a metal composite oxide, lithium, a lithium alloy, and a negative electrode active material capable of forming an alloy (capable of being alloyed) with lithium. Among these, a carbonaceous material, a metal composite oxide, or a lithium single body is preferably used from the viewpoint of reliability. An active material which is capable of being alloyed with lithium is preferable because a capacity of the all-solid-state secondary battery can be increased.

The carbonaceous material used as the negative electrode active material is a material substantially consisting of carbon. Examples thereof include petroleum pitch, carbon black such as acetylene black (AB), graphite (natural graphite and artificial graphite such as vapor-grown graphite), and carbonaceous material obtained by calcining a variety of synthetic resins such as a polyacrylonitrile (PAN)-based resin and a furfuryl alcohol resin. Furthermore, examples thereof also include various carbon fibers such as PAN-based carbon fiber, cellulose-based carbon fiber, pitch-based carbon fiber, vapor-grown carbon fiber, dehydrated polyvinyl alcohol (PVA)-based carbon fiber, lignin carbon fiber, vitreous carbon fiber, and activated carbon fiber; mesophase microspheres, graphite whisker, and tabular graphite.

These carbonaceous materials can be classified into non-graphitizable carbonaceous materials (also referred to as “hard carbon”) and graphitizable carbonaceous materials, based on the graphitization degree. In addition, it is preferable that the carbonaceous material has the surface spacing, density, and crystallite size described in JP1987-22066A (JP-S62-22066A), JP1990-6856A (JP-H2-6856A), and JP1991-45473A (JP-H3-45473A). The carbonaceous material is not necessarily a single material, and may be a mixture of natural graphite and artificial graphite described in JP1993-90844A (JP-H5-90844A) or graphite having a coating layer described in JP1994-4516A (JP-H6-4516A).

As the carbonaceous material, hard carbon or graphite is preferably used, and graphite is more preferably used.

The oxide of a metal or a metalloid element, which is applied as the negative electrode active material, is not particularly limited as long as it is an oxide capable of intercalating and deintercalating lithium; and examples thereof include an oxide of a metal element (metal oxide), a composite oxide of a metal element or a composite oxide of a metal element and a metalloid element (collectively referred to as a metal composite oxide), and an oxide of a metalloid element (a metalloid oxide). The oxide is preferably an amorphous oxide, and preferred examples thereof include chalcogenides which are reaction products between metal elements and elements of Group 16 in the periodic table. In the present invention, the metalloid element refers to an element having intermediate properties between those of a metal element and a non-metal element, and typically, the metalloid element includes six elements including boron, silicon, germanium, arsenic, antimony, and tellurium, and further includes three elements including selenium, polonium, and astatine. In addition, the “noncrystalline” means an oxide having a broad scattering band with an apex in a range of 20° to 400 in terms of the 20 value in case of being measured by an X-ray diffraction method using a CuKα ray, and the oxide may have a crystalline diffraction line. The highest intensity in a crystalline diffraction line observed in a range of 400 to 700 in terms of the 20 value is preferably 100 times or less and more preferably 5 times or less with respect to the intensity of a diffraction line at the apex in a broad scattering band observed in a range of 200 to 400 in terms of the 20 value, and it is particularly preferable that the oxide does not have a crystalline diffraction line.

In the compound group consisting of the noncrystalline oxides and the chalcogenides described above, the noncrystalline oxide of a metalloid element or the above-described chalcogenide is more preferable; and a (composite) oxide consisting of one element or a combination of two or more elements selected from elements (for example, Al, Ga, Si, Sn, Ge, Pb, Sb, and Bi) of Group 13 (IIIB) to Group 15 (VB) in the periodic table or the chalcogenide is particularly preferable. Specific examples of the preferred noncrystalline oxide and chalcogenide preferably include Ga₂O₃, GeO, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, GeS, PbS, PbS₂, Sb₂S₃, and Sb₂S₅.

Suitable examples of a negative electrode active material which can be used in combination with the noncrystalline oxide mainly using Sn, Si, or Ge include a carbonaceous material capable of intercalating and deintercalating lithium ions or lithium metal, a lithium single substance, a lithium alloy, and a negative electrode active material capable of forming an alloy with lithium.

It is preferable that an oxide of a metal or a metalloid element, in particular, a metal (composite) oxide and the above-described chalcogenide contain at least one of titanium or lithium as the constitutional component from the viewpoint of high current density charging and discharging characteristics. Examples of the metal composite oxide (lithium composite metal oxide) including lithium include a composite oxide of lithium oxide and the above metal (composite) oxide or the above chalcogenide, and specifically, Li₂SnO₂.

As the negative electrode active material, for example, a metal oxide (titanium oxide) having a titanium element is also preferable. Specifically, Li₄Ti₅O₁₂ (lithium titanium oxide [LTO]) is preferable from the viewpoint that the volume variation during the intercalation and deintercalation of lithium ions is small, and thus high-speed charging and discharging characteristics are excellent, and deterioration of electrodes is suppressed, whereby it is possible to improve life of the lithium ion secondary battery.

The lithium alloy as the negative electrode active material is not particularly limited as long as it is typically used as a negative electrode active material for a secondary battery; and examples thereof include a lithium aluminum alloy, specifically, a lithium aluminum alloy using lithium as a base metal, to which 10% by mass of aluminum is added.

The negative electrode active material capable of forming an alloy with lithium is not particularly limited as long as it is typically used as a negative electrode active material for a secondary battery. Examples of such an active material include a (negative electrode) active material (an alloy or the like) having a silicon element or a tin element, and a metal such as Al or In; and a negative electrode active material (a silicon element-containing active material) having a silicon element capable of exhibiting high battery capacity is preferable, and a silicon element-containing active material in which a content of the silicon element is 50% by mole or more with respect to all constitutional elements is more preferable.

Generally, a negative electrode containing these negative electrode active materials (for example, an Si negative electrode containing a silicon element-containing active material, an Sn negative electrode containing a tin element-containing active material, and the like) can absorb a larger amount of Li ions than carbon negative electrodes (such as graphite and acetylene black). That is, the amount of Li ions absorbed per unit mass increases. Therefore, the battery capacity (energy density) can be increased. As a result, there is an advantage in that the battery driving duration can be extended.

Examples of the silicon element-containing active material include a silicon-containing alloy (for example, LaSi₂, VSi₂, La—Si, Gd—Si, or Ni—Si) including a silicon material such as Si or SiOₓ (0<x≤1) and titanium, vanadium, chromium, manganese, nickel, copper, lanthanum, or the like or a structured active material thereof (for example, LaSi₂/Si), and an active material containing a silicon element and a tin element, such as SnSiO₃ or SnSiS₃. Since SiOₓ itself can be used as the negative electrode active material (the metalloid oxide) and Si is produced along with the operation of the all-solid-state secondary battery, SiOₓ can be used as a negative electrode active material (or a precursor material thereof) capable of forming an alloy with lithium.

Examples of the negative electrode active material containing a tin element include Sn, SnO, SnO₂, SnS, SnS₂, and the above-described active material containing a silicon element and a tin element. In addition, a composite oxide with lithium oxide, for example, Li₂SnO₂ can also be used.

In the present invention, the above-described negative electrode active material can be used without being particularly limited. However, from the viewpoint of battery capacity, a preferred aspect as the negative electrode active material is a negative electrode active material capable of being alloyed with lithium, and among these, the silicon material or the silicon-containing alloy (the alloy containing a silicon element) described above is more preferable, and it is still more preferable to contain a negative electrode active material containing silicon (Si) or a silicon-containing alloy.

A chemical formula of a compound obtained by the above-described baking method can be calculated using an inductively coupled plasma (ICP) emission spectroscopy as a measuring method from the mass difference of powder before and after baking as a convenient method.

A shape of the negative electrode active material is not particularly limited, but it is preferably a particulate shape in the composition for a non-aqueous secondary battery. In a case where the negative electrode active material has a particulate shape, a particle diameter of the negative electrode active material is not particularly limited, but it is preferably 0.1 to 60 km. The particle diameter of the negative electrode active material particle can be measured using the same method as that of the particle diameter of the inorganic solid electrolyte described above. In order to have a predetermined particle diameter, a normal pulverizer or classifier is used as in the inorganic solid electrolyte.

The composition for a non-aqueous secondary battery may contain one kind or two or more kinds of the negative electrode active materials.

A content of the negative electrode active material in the composition for a non-aqueous secondary battery is not particularly limited, and it is preferably 10% to 90% by mass, more preferably 20% to 85% by mass, still more preferably 30% to 80% by mass, and even more preferably 40% to 75% by mass in 100% by mass of the solid content.

In the present invention, in a case where a negative electrode active material layer is formed by charging a secondary battery, ions of a metal belonging to Group 1 or Group 2 in the periodic table, generated in the all-solid-state secondary battery, can be used instead of the above-described negative electrode active material. By bonding the ions to electrons and precipitating a metal, the negative electrode active material layer can be formed.

### (Coating of Active Material)

Surfaces of the positive electrode active material and the negative electrode active material may be subjected to surface coating with another metal oxide. Examples of a surface coating agent include metal oxides containing Ti, Nb, Ta, W, Zr, Al, Si, or Li. Examples thereof include titanium oxide spinel, tantalum-based oxides, niobium-based oxides, and lithium niobate-based compounds; and specific examples thereof include Li₄Ti₅O₁₂, Li₂Ti₂O₈, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

In addition, the surface of the electrode containing the positive electrode active material or the negative electrode active material may be subjected to a surface treatment with sulfur or phosphorus.

Furthermore, the particle surface of the positive electrode active material or the negative electrode active material may be subjected to a surface treatment with an actinic ray or an active gas (plasma or the like) before and after the surface coating.

### <Conductive Auxiliary Agent>

It is also one of preferred aspects that the composition for a non-aqueous secondary battery according to the embodiment of the present invention contains a conductive auxiliary agent, and it is preferable to use the active material and the conductive auxiliary agent in combination; for example, it is preferable to use a silicon atom-containing active material as the negative electrode active material and the conductive auxiliary agent in combination.

The conductive auxiliary agent is not particularly limited, a conductive auxiliary agent which is known as a general conductive auxiliary agent can be used. For example, the conductive auxiliary agent may be graphite such as natural graphite and artificial graphite; carbon black such as acetylene black, ketjen black, and furnace black; irregular carbon such as needle cokes; a carbon fiber such as vapor-grown carbon fiber and carbon nanotube; a carbonaceous material such as graphene and fullerene which are electron-conductive materials; metal powder or a metal fiber of copper, nickel, or the like; and a conductive polymer such as polyaniline, polypyrrole, polythiophene, polyacetylene, and a polyphenylene derivative.

In the present invention, in a case where the active material is used in combination with the conductive auxiliary agent, among the above-described conductive auxiliary agents, a conductive auxiliary agent which does not intercalate and deintercalate ions (preferably Li ions) of a metal belonging to Group 1 or Group 2 in the periodic table and does not function as an active material at the time of charging and discharging of the battery is classified as the conductive auxiliary agent. Therefore, among the conductive auxiliary agents, a conductive auxiliary agent which can function as the active material in the active material layer at the time of charging and discharging of the battery is classified as the active material, not as the conductive auxiliary agent. Whether or not the conductive auxiliary agent functions as the active material at the time of charging and discharging of the battery is not unambiguously determined, and determined by a combination with the active material.

The conductive auxiliary agent preferably has a particulate shape in the composition for a non-aqueous secondary battery. In a case where the conductive auxiliary agent is in a particulate form, a particle diameter (volume average particle size) of the conductive auxiliary agent is not particularly limited, but is, for example, preferably 0.02 to 1.0 m. The particle diameter of the conductive auxiliary agent can be measured using the same method as that of the particle diameter of the inorganic solid electrolyte.

The composition for a non-aqueous secondary battery may contain one kind or two kinds of the conductive auxiliary agents.

In a case where the composition for a non-aqueous secondary battery according to the embodiment of the present invention contains a conductive auxiliary agent, a content of the conductive auxiliary agent in the composition for a non-aqueous secondary battery is preferably 0% to 10% by mass in 100% by mass of the solid content.

### <Lithium Salt>

It is also preferable that the composition for a non-aqueous secondary battery according to the embodiment of the present invention contains a lithium salt (supporting electrolyte). Generally, the lithium salt is preferably a lithium salt which is used for this kind of product and is not particularly limited. For example, lithium salts described in paragraphs 0082 to 0085 of JP2015-088486A are preferable. In a case where the composition for a non-aqueous secondary battery according to the embodiment of the present invention contains a lithium salt, a content of the lithium salt is preferably 0.1 part by mass or more and more preferably 5 parts by mass or more with respect to 100 parts by mass of the inorganic solid electrolyte. The upper limit thereof is preferably 50 parts by mass or less, and more preferably 20 parts by mass or less.

<Dispersant Other than Polymer According to Embodiment of Present Invention>

The composition for a non-aqueous secondary battery according to the embodiment of the present invention may not contain a dispersant other than the polymer according to the embodiment of the present invention because the polymer according to the embodiment of the present invention functions as a dispersant, but may contain a dispersant other than the polymer according to the embodiment of the present invention (referred to as other dispersants) to reinforce the dispersion function of the polymer according to the embodiment of the present invention. As the other dispersants, a binder usually used in the non-aqueous secondary battery can be appropriately selected and used. In general, a compound intended for particle adsorption and steric repulsion and/or electrostatic repulsion is suitably used.

The composition for a non-aqueous secondary battery according to the embodiment of the present invention may contain one kind or two or more kinds of the other dispersants.

In a case where the composition for a non-aqueous secondary battery according to the embodiment of the present invention contains other dispersants, a content of the other dispersants is appropriately determined, and can be, for example, 3% by mass or less in 100% by mass of the solid content of the composition for a non-aqueous secondary battery.

### <Binder>

The composition for a non-aqueous secondary battery according to the embodiment of the present invention may not contain a binder other than the polymer according to the embodiment of the present invention because the polymer according to the embodiment of the present invention functions as a binder in the constituent layer, but may contain a binder other than the polymer according to the embodiment of the present invention to reinforce the function of the polymer according to the embodiment of the present invention. As such a binder, a binder usually used in the non-aqueous secondary battery can be appropriately selected and used.

The composition for a non-aqueous secondary battery according to the embodiment of the present invention may contain one or two or more kinds of binders other than the polymer according to the embodiment of the present invention.

In a case where the composition for a non-aqueous secondary battery according to the embodiment of the present invention contains a binder other than the polymer according to the embodiment of the present invention, a content of the binder can be appropriately determined. The content (in terms of solid contents) of the binder in the composition for a non-aqueous secondary battery is not particularly limited, but is preferably 0.1% to 4.0% by mass, more preferably 0.2% to 2.0% by mass, and still more preferably 0.5% to 1.5% by mass, from the viewpoint of bonding property of the solid particles. For the same reason, the content (in terms of solid contents) of the binder in 100% by mass of the solid content of the composition for a non-aqueous secondary battery is preferably 0.1% to 5.0% by mass, more preferably 0.3% to 3.0% by mass, and still more preferably 0.5% to 1.5% by mass.

In 100% by mass of the solid content, a mass ratio [(Mass of inorganic solid electrolyte+Mass of active material)/(Total mass of binder other than polymer according to embodiment of present invention)] of the total mass (total amount) of the inorganic solid electrolyte and the active material to the mass of the binder other than the polymer according to the embodiment of the present invention is preferably in a range of 1,000 to 1. The ratio is more preferably 500 to 2 and still more preferably 100 to 10.

### <Other Additives>

As components other than the respective components described above, the composition for a non-aqueous secondary battery according to the embodiment of the present invention may appropriately contain an ionic liquid, a thickener, a crosslinking agent (agent causing a crosslinking reaction by radical polymerization, condensation polymerization, or ring-opening polymerization), a polymerization initiator (agent which generates an acid or a radical by heat or light), a defoamer, a leveling agent, a dehydrating agent, or an antioxidant. The ionic liquid is contained in order to further improve the ion conductivity, and the known ionic liquid can be used without being particularly limited.

### (Preparation of Composition for Non-Aqueous Secondary Battery)

The composition for a non-aqueous secondary battery according to the embodiment of the present invention can be prepared as a mixture, preferably as a slurry, by mixing the polymer according to the embodiment of the present invention and each of the above-described components according to the application using, for example, various mixers usually used. In a case of an electrode composition, an active material is further mixed.

The mixing method is not particularly limited, and it can be carried out using a known mixer such as a ball mill, a beads mill, a planetary mixer, a blade mixer, a roll mill, a kneader, a disc mill, a self-rotation type mixer, or a narrow gap type disperser. Each component may be mixed collectively or may be mixed sequentially. The environment in which the mixing is carried out is not particularly limited, and examples thereof include a dry air atmosphere (dew point of −20° C. or lower) or an inert gas atmosphere (for example, an argon gas atmosphere, a helium gas atmosphere, or a nitrogen gas atmosphere). In addition, the mixing conditions are not particularly limited and are appropriately set, and for example, the mixing temperature can be set to 15° C. to 40° C. In addition, a rotation speed of the self-rotation type mixer or the like can be set to 200 to 3,000 rpm.

A mixing time is not particularly limited, and can be appropriately determined according to the dispersibility of the solid particles; and for example, the mixing time can be set to 1 to 180 minutes. Since the polymer according to the embodiment of the present invention can disperse the solid particles in the dispersion medium into a desired dispersion state in a short time, the mixing time (dispersion time) can be set to be short, and for example, can be set to 30 minutes or shorter and is preferably set to 5 to 25 minutes. Here, the mixing time shortened by the polymer according to the embodiment of the present invention refers to a mixing time in a case of mixing the solid particles, the polymer according to the embodiment of the present invention, and the dispersion medium; but in a case where the mixing of the components is performed in a plurality of stages, the mixing time in each stage can be shortened. By setting the mixing time to be short in this way, the dispersion energy and the load applied to the solid particles during the dispersion can be reduced to suppress the damage to the solid particles, and thus a constituent layer with low resistance and a non-aqueous secondary battery with excellent cycle characteristics and low resistance can be realized.

Since the composition for a non-aqueous secondary battery according to the embodiment of the present invention has excellent dispersion characteristics of the solid particles, it can be stored after the preparation and does not have to be prepared each time when it is used.

### [Sheet for Non-Aqueous Secondary Battery]

A sheet for a non-aqueous secondary battery can be produced by using the composition for a non-aqueous secondary battery according to the embodiment of the present invention. The sheet for a non-aqueous secondary battery according to the embodiment of the present invention is a sheet-shaped molded body with which a constituent layer of a non-aqueous secondary battery can be formed, and it includes various aspects depending on use applications thereof. The constituent layer formed of the composition for a non-aqueous secondary battery has a constituent layer with low resistance, and further preferably has a constituent layer with a flat surface.

Hereinafter, a sheet for an all-solid-state secondary battery, which is one suitable form of the sheet for a non-aqueous secondary battery, will be described, but the following content regarding the sheet for an all-solid-state secondary battery can be applied to the sheet for a non-aqueous secondary battery.

<Sheet for all-Solid-State Secondary Battery>

The sheet for an all-solid-state secondary battery according to the embodiment of the present invention is a sheet-shaped molded body with which a constituent layer of an all-solid-state secondary battery can be formed, and it includes various aspects depending on use applications thereof. Examples of thereof include a sheet which is preferably used in a solid electrolyte layer (also referred to as a solid electrolyte sheet for an all-solid-state secondary battery) and a sheet which is preferably used in an electrode or a laminate of an electrode and a solid electrolyte layer (an electrode sheet for an all-solid-state secondary battery). In the present invention, the variety of sheets described above will be collectively referred to as a sheet for an all-solid-state secondary battery.

In the present invention, each layer constituting the sheet for an all-solid-state secondary battery may have a monolayer structure or a multilayer structure.

In the sheet for an all-solid-state secondary battery, the solid electrolyte layer or the active material layer on a substrate is formed of the composition for a non-aqueous secondary battery according to the embodiment of the present invention. Therefore, the layer formed of the composition for a non-aqueous secondary battery according to the embodiment of the present invention is formed of components (excluding the dispersion medium) derived from the composition for a non-aqueous secondary battery, and is usually in close contact (bonded) in a state in which solid particles (the inorganic solid electrolyte, the conductive auxiliary agent, and the active material) and the polymer according to the embodiment of the present invention are mixed.

The sheet for an all-solid-state secondary battery can achieve a reduction in resistance (improvement in conductivity) and excellent cycle characteristics of the all-solid-state secondary battery by appropriately peeling off the substrate or directly incorporating the sheet into the all-solid-state secondary battery.

It is sufficient that the solid electrolyte sheet for an all-solid-state secondary battery according to the embodiment of the present invention is a sheet including the solid electrolyte layer, and it may be a sheet in which a solid electrolyte layer is formed on a substrate or may be a sheet (sheet from which the substrate has been peeled off) which is formed of the solid electrolyte layer without including a substrate. The solid electrolyte sheet for an all-solid-state secondary battery may include other layers in addition to the solid electrolyte layer. Examples of the other layers include a protective layer (peeling sheet), a collector, and a coating layer. The solid electrolyte layer included in the solid electrolyte sheet for an all-solid-state secondary battery is preferably formed of the composition for a non-aqueous secondary battery (inorganic solid electrolyte-containing composition) according to the embodiment of the present invention. A content of each component in the solid electrolyte layer is not particularly limited, but it preferably has the same meaning as the content of each component in the solid content of the composition for a non-aqueous secondary battery according to the embodiment of the present invention. A layer thickness of each layer constituting the solid electrolyte sheet for an all-solid-state secondary battery is the same as a layer thickness of each layer in the all-solid-state secondary battery, which will be described later.

Examples of the solid electrolyte sheet for an all-solid-state secondary battery according to the embodiment of the present invention include a sheet including a layer formed of the composition for a non-aqueous secondary battery according to the embodiment of the present invention, a typical solid electrolyte layer, and a protective layer on a substrate in this order.

The substrate is not particularly limited as long as it can support the solid electrolyte layer, and examples thereof include a sheet body (plate-shaped body) formed of materials described later regarding a collector, an organic material, an inorganic material, or the like. Examples of the organic material include various polymers, and specific examples thereof include polyethylene terephthalate, polypropylene, polyethylene, and cellulose. Examples of the inorganic material include glass and ceramic.

It is sufficient that the electrode sheet for an all-solid-state secondary battery according to the embodiment of the present invention (simply also referred to as “electrode sheet”) is an electrode sheet including the active material layer, and it may be a sheet in which the active material layer is formed on a substrate (collector) or may be a sheet (sheet from which the substrate has been peeled off) which is formed of the active material layer without including a substrate. The electrode sheet is typically a sheet including the collector and the active material layer, and examples of an aspect thereof include an aspect including the collector, the active material layer, and the solid electrolyte layer in this order and an aspect including the collector, the active material layer, the solid electrolyte layer, and the active material layer in this order. It is preferable that the solid electrolyte layer and the active material layer, which are included in the electrode sheet, are formed of the composition for a non-aqueous secondary battery according to the embodiment of the present invention (the inorganic solid electrolyte-containing composition or the electrode composition). A content of each component in the solid electrolyte layer or the active material layer is not particularly limited, but it preferably has the same meaning as the content of each component in the solid content of the composition for a non-aqueous secondary battery according to the embodiment of the present invention. A layer thickness of each layer constituting the electrode sheet according to the embodiment of the present invention is the same as the layer thickness of each layer in the all-solid-state secondary battery, which will be described later. The electrode sheet may include the above-described other layers.

In a case where the solid electrolyte layer or the active material layer is not formed of the composition for a non-aqueous secondary battery according to the embodiment of the present invention, it is formed of a general constituent layer-forming material.

In the sheet for an all-solid-state secondary battery according to the embodiment of the present invention, at least one layer of the solid electrolyte layer or the active material layer is formed of the composition for a non-aqueous secondary battery according to the embodiment of the present invention. Therefore, the sheet for an all-solid-state secondary battery according to the embodiment of the present invention has a constituent layer with a flat surface and low resistance in which solid particles including the inorganic solid electrolyte are bonded. By using the constituent layer as a constituent layer of the all-solid-state secondary battery, low resistance (high conductivity) and excellent cycle characteristics of the all-solid-state secondary battery can be realized.

[Manufacturing Method of Sheet for all-Solid-State Secondary Battery]

A manufacturing method of the sheet for an all-solid-state secondary battery according to the embodiment of the present invention is not particularly limited, and the sheet can be manufactured by forming each of the above-described layers using the composition for a non-aqueous secondary battery according to the embodiment of the present invention. Examples thereof include a method in which film formation (coating and drying) is carried out preferably on a substrate or a collector (another layer may be interposed) to form a layer (coated and dried layer) consisting of the composition for a non-aqueous secondary battery. As a result, it is possible to produce a sheet for an all-solid-state secondary battery, having the substrate or the collector and having the coated and dried layer. In particular, in a case where a film of the composition for a non-aqueous secondary battery according to the embodiment of the present invention is formed on a collector to produce a sheet for an all-solid-state secondary battery, it is possible to reinforce adhesion between the collector and the active material layer. Here, the coated and dried layer refers to a layer formed by carrying out coating with the composition for a non-aqueous secondary battery according to the embodiment of the present invention and drying the dispersion medium (that is, a layer formed of the composition for a non-aqueous secondary battery according to the embodiment of the present invention and consisting of a composition obtained by removing the dispersion medium from the composition for a non-aqueous secondary battery according to the embodiment of the present invention). In the active material layer and the coated and dried layer, the dispersion medium may remain within a range in which the effect of the present invention is not impaired, and a residual amount thereof in each of the layers may be, for example, 3% by mass or less.

In the manufacturing method of the sheet for an all-solid-state secondary battery according to the embodiment of the present invention, each of the steps such as coating and drying will be described in the manufacturing method of the all-solid-state secondary battery.

In the manufacturing method of the sheet for an all-solid-state secondary battery according to the embodiment of the present invention, the coated and dried layer obtained as described above can be pressurized. The pressurizing condition and the like will be described later in the section of the manufacturing method of the all-solid-state secondary battery.

In addition, in the manufacturing method of the sheet for an all-solid-state secondary battery according to the embodiment of the present invention, the substrate, the protective layer (particularly the peeling sheet), or the like can also be peeled off.

### [Non-Aqueous Secondary Battery]

The non-aqueous secondary battery according to the embodiment of the present invention includes a positive electrode active material layer, a negative electrode active material layer facing the positive electrode active material layer, and an electrolyte layer disposed between the positive electrode active material layer and the negative electrode active material layer. The non-aqueous secondary battery according to the embodiment of the present invention is not particularly limited in the configuration as long as it includes the electrolyte layer between the positive electrode active material layer and the negative electrode active material layer, and for example, a known configuration which relates to the non-aqueous secondary battery can be employed.

<all-Solid-State Secondary Battery>

Hereinafter, the all-solid-state secondary battery which is a preferred form of the non-aqueous secondary battery will be described.

The all-solid-state secondary battery according to the embodiment of the present invention includes a positive electrode active material layer, a negative electrode active material layer facing the positive electrode active material layer, and a solid electrolyte layer disposed between the positive electrode active material layer and the negative electrode active material layer. The all-solid-state secondary battery according to the embodiment of the present invention is not particularly limited in the configuration as long as it includes the solid electrolyte layer between the positive electrode active material layer and the negative electrode active material layer, and for example, a known configuration which relates to the all-solid-state secondary battery can be employed. The positive electrode active material layer is preferably formed on a positive electrode collector to constitute a positive electrode. The negative electrode active material layer is preferably formed on a negative electrode collector to constitute a negative electrode. In the present invention, each constituent layer (including the collector layer and the like) constituting the all-solid-state secondary battery may have a monolayer structure or a multilayer structure.

It is preferable that at least one layer of the negative electrode active material layer, the positive electrode active material layer, or the solid electrolyte layer is formed of the composition for a non-aqueous secondary battery according to the embodiment of the present invention. In addition, it is also one of preferred aspects that at least one of the negative electrode active material layer or the positive electrode active material layer is formed of the composition for a non-aqueous secondary battery according to the embodiment of the present invention. In the present invention, an aspect in which all of the layers are formed of the composition for a non-aqueous secondary battery according to the embodiment of the present invention is also one of preferred aspects. In the present invention, forming the constituent layer of the all-solid-state secondary battery using the composition for a non-aqueous secondary battery according to the embodiment of the present invention includes an aspect in which the constituent layer is formed using the sheet for an all-solid-state secondary battery according to the embodiment of the present invention (however, in a case where a layer other than the layer formed of the composition for a non-aqueous secondary battery according to the embodiment of the present invention is provided, a sheet from which the layer is removed). The all-solid-state secondary battery according to the embodiment of the present invention, in which at least one layer of the constituent layers is formed of the composition for a non-aqueous secondary battery according to the embodiment of the present invention, exhibits excellent cycle characteristics with low resistance (high conductivity). In addition, since the all-solid-state secondary battery according to the embodiment of the present invention exhibits low resistance and high ion conductivity, a large current can be taken out.

In a case where the active material layer or the solid electrolyte layer is not formed of the composition for a non-aqueous secondary battery according to the embodiment of the present invention, a known material in the related art can be used.

In the present invention, each constituent layer (including the collector layer and the like) constituting the all-solid-state secondary battery may have a monolayer structure or a multilayer structure.

### <Positive Electrode Active Material Layer, Solid Electrolyte Layer, and Negative Electrode Active Material Layer>

In the active material layer or the solid electrolyte layer formed of the composition for a non-aqueous secondary battery according to the embodiment of the present invention, the kinds of components to be contained and the contents thereof are preferably the same as those for the composition for a non-aqueous secondary battery according to the embodiment of the present invention with respect to the solid content.

A thickness of each of the negative electrode active material layer, the solid electrolyte layer, and the positive electrode active material layer is not particularly limited. The thickness of each of the layers is preferably 10 to 1,000 m, and in a case of taking a dimension of a general all-solid-state secondary battery into account, it is more preferably 20 m or more and less than 500 m. In the all-solid-state secondary battery according to the embodiment of the present invention, the thickness of at least one layer of the positive electrode active material layer or the negative electrode active material layer is still more preferably 50 m or more and less than 500 m.

### <Collector>

Each of the positive electrode active material layer and the negative electrode active material layer may include a collector on a side opposite to the solid electrolyte layer. The positive electrode collector and the negative electrode collector are preferably an electron conductor.

In the present invention, any one of the positive electrode collector or the negative electrode collector, or collectively both of them may be simply referred to as a collector.

As a material which forms the positive electrode collector, aluminum, an aluminum alloy, stainless steel, nickel, titanium, or a material (material on which a thin film has been formed) obtained by treating the surface of aluminum or stainless steel with carbon, nickel, titanium, or silver is preferable, and among these, aluminum or an aluminum alloy is more preferable.

As a material which forms the negative electrode collector, aluminum, copper, a copper alloy, stainless steel, nickel, titanium, or a material obtained by treating the surface of aluminum, copper, a copper alloy, or stainless steel with carbon, nickel, titanium, or silver is preferable, and aluminum, copper, a copper alloy, or stainless steel is more preferable.

Regarding a shape of the collector, a film sheet shape is typically used, but it is also possible to use a collector having a shape a net shape or a punched shape, or a collector of a lath body, a porous body, a foaming body, a molded body of a fiber group, or the like.

A thickness of the collector is not particularly limited, but it is preferably 1 to 500 m. In addition, protrusions and recesses are preferably provided on a surface of the collector by performing a surface treatment.

### <Other Configurations>

In the present invention, a functional layer, a functional member, or the like may be appropriately interposed or disposed between or on the outside of the respective layers of the negative electrode collector, the negative electrode active material layer, the solid electrolyte layer, the positive electrode active material layer, and the positive electrode collector.

### <Housing>

Depending on the use application, the all-solid-state secondary battery according to the embodiment of the present invention may be used as the all-solid-state secondary battery having the above-described structure as it is, but is preferably sealed in an appropriate housing to be used in the form of a dry cell. The housing may be a metallic housing or a resin (plastic) housing. In a case where a metallic housing is used, examples thereof include an aluminum alloy housing and a stainless steel housing. It is preferable that the metallic housing is classified into a positive electrode-side housing and a negative electrode-side housing and that the positive electrode-side housing and the negative electrode-side housing are electrically connected to the positive electrode collector and the negative electrode collector, respectively. The positive electrode-side housing and the negative electrode-side housing are preferably integrated by being joined together through a gasket for short circuit prevention.

<Preferred Embodiment of all-Solid-State Secondary Battery>

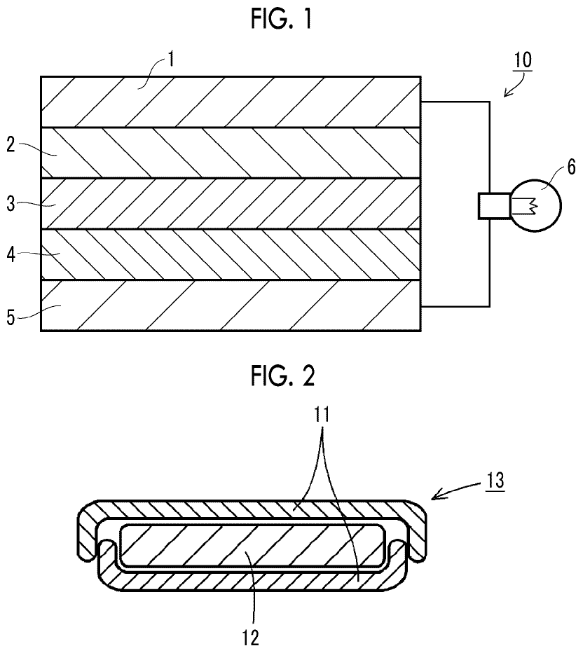

Hereinafter, the all-solid-state secondary battery according to the preferred embodiment of the present invention will be described with reference to FIG. 1, but the present invention is not limited thereto.

FIG. 1 is a cross-sectional view schematically showing the all-solid-state secondary battery (lithium ion secondary battery) according to the preferred embodiment of the present invention. In a case of being viewed from the negative electrode side, an all-solid-state secondary battery 10 according to the present embodiment includes a negative electrode collector 1, a negative electrode active material layer 2, a solid electrolyte layer 3, a positive electrode active material layer 4, and a positive electrode collector 5 in this order. The respective layers are in contact with each other to form an adjacent structure. By adopting such a structure, during charging, electrons (e⁻) are supplied to the negative electrode side, and lithium ions (Li⁺) are accumulated in the negative electrode. On the other hand, during discharging, lithium ions (Li⁺) accumulated in the negative electrode are returned to the positive electrode side, and electrons are supplied to an operation portion 6. In the illustrated example, an electric bulb is employed as a model of the operation portion 6, and is lit by the discharging.

In a case where the all-solid-state secondary battery having the layer configuration shown in FIG. 1 is put into a 2032-type coin case 11 (for example, see FIG. 2), the all-solid-state secondary battery will be referred to as a laminate 12 for an all-solid-state secondary battery, and a battery produced by putting the laminate 12 for an all-solid-state secondary battery into a 2032-type coin case 11 will be referred to as a (coin-type) all-solid-state secondary battery 13, thereby referring to both batteries distinctively in some cases.

### (Positive Electrode Active Material Layer, Solid Electrolyte Layer, and Negative Electrode Active Material Layer)

In the all-solid-state secondary battery 10, all of the positive electrode active material layer 4, the solid electrolyte layer 3, and the negative electrode active material layer 2 are formed of the composition for a non-aqueous secondary battery according to the embodiment of the present invention. The kinds of the inorganic solid electrolyte and the polymer according to the embodiment of the present invention, which are contained in the positive electrode active material layer 4, the solid electrolyte layer 3, and the negative electrode active material layer 2, may be the same or different from each other. In addition, the kinds of the conductive auxiliary agents contained in the positive electrode active material layer 4 and the negative electrode active material layer 2 may be the same or different from each other.

In the present invention, any one of the positive electrode active material layer or the negative electrode active material layer, or collectively both of them may be simply referred to as an active material layer or an electrode active material layer. In addition, in the present invention, any one of the positive electrode active material or the negative electrode active material, or collectively both of them may be simply referred to as an active material or an electrode active material.

The solid electrolyte layer contains an inorganic solid electrolyte having conductivity of an ion of a metal belonging to Group 1 or Group 2 in the periodic table, the polymer according to the embodiment of the present invention, any component described above, and the like within a range not impairing the effect of the present invention, and it generally does not contain a positive electrode active material and/or a negative electrode active material.

The positive electrode active material layer contains an inorganic solid electrolyte having conductivity of an ion of a metal belonging to Group 1 or Group 2 in the periodic table, a positive electrode active material, the polymer according to the embodiment of the present invention, any component described above, and the like within a range not impairing the effect of the present invention.

The negative electrode active material layer contains an inorganic solid electrolyte having conductivity of an ion of a metal belonging to Group 1 or Group 2 in the periodic table, a negative electrode active material, the polymer according to the embodiment of the present invention, any component described above, and the like within a range not impairing the effect of the present invention.

In the all-solid-state secondary battery 10, the negative electrode active material layer may be a lithium metal layer. Examples of the lithium metal layer include a layer formed by depositing or molding a lithium metal powder, a lithium foil, and a lithium vapor-deposited film. A thickness of the lithium metal layer can be, for example, 1 to 500 m regardless of the thickness of the negative electrode active material layer described above.

In the present invention, in a case where the constituent layer is formed of the composition for a non-aqueous secondary battery according to the embodiment of the present invention, an all-solid-state secondary battery exhibiting excellent cycle characteristics with low resistance can be realized.

### (Collector)

The positive electrode collector 5 and the negative electrode collector 1 are as described above.

In a case where the all-solid-state secondary battery 10 has a constituent layer other than the constituent layer formed of the composition for a non-aqueous secondary battery according to the embodiment of the present invention, a layer formed of a known constituent layer-forming material can also be applied.

In addition, each layer may be composed of a single layer or may be composed of multiple layers.

### [Manufacturing of Non-Aqueous Secondary Battery]

The non-aqueous secondary battery can be manufactured according to a conventional method using the composition for a non-aqueous secondary battery according to the embodiment of the present invention.

For example, the all-solid-state secondary battery can be manufactured by forming each of the above-described layers using the composition for a non-aqueous secondary battery according to the embodiment of the present invention, or the like. Specifically, the all-solid-state secondary battery according to the embodiment of the present invention can be manufactured by performing a method (manufacturing method of the sheet for a non-aqueous secondary battery according to the embodiment of the present invention) which includes (is carried out through) a step of coating an appropriate substrate (for example, a metal foil which serves as a collector) with the composition for a non-aqueous secondary battery according to the embodiment of the present invention and forming a coating film (forming a film).

More specifically, a composition for a non-aqueous secondary battery containing a positive electrode active material is applied and dried as a material for a positive electrode (positive electrode composition) onto a metal foil which is a positive electrode collector to form a positive electrode active material layer, thereby producing a positive electrode sheet for a non-aqueous secondary battery. Next, the composition for a non-aqueous secondary battery (inorganic solid electrolyte-containing composition), which is used for forming a solid electrolyte layer, is applied and dried onto the positive electrode active material layer to form the solid electrolyte layer. Furthermore, a composition for a non-aqueous secondary battery containing a negative electrode active material is applied and dried as a negative electrode material (negative electrode composition) onto the solid electrolyte layer to form a negative electrode active material layer. A negative electrode collector (a metal foil) is superposed on the negative electrode active material layer, whereby it is possible to obtain an all-solid-state secondary battery having a structure in which the solid electrolyte layer is sandwiched between the positive electrode active material layer and the negative electrode active material layer. A desired all-solid-state secondary battery can also be manufactured by sealing the all-solid-state secondary battery in a housing.

In addition, it is also possible to manufacture an all-solid-state secondary battery by performing the forming method of each layer in reverse order to form the negative electrode active material layer, the solid electrolyte layer, and the positive electrode active material layer on the negative electrode collector, and then superposing the positive electrode collector thereon.

As another method, the following method can be exemplified. That is, a positive electrode sheet for an all-solid-state secondary battery is produced as described above. In addition, a composition for a non-aqueous secondary battery containing a negative electrode active material is applied and dried as a negative electrode material (negative electrode composition) onto a metal foil which is a negative electrode collector to form a negative electrode active material layer, thereby producing a negative electrode sheet for a non-aqueous secondary battery. Next, a solid electrolyte layer is formed on the active material layer in any one of these sheets as described above. Furthermore, the other of the positive electrode sheet for an all-solid-state secondary battery and the negative electrode sheet for an all-solid-state secondary battery is laminated on the solid electrolyte layer such that the solid electrolyte layer and the active material layer come into contact with each other. In this manner, an all-solid-state secondary battery can be manufactured.

In addition, as still another method, the following method can be exemplified. That is, the positive electrode sheet for an all-solid-state secondary battery and the negative electrode sheet for an all-solid-state secondary battery are produced as described above. In addition, separately from the positive electrode sheet for an all-solid-state secondary battery and the negative electrode sheet for an all-solid-state secondary battery, the composition for a non-aqueous secondary battery is applied and dried onto a substrate, thereby producing a solid electrolyte sheet for an all-solid-state secondary battery consisting of the solid electrolyte layer. Furthermore, the positive electrode sheet for an all-solid-state secondary battery and the negative electrode sheet for an all-solid-state secondary battery are laminated such that the solid electrolyte layer removed from the substrate is sandwiched therebetween. In this manner, an all-solid-state secondary battery can be manufactured.

Furthermore, the positive electrode sheet for an all-solid-state secondary battery, the negative electrode sheet for an all-solid-state secondary battery, and the solid electrolyte sheet for an all-solid-state secondary battery are produced as described above. Next, the positive electrode sheet for an all-solid-state secondary battery or the negative electrode sheet for an all-solid-state secondary battery, and the solid electrolyte sheet for an all-solid-state secondary battery are superimposed and pressurized into a state in which the positive electrode active material layer or the negative electrode active material layer is brought into contact with the solid electrolyte layer. In this manner, the solid electrolyte layer is transferred to the positive electrode sheet for an all-solid-state secondary battery or the negative electrode sheet for an all-solid-state secondary battery. Thereafter, the solid electrolyte layer from which the substrate of the solid electrolyte sheet for an all-solid-state secondary battery has been peeled off and the negative electrode sheet for an all-solid-state secondary battery or the positive electrode sheet for an all-solid-state secondary battery are superimposed and pressurized (into a state in which the negative electrode active material layer or the positive electrode active material layer is brought into contact with the solid electrolyte layer). In this manner, an all-solid-state secondary battery can be manufactured. The pressurizing method and the pressurizing conditions in the method are not particularly limited, and a method and pressurizing conditions described in the pressurization step, which will be described later, can be adopted.

The solid electrolyte layer and the like can also be formed by, for example, pressurizing and molding the composition for a non-aqueous secondary battery or the like on a substrate or an active material layer under pressurizing conditions described later.

In the above-described manufacturing method, it is sufficient that the composition for a non-aqueous secondary battery according to the embodiment of the present invention is used in any one of the positive electrode composition, the composition for a non-aqueous secondary battery, or the negative electrode composition. The composition for a non-aqueous secondary battery according to the embodiment of the present invention is preferably used in the inorganic solid electrolyte-containing composition or at least one of the positive electrode composition or the negative electrode composition, or the composition for a non-aqueous secondary battery according to the embodiment of the present invention can be used in any of the compositions.

In a case where the solid electrolyte layer or the active material layer is formed of a composition other than the composition for a non-aqueous secondary battery according to the embodiment of the present invention, examples thereof include a typically used composition. In addition, the negative electrode active material layer can also be formed by bonding ions of a metal belonging to Group 1 or Group 2 in the periodic table, which are accumulated on a negative electrode collector during initialization described later or during charging for use, without forming the negative electrode active material layer during the manufacturing of the all-solid-state secondary battery to electrons and precipitating the ions on the negative electrode collector and the like as a metal.

### <Formation (Film Formation) of Each Layer>

A coating method of the composition for a non-aqueous secondary battery is not particularly limited and can be appropriately selected. Examples thereof include coating (preferably wet-type coating), spray coating, spin coating, dip coating, slit coating, stripe coating, and bar coating. A coating temperature is not particularly limited, and examples thereof include a temperature range of usually room temperature (for example, 15° C. to 30° C.) under non-heating.

The applied composition for a non-aqueous secondary battery is subjected to a drying treatment (heating treatment). The drying treatment may be performed after applying each composition, or may be performed after multilayer coating with a plurality of compositions. A drying temperature is not particularly limited. The lower limit thereof is preferably 30° C. or higher, more preferably 60° C. or higher, and still more preferably 80° C. or higher. The upper limit thereof is preferably 300° C. or lower, more preferably 250° C. or lower, and still more preferably 200° C. or lower. In a case where the composition is heated in the above-described temperature range, the dispersion medium can be removed and the layer can be made into a solid state (coated and dried layer). The temperature range is preferable since the temperature is not excessively increased and each member of the all-solid-state secondary battery is not impaired. As a result, excellent overall performance is exhibited in the all-solid-state secondary battery, and it is possible to obtain favorable bonding property and favorable ion conductivity.

After applying and drying the composition for a non-aqueous secondary battery, it is preferable to pressurize each layer or the all-solid-state secondary battery after superimposing the constituent layers or producing the all-solid-state secondary battery. In addition, it is also preferable that each of the layers is pressurized together in a state of being laminated. Examples of the pressurizing method include a method using a hydraulic cylinder press machine. A pressurizing force is not particularly limited, but it is generally preferably in a range of 5 to 1,500 MPa.

In addition, the pressurization and the heating of the applied composition for a non-aqueous secondary battery may be carried out at the same time. A heating temperature is not particularly limited, but is generally in a range of 30° C. to 300° C. The pressing can also be applied at a temperature higher than a glass transition temperature of the inorganic solid electrolyte. The pressing can also be applied at a temperature higher than a glass transition temperature of the polymer according to the embodiment of the present invention. Here, the temperature is generally a temperature not exceeding a melting point of the polymer according to the embodiment of the present invention.

The pressurization may be carried out in a state in which the coating solvent or the dispersion medium has been dried in advance or in a state in which the solvent or the dispersion medium remains.

The respective compositions may be applied at the same time, and the application, the drying, and the pressing may be carried out simultaneously and/or sequentially. Each of the compositions may be applied onto each of the separate substrates, and then laminated by carrying out the transfer.

The atmosphere in the film forming method (coating, drying, and pressurization (under heating) is not particularly limited, and may be any atmosphere such as atmospheric air, dry air (dew point of −20° C. or lower), or inert gas (for example, an argon gas, a helium gas, or a nitrogen gas).

A pressurization time may be a short time (for example, within several hours) under the application of a high pressure, or a long time (one day or longer) under the application of an intermediate pressure. In a case of members other than the sheet for an all-solid-state secondary battery, for example, the all-solid-state secondary battery, it is also possible to use a restraining tool (screw fastening pressure or the like) of the all-solid-state secondary battery in order to continuously apply an intermediate pressure. A pressing pressure may be a pressure that is uniform or varies with respect to a portion under pressure such as a sheet surface. The pressing pressure may be changed according to the area or the film thickness of the portion under pressure. In addition, the pressure may also be variable stepwise for the same portion. A pressing surface may be flat or roughened.

### <Initialization>

The non-aqueous secondary battery manufactured as described above is preferably initialized after the manufacturing or before use. The initialization is not particularly limited, and it is possible to initialize the non-aqueous secondary battery by, for example, carrying out initial charging and discharging in a state in which the pressing pressure is increased and then releasing the pressure until it reaches a general working pressure of the non-aqueous secondary battery.

### [Use Application of Non-Aqueous Secondary Battery]

The non-aqueous secondary battery according to the embodiment of the present invention can be applied to a variety of use applications. The application aspect is not particularly limited, and in a case of being mounted in an electronic apparatus, examples thereof include a notebook computer, a pen-based input personal computer, a mobile personal computer, an e-book player, a mobile phone, a cordless phone handset, a pager, a handy terminal, a portable fax, a mobile copier, a portable printer, a headphone stereo, a video movie, a liquid crystal television, a handy cleaner, a portable CD, a mini disc, an electric shaver, a transceiver, an electronic notebook, a calculator, a memory card, a portable tape recorder, a radio, and a backup power supply. In addition, in a case of being used for consumer applications, examples thereof include an automobile (electric vehicle and the like), an electric vehicle, a motor, a lighting instrument, a toy, a game device, a road conditioner, a watch, a strobe, a camera, and a medical device (a pacemaker, a hearing aid, a shoulder massage device, and the like). Furthermore, the non-aqueous electrolytic solution secondary can be used for various military usages and universe usages. In addition, the secondary battery according to the embodiment of the present invention can also be combined with a solar cell.

### EXAMPLES

Hereinafter, the present invention will be described in more detail based on Examples, but the present invention is not limited thereto be interpreted. “Part” and “%” that represent compositions in the following Examples are based on the mass unless particularly otherwise described. In the present invention, “room temperature” means 25° C.

### [Example 1] Synthesis of Polymer and Preparation of Polymer Solution or Dispersion Liquid

The following polymers shown in the following chemical formulae and Table 1 were synthesized as follows, and a polymer solution or a dispersion liquid was prepared.

In the following chemical formulae, the degree of polymerization of a siloxane structure in a polymerized chain consisting of polysiloxane is not described. In addition, R^{Y} bonded to the polymerized chain consisting of polysiloxane represents a linking group, and R^{Z} represents a substituent. “Ph” in the following polymer B-01 represents a phenyl group. In addition, in the following polymers B-01 to B-06, B-21, and T-1 to T-5, the numerical value described below each constitutional component indicates the content (% by mass) of the constitutional component in the polymer.

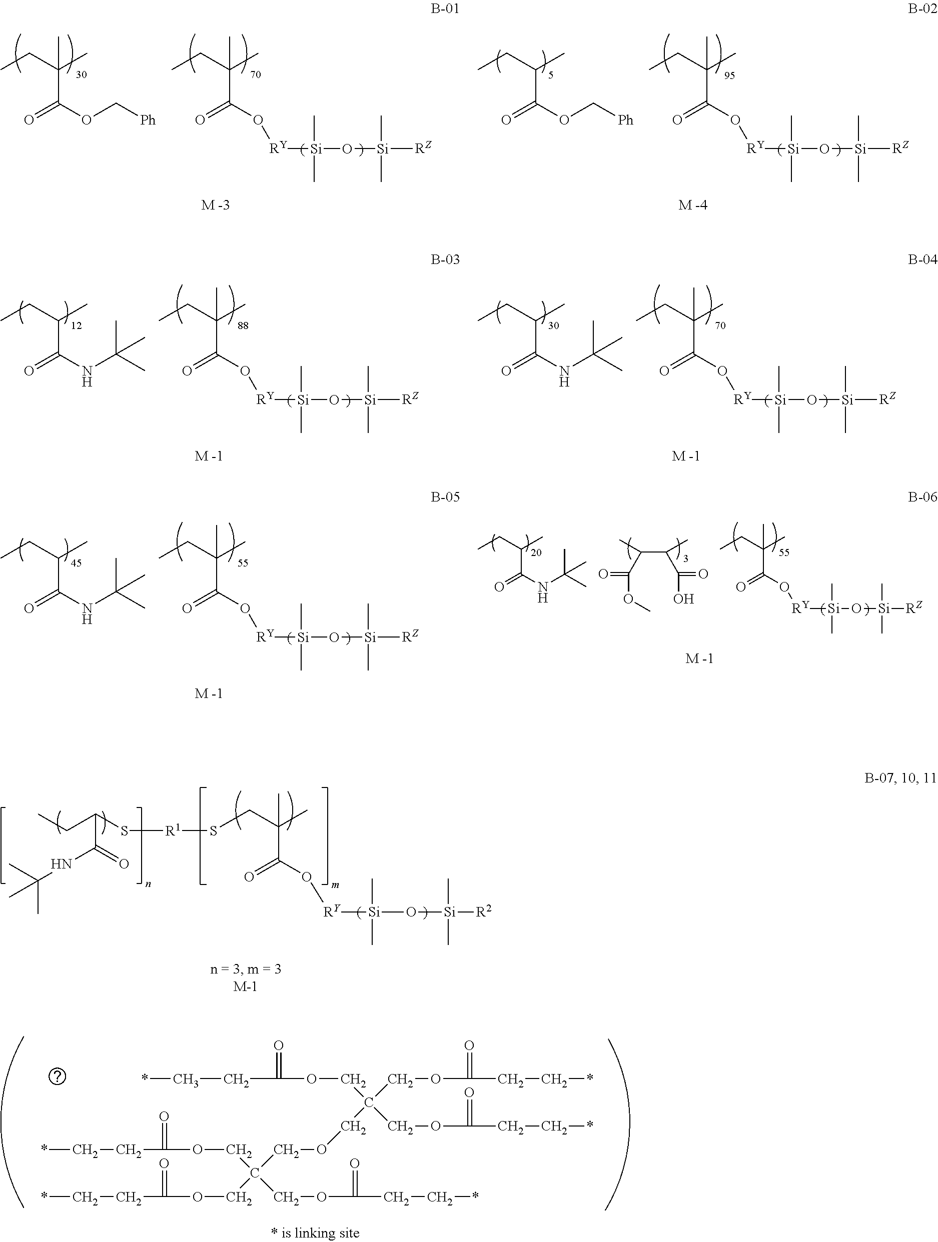

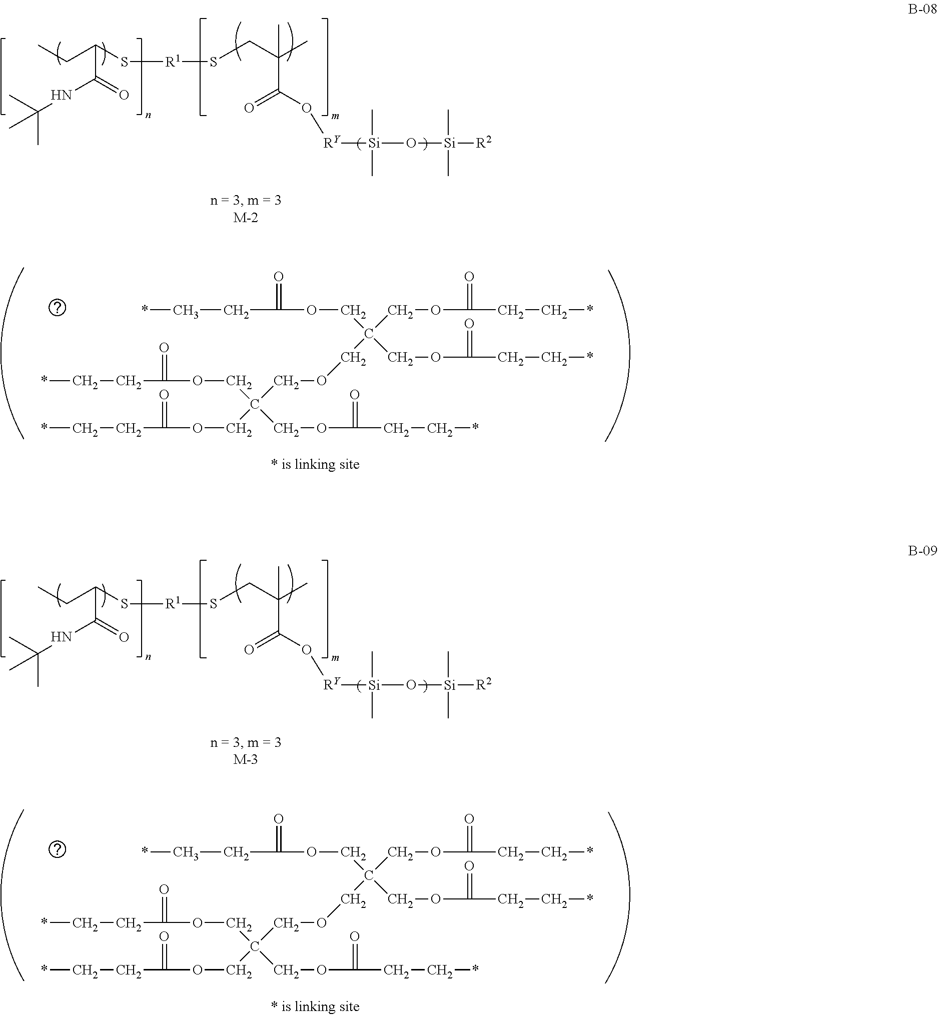

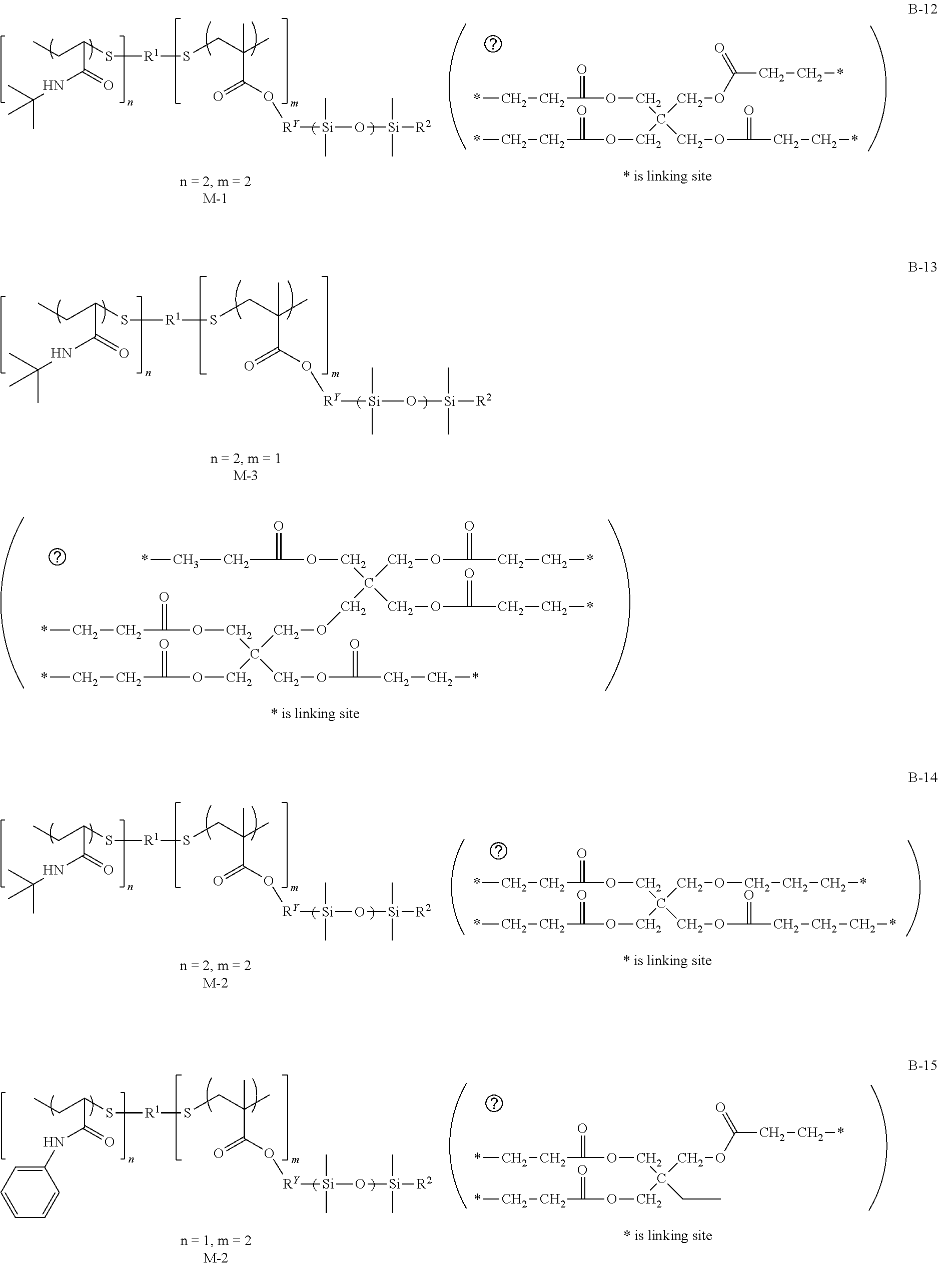

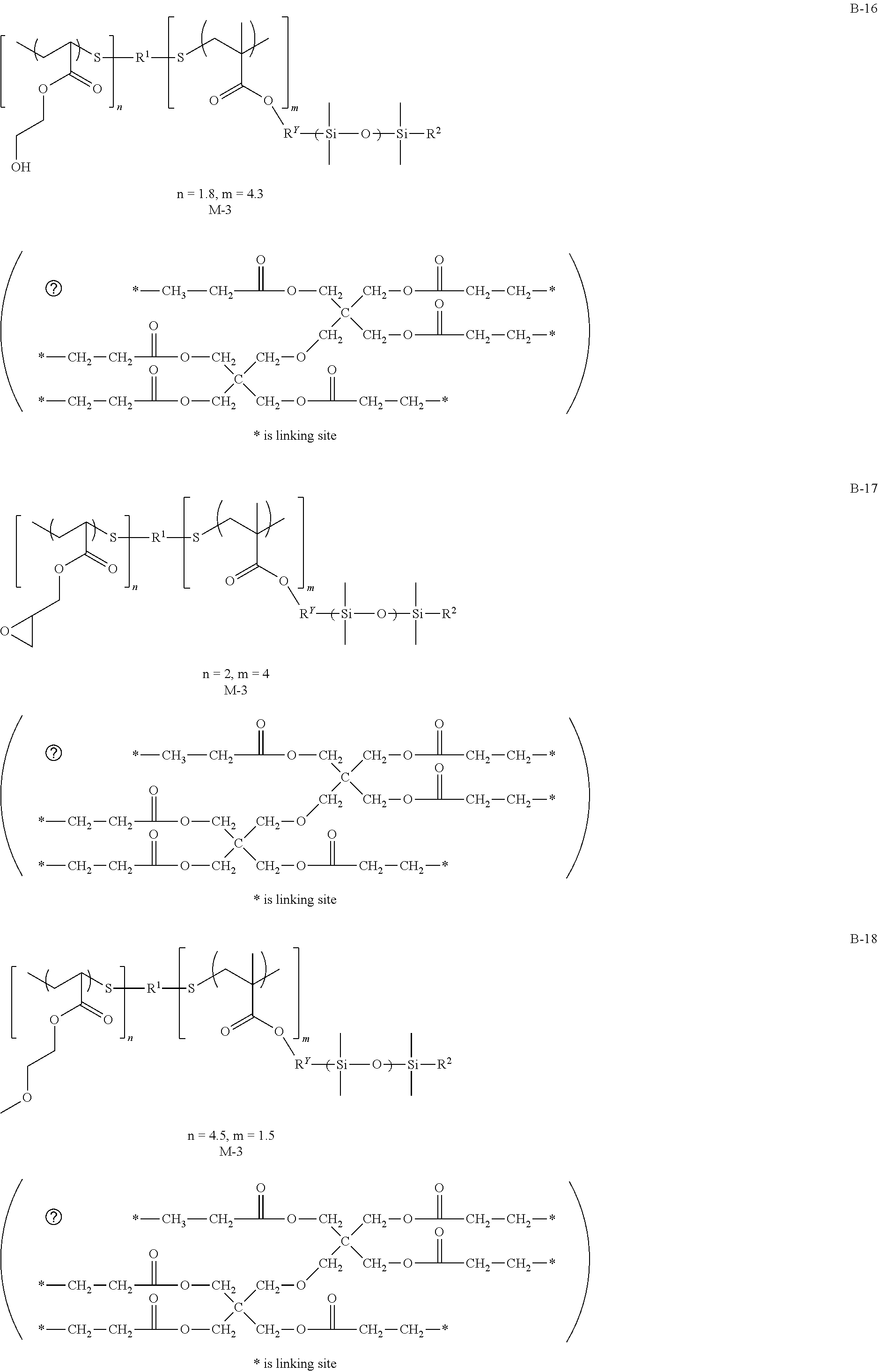

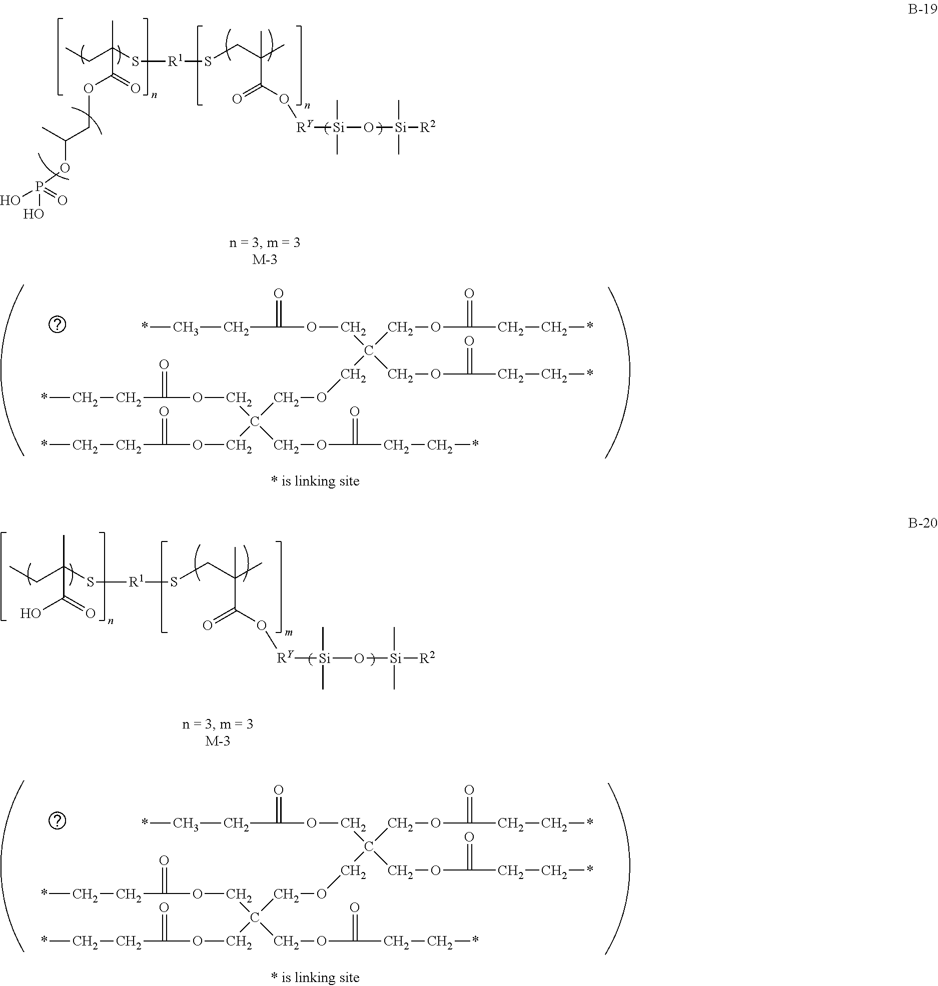

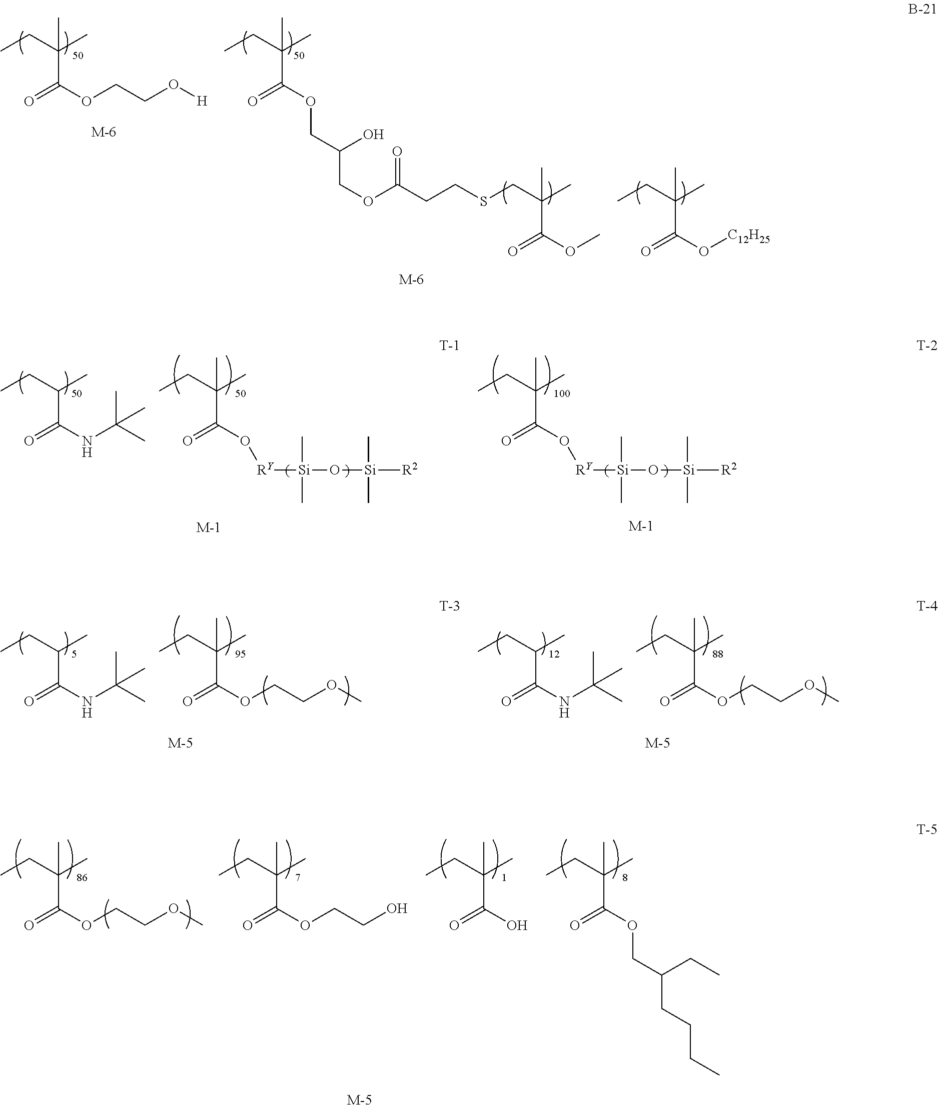

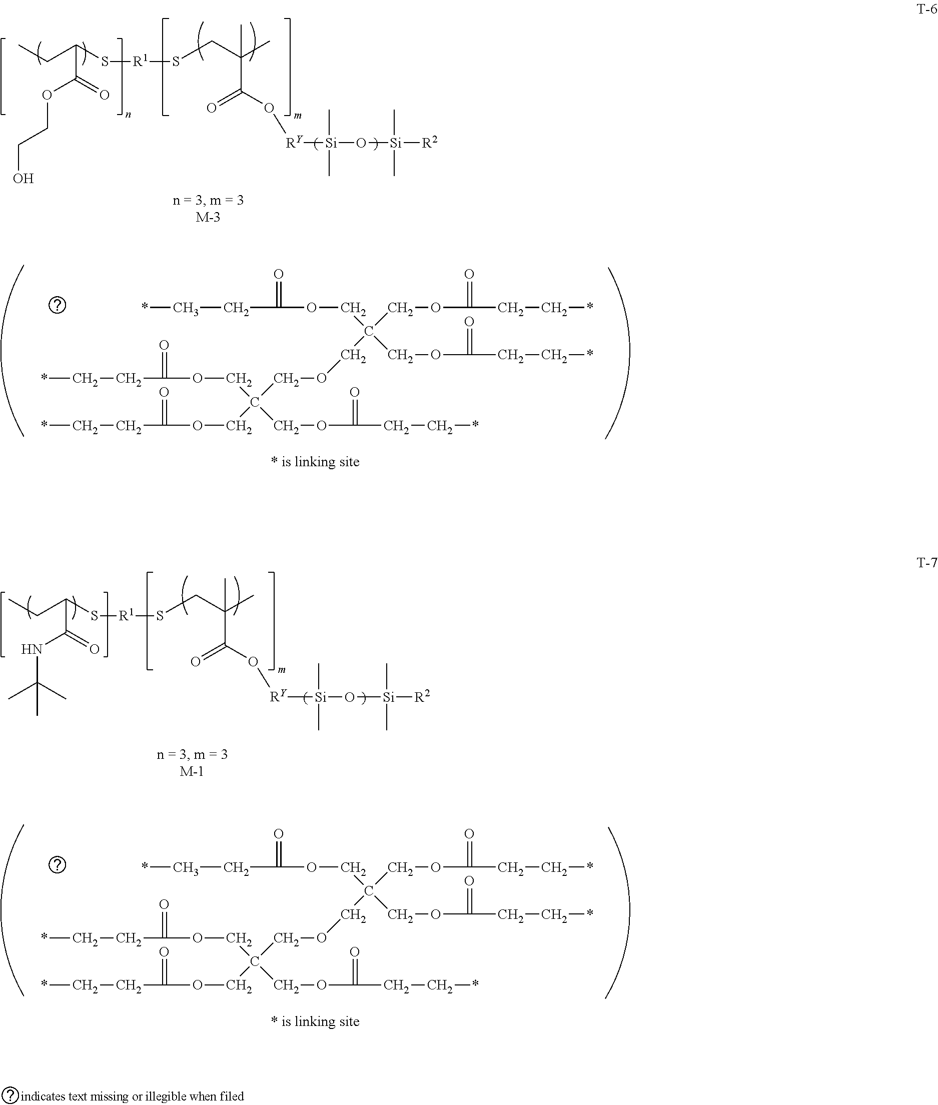

### Synthesis Example B-01: Synthesis of Polymer B-01 and Preparation of Polymer Solution B-01

First, 12.6 g of KF-2012 (product name, manufactured by Shin-Etsu chemical Co., Ltd.), 5.4 g of benzyl methacrylate, and 2.7 g of a polymerization initiator V-601 (product name, manufactured by FUJIFIL Wako Pre Chemical Corporation) were charged into a 200 mL graduated cylinder, and the mixture was dissolved in 81 g of butyl butyrate to prepare a monomer solution.

Next, 81 g of butyl butyrate was charged into a 300 mL three-neck flask, and stirred at 85° C. under a nitrogen stream. Next, the above-described monomer solution was added dropwise thereto over 2 hours, and after the dropwise addition was completed, the temperature was raised to 90° C. and the mixture was stirred for 2 hours. The obtained polymerization solution was poured into 800 g of methanol, stirred for 10 minutes, and allowed to stand for 10 minutes. The precipitate obtained after removing the supernatant was dssolved in 60 g of butyl butyrate and heated at 30 hPa and 80° C. for 1 hour to distill off methanol.

In this way, a polymer B-01 as a random copolymer was synthesized, and a polymer solution B-1 (concentration: 10% by mass) consisting of the polymer was obtained.

### Synthesis Examples B-02 to B-06: Synthesis of Polymers B-02 to B-06 and Preparation of Polymer Solutions B-02 to B-06

Polymers B-02 to B-06 as a random copolymer were synthesized in the same manner as in Synthesis Example B-01, except that, in Synthesis Example B-01, a compound for deriving each constitutional component was used such that the polymers B-02 to B-06 had the formulation (the type and the content of the constitutional component) shown in Table 1, and the amount of the polymerization initiator was adjusted such that the weight-average molecular weight was as shown in Table 1. As a result, polymer solutions B-02 to B-06 consisting of the respective polymers were obtained.

### Synthesis Example B-07: Synthesis of Polymer B-07 and Preparation of Polymer Solution B-07

First, 80.6 g (89.4 mmol) of X-22-174ASX (product name, manufactured by Shin-Etsu Chemical Co., Ltd.) and 0.4 g of a polymerization initiator V-601 (product name, manufactured by FUJIFILM Wako Pure Chemical Corporation) were charged into a 500 mL graduated cylinder, and the mixture was dissolved in 81 g of butyl butyrate to prepare a monomer solution (X).

Next, 152 g of butyl butyrate and 20.0 g (product name: DPMP, manufactured by SAKAI CHEMICAL INDUSTRY CO.,LTD., 25.5 mmol) of dipentaerythritol hexakis(3-mercaptopropionate) were charged into a 500 mL three-neck flask, the mixture was stirred at 80° C. under a nitrogen stream, and an initiator solution obtained by mixing and dissolving 0.3 g of a polymerization initiator V-601 and 2 g of butyl butyrate in advance was added thereto. After 10 minutes, the above-described monomer solution (X) was added dropwise thereto over 2 hours. After the dropwise addition was completed, the mixture was stirred at 80° C. for 1 hour, and then the temperature was raised to 90° C. and the mixture was stirred for 2 hours to obtain a polymer solution.

Next, 81.1 g (solid content: 24.3 g) of the polymer solution obtained as described above, 3.5 g (27.5 mmol) of tert-butyl acrylamide (tBuAAm), and 0.1 g of a polymerization initiator V-601 (product name, manufactured by FUJIFILM Wako Pure Chemical Corporation) were charged into a 200 mL graduated cylinder, and the mixture was dissolved in 20 g of N-methyl-2-pyrrolidone to prepare a monomer solution (A). Next, 33 g of butyl butyrate was charged into a 300 mL three-neck flask, the mixture was stirred at 80° C. under a nitrogen stream, and an initiator solution obtained by mixing and dissolving 0.05 g of a polymerization initiator V-601 and 2 g of butyl butyrate in advance was added thereto. Next, the above-described monomer solution (A) was added dropwise thereto over 2 hours after 10 minutes. After the dropwise addition was completed, the mixture was stirred at 80° C. for 2 hours, and then the temperature was raised to 90° C. and the mixture was stirred for 1 hour. The obtained polymerization solution was poured into 800 g of methanol, stirred for 10 minutes, and allowed to stand for 10 minutes. The precipitate obtained after removing the supernatant was dissolved in 60 g of butyl butyrate and heated at 30 hPa and 80° C. for 1 hour to distill off methanol.

In this way, a multibranched polymer B-07 having a polymer chain P^{1X} consisting of a homopolymer of X-22-174ASX and a polymer chain P^{1A} consisting of a homopolymer of tBuAAm as a polymeric arm portion was synthesized, and a polymer solution B-07 (concentration: 10% by mass) consisting of the polymers was obtained.

### Synthesis Examples B-08 to B-20: Synthesis of Polymers B-08 to B-20 and Preparation Of Polymer Solutions B-08 to B-20

Multibranched polymers B-08 to B-20 were synthesized in the same manner as in Synthesis Example B-07, except that, in Synthesis Example B-07, a compound for deriving each component was used such that the polymers B-08 to B-20 had the formulation (the type and the content of the constitutional component and each component of the core portion) shown in Table 1, and the amount of the polymerization initiator was adjusted such that the weight-average molecular weight was as shown in Table 1. As a result, polymer solutions B-08 to B-20 consisting of the respective polymers were obtained.

The polymeric arm portions in each of the multibranched polymers were all polymer chains consisting of a homopolymer of the constitutional component (X) or the constitutional component (A).

### Synthesis Example B-21: Synthesis of Polymer B-21 and Preparation of Binder Dispersion Liquid B-21

First, a macromonomer M-7 was synthesized as follows.

150.2 g of methyl methacrylate (manufactured by FUJIFILM Wako Pure Chemical Corporation), 380.8 g of dodecyl methacrylate (manufactured by FUJIFILM Wako Pure Chemical Corporation), 5.0 g of mercaptopropionic acid, and 5.0 g of a polymerization initiator V-601 (manufactured by FUJIFILM Wako Pure Chemical Corporation) were charged into a 1 L graduated cylinder, and the mixture was stirred to be uniformly dissolved to prepare a monomer solution (M1). 468 g of toluene (manufactured by FUJIFILM Wako Pure Chemical Corporation) was charged into a 2 L three-necked flask and stirred at 80° C., and then the above-described monomer solution (M1) was added dropwise thereto over 2 hours. After completion of the dropwise addition, stirring was carried out at 80° C. for 2 hours, and then the temperature was raised to 90° C. and stirring was carried out for 2 hours. Next, 480 mg of 2,2,6,6-tetramethylpiperidine-1-oxyl (manufactured by FUJIFILM Wako Pure Chemical Corporation), 32.8 g of glycidyl methacrylate (manufactured by FUJIFILM Wako Pure Chemical Corporation), and 6.5 g of tetrabutylammonium bromide (manufactured by FUJIFILM Wako Pure Chemical Corporation) were added thereto, and the mixture was stirred at 120° C. for 3 hours. After allowing the solution to stand at room temperature, the solution was poured into 1,800 g of methanol to remove the supernatant. Butyl butyrate was added thereto, and methanol was distilled off under reduced pressure to obtain a butyl butyrate solution of a macromonomer M-7. A concentration of solid contents was 40% by mass, and a number-average molecular weight was 12,500.

Next, a polymer B-21 was synthesized using the macromonomer M-7 as follows.

120.0 g of BLEMMER AE-400 (manufactured by NOF Corporation) and 2.40 g of a polymerization initiator V-601 (product name, manufactured by FUJIFILM Wako Pure Chemical Corporation) were charged into a 500 mL graduated cylinder, and the mixture dissolved in 155.8 g of butyl butyrate to prepare a monomer solution (M2).

300 g (solid content: 120.0 g) of the macromonomer M-7 solution and 225.0 g of butyl butyrate were charged into a 2 L three-neck flask, the mixture was stirred at 80° C., and the above-described monomer solution (M2) was added dropwise thereto over 2 hours. After the completion of the dropwise addition, the mixture was heated to 90° C. and stirred for 2 hours.

In this way, a binder dispersion liquid B-21 (concentration: 30% by mass) in which the polymer B-21 was dispersed in butyl butyrate was obtained. An average particle diameter of the binder in the dispersion liquid was 100 nm.

### Synthesis Examples T-1 to T-5: Synthesis of Polymers T-1 to T-5 and Preparation of Polymer Solutions T-1 to T-5

Polymers T-1 to T-5 were synthesized in the same manner as in Synthesis Example B-01, except that, in Synthesis Example B-01, a compound for deriving each constitutional component was used such that the polymers T-1 to T-5 had the formulation (the type and the content of the constitutional component) shown in Table 1, and the amount of the polymerization initiator was adjusted such that the weight-average molecular weight was as shown in Table 1. As a result, polymer solutions T-1 to T-5 consisting of the respective polymers were obtained. The polymers T-1 and T-3 to T-5 were random copolymers.

### Synthesis Examples T-6 and T-7: Synthesis of Polymers T-6 and T-7 and Preparation of Polymer Solutions T-6 and T-7

Polymers T-6 and T-7 were synthesized in the same manner as in Synthesis Example B-07, except that, in Synthesis Example B-07, a compound for deriving each component was used such that the polymers T-6 and T-7 had the formulation (the type and the content of the constitutional component and each component of the core portion) shown in Table 1, and the amount of the polymerization initiator was adjusted such that the weight-average molecular weight was as shown in Table 1. As a result, polymer solutions T-6 and T-7 consisting of the respective polymers were obtained.

The acid value and the base value of each of the synthesized polymers were measured by the above-described methods.

As a result, the acid value of the polymer B-06 was 13 mgKOH/g, the acid value of the polymer B-19 was 6 mgKOH/g, the acid value of the polymer B-20 was 20 mgKOH/g, the acid value of the polymer T-5 was 8 mgKOH/g, and the acid values of the other polymers were 0 mgKOH/g.

The base values of the polymers B-01 to B-21 and T-1 to T-7 were all 0 mgKOH/g.

The viscosity and the weight-average molecular weight of each of the synthesized polymers are shown in Table 1. The viscosity and the weight-average molecular weight were measured by the above-described methods. The viscosity was measured by sufficiently drying the solvent under reduced pressure to prepare a sample of the polymer monomer. In addition, the column of “State” of Table 1 indicates the state of the polymer in each composition described later where the state had been determined to be dissolved or particles (dispersed in a particle shape without being dissolved) based on the results obtained by measuring the solubility in the dispersion medium according to the above-described method. All of the synthesized polymers had no flash point (flash point was 250° C. or higher).

The “Content (% by mass)” described in Table 1 is a value calculated from the preparation ratio of each compound during the preparation.

TABLE 1

| | Constitutional | | | | | | | | |
|---|---|---|---|---|---|---|---|---|---|
| | component (X) | | | | | | | | |
| | | | Number- | Constitutional component (A) | | | | | |
| | | Content | average | | | Content | | | Content |
| | | (% by | molecular | | Functional | (% by | | Functional | (% by |
| No. | | mass) | weight | | group | mass) | | group | mass) |
| B-01 | M-3 | 70 | 4600 | — | — | — | — | — | — |
| B-02 | M-4 | 95 | 400 | tBuAAm | Amide | 5 | — | — | — |
| | | | | | group | | | | |
| B-03 | M-1 | 88 | 900 | tBuAAm | Amide | 12 | — | — | — |
| | | | | | group | | | | |
| B-04 | M-1 | 70 | 900 | tBuAAm | Amide | 30 | — | — | — |
| | | | | | group | | | | |
| B-05 | M-1 | 55 | 900 | tBuAAm | Amide | 45 | — | — | — |
| | | | | | group | | | | |
| B-06 | M-1 | 77 | 900 | tBuAAm | Amide | 20 | MA | Dicarboxylic | 3 |
| | | | | | group | | | acid group | |
| B-07 | M-1 | 88 | 900 | tBuAAm | Amide | 12 | — | — | — |
| | | | | | group | | | | |
| B-08 | M-2 | 88 | 2300 | tBuAAm | Amide | 12 | — | — | — |
| | | | | | group | | | | |
| B-09 | M-3 | 88 | 4600 | tBuAAm | Amide | 12 | — | — | — |
| | | | | | group | | | | |
| B-10 | M-1 | 70 | 900 | tBuAAm | Amide | 30 | — | — | — |
| | | | | | group | | | | |
| B-11 | M-1 | 50 | 900 | tBuAAm | Amide | 50 | — | — | — |
| | | | | | group | | | | |
| B-12 | M-1 | 88 | 900 | tBuAAm | Amide | 12 | — | — | — |
| | | | | | group | | | | |
| B-13 | M-3 | 80 | 4600 | iPrAAm | Amide | 20 | — | — | — |
| | | | | | group | | | | |
| B-14 | M-2 | 65 | 2300 | MeAAm | Amide | 35 | — | — | — |
| | | | | | group | | | | |
| B-15 | M-2 | 80 | 2300 | PhAAm | Amide | 20 | — | — | — |
| | | | | | group | | | | |
| B-16 | M-3 | 85 | 4600 | HEA | Hydroxy | 15 | — | — | — |
| | | | | | group | | | | |
| B-17 | M-3 | 90 | 4600 | GMA | Epoxy | 10 | — | — | — |
| | | | | | group | | | | |
| B-18 | M-3 | 85 | 4600 | MEA | Ether | 15 | — | — | — |
| | | | | | group | | | | |
| B-19 | M-3 | 95 | 4600 | Phosmer | Phosphoric | 5 | — | — | — |
| | | | | PP | acid group | | | | |
| B-20 | M-3 | 97 | 4600 | MAA | Carboxy | 3 | — | — | — |
| | | | | | group | | | | |
| B-21 | M-6 | 50 | 500 | — | — | — | — | — | — |
| | M-7 | 50 | 12500 | | | | | | |
| | M-7 | | | | | | | | |
| T-1 | M-1 | 50 | 900 | tBuAAm | Amide | 50 | — | — | — |
| | | | | | group | | | | |
| T-2 | M-1 | 100 | 900 | — | — | — | — | — | — |
| T-3 | M-5 | 95 | 300 | tBuAAm | Amide | 5 | — | — | — |
| | | | | | group | | | | |
| T-4 | M-5 | 88 | 300 | tBuAAm | Amide | 12 | — | — | — |
| | | | | | group | | | | |
| T-5 | M-5 | 86 | 300 | HEMA | Hydroxy | 7 | AA | | 1 |
| | | | | | group | | | | |
| T-6 | M-3 | 70 | 4600 | HEA | Hydroxy | 30 | — | — | — |
| | | | | | group | | | | |
| T-7 | M-1 | 98 | 900 | tBuAAm | Amide | 2 | — | — | — |
| | | | | | group | | | | |

| | | | Weight- | | | |
|---|---|---|---|---|---|---|
| | | | average | | | |
| | SP | Core | molecular | Viscosity | | |
| No. | value | portion | weight | (Pa · s) | State | Remark |
| B-01 | 17.8 | — | 9,000 | 2.0 | Dissolved | Present |
| | | | | | | invention |
| B-02 | 17.1 | — | 4.000 | 0.10 | Dissolved | Present |
| | | | | | | invention |
| B-03 | 17.6 | — | 9,000 | 0.50 | Dissolved | Present |
| | | | | | | invention |
| B-04 | 18.9 | — | 6,000 | 20 | Dissolved | Present |
| | | | | | | invention |
| B-05 | 20.0 | — | 8,000 | 8,000 | Dissolved | Present |
| | | | | | | invention |
| B-06 | 18.2 | — | 12,000 | 6,000 | Dissolved | Present |
| | | | | | | invention |
| B-07 | 17.6 | DPMP | 6,000 | 10 | Dissolved | Present |
| | | | | | | invention |
| B-08 | 17.3 | DPMP | 15,000 | 2,000 | Dissolved | Present |
| | | | | | | invention |
| B-09 | 17.2 | DPMP | 30,000 | 6,300 | Dissolved | Present |
| | | | | | | invention |
| B-10 | 18.9 | DPMP | 17,000 | 7,500 | Dissolved | Present |
| | | | | | | invention |
| B-11 | 20.4 | DPMP | 18,000 | 9,000 | Dissolved | Present |
| | | | | | | invention |
| B-12 | 17.6 | PEMP | 5,000 | 2.0 | Dissolved | Present |
| | | | | | | invention |
| B-13 | 18.2 | DPMP | 25.000 | 5,000 | Dissolved | Present |
| | | | | | | invention |
| B-14 | 21.7 | MUT4 | 7,000 | 6,000 | Dissolved | Present |
| | | | | | | invention |
| B-15 | 18.7 | TMMP | 4,000 | 100 | Dissolved | Present |
| | | | | | | invention |
| B-16 | 17.4 | DPMP | 20,000 | 6,000 | Dissolved | Present |
| | | | | | | invention |
| B-17 | 17.1 | DPMP | 18,000 | 3,000 | Dissolved | Present |
| | | | | | | invention |
| B-18 | 16.9 | DPMP | 20,000 | 2,500 | Dissolved | Present |
| | | | | | | invention |
| B-19 | 16.6 | DPMP | 22.000 | 2,000 | Dissolved | Present |
| | | | | | | invention |
| B-20 | 16.5 | DPMP | 23,000 | 1,500 | Dissolved | Present |
| | | | | | | invention |
| B-21 | 19.8 | — | 100,000 | 5,000 | Particles | Present |
| | | | | | | invention |
| T-1 | 20.4 | — | 9,000 | 12,000 | Dissolved | Present |
| | | | | | | invention |
| T-2 | 16.7 | — | 900 | 0.05 | Dissolved | Present |
| | | | | | | invention |
| T-3 | 20.5 | — | 3,500 | 0.05 | Dissolved | Present |
| | | | | | | invention |
| T-4 | 20.8 | — | 5,000 | 1.0 | Dissolved | Present |
| | | | | | | invention |
| T-5 | 20.4 | — | 60,000 | 1.0 | Dissolved | Present |
| | | | | | | invention |
| T-6 | 18.4 | DPMP | 30,000 | 15,000 | Dissolved | Present |
| | | | | | | invention |
| T-7 | 16.8 | DPMP | 15,000 | 0.05 | Dissolved | Present |
| | | | | | | invention |

<Abbreviations in Table 1>
In Table 1, “—” in the column of the constitutional component indicates that the compound did not have a corresponding constitutional component.

The benzyl methacrylate (manufactured by FUJIIJLM Wako Pure Chemical Corporation; SP value: 20.2) used for preparing the polymer B-01 and the 2-ethylhexyl acrylate (manufactured by FUJIIJLM Wako Pure Chemical Corporation; SP value: 17.3) used for preparing the polymer T-1 do not correspond to any of the constitutional components (A) and (X), and thus are not described in the column of the constitutional component in Table 1.

The column of “Constitutional component (X)” in Table 1 indicates the following compounds from which the above-described constitutional component (X) is derived.
M-1: X-22-174ASX (product number, molecular weight: 900, manufactured by Shin-Etsu Chemical Co., Ltd.; SP value: 16.7
M-2: X-22-174BX: (product number, molecular weight: 2,300, manufactured by Shin-Etsu Chemical Co., Ltd.; SP value: 16.4
M-3: KF-2012 (product number, molecular weight: 4,600, manufactured by Shin-Etsu Chemical Co., Ltd., SP value: 16.3
M-4: X-22-2404 (product number, molecular weight: 400, manufactured by Shin-Etsu Chemical Co., Ltd., SP value: 16.8
M-5: methoxypolyethylene glycol monomethacrylate (BLEMMER PME-200, manufactured by NOF Corporation; molecular weight: 300, SP value: 20.3
M-6: polyethylene glycol monomethacrylate (BLEMMER AE-400, manufactured by NOF Corporation; molecular weight: 500, SP value: 21.5
M-7: macromonomer synthesized in Synthesis Example B-21; number-average molecular weight: 12,500, SP value: 18.0

The column of “Constitutional component (A)” in Table 1 indicates the following compounds from which the above-described constitutional component (A) is derived.
tBuAAm: N-tert-butyl acrylamide (manufactured by FUJIFILM Wako Pure Chemical Corporation; SP value: 24.1)
iPrAAM: N-isopropyl acrylamide (manufactured by FUJIFILM Wako Pure Chemical Corporation; SP value: 25.8)
MeAAM: N-methyl acrylamide (manufactured by Sigma-Aldrich Co., LLC; SP value: 31.4)
PhAAM: N-phenyl acrylamide (manufactured by FUJIFILM Wako Pure Chemical Corporation; SP value: 27.9)
HEA: 2-hydroxyethyl acrylate (manufactured by FUJIFILM Wako Pure Chemical Corporation; SP value: 23.5)
GMA: glycidyl methacrylate (manufactured by Tokyo Chemical Industry Co., Ltd.; SP value: 23.7)
MEA: methoxyethyl acrylate (manufactured by Tokyo Chemical Industry Co., Ltd.; SP value: 20.0)
Phosmer PP: acid-phosphoxy-polyoxy-propylene glycol monomethacrylate (degree of polymerization of propyleneoxy group: 5 to 6, manufactured by Uni-Chemical Co., Ltd.; SP value: 19.4)
MAA: methacrylic acid (manufactured by FUJIFILM Wako Pure Chemical Corporation; SP value: 24.0)
HEMA: 2-ethylhexyl methacrylate (manufactured by FUJIFILM Wako Pure Chemical Corporation; SP value: 22.9)
MA: maleic acid anhydride (manufactured by FUJIFILM Wako Pure Chemical Corporation; SP value: 24.1)
AA: acrylic acid (manufactured by FUJIFILM Wako Pure Chemical Corporation; SP value: 25.5)

The column of “Core portion” in Table 1 indicates the following compounds from which “L-(S)-n” of Formula (1) was derived.
DPMP: dipentaerythritol hexakis(3-mercaptopropionate); manufactured by SAKAI CHEMICAL INDUSTRY CO.,LTD.
PEMP: pentaerythritol tetra(3-mercaptopropionate); manufactured by SAKAI CHEMICAL INDUSTRY CO.,LTD.
MUT4: pentaerythritol tetrapropanethiol (product name: Multhiol (registered trademark) Y-4, manufactured by SAKAI CHEMICAL INDUSTRY CO.,LTD.
TMMP: trimethylolpropane tris(3-mercaptopropionate); manufactured by SAKAI CHEMICAL INDUSTRY CO.,LTD.

### Example 2

### 1. Synthesis of Sulfide-Based Inorganic Solid Electrolyte

### Synthesis Example A

A sulfide-based inorganic solid electrolyte was synthesized with reference to non-patent documents of T. Ohtomo, A. Hayashi, M. Tatsumisago, Y. Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a glove box in an argon atmosphere (dew point: −70° C.), lithium sulfide (Li₂S, manufactured by Sigma-Aldrich Co., LLC Co., LLC Co., LLC, purity: >99.98%) (2.42 g) and diphosphorus pentasulfide (P₂S₅, manufactured by Sigma-Aldrich Co., LLC Co., LLC Co., LLC, purity: >99%) (3.90 g) each were weighed, put into an agate mortar, and mixed using an agate pestle for 5 minutes. A mixing ratio between Li₂S and P₂S₅(Li₂S:P₂S₅) was set to 75:25 in terms of molar ratio.

Next, 66 g of zirconia beads having a diameter of 5 mm were put into a 45 mL container made of zirconia (manufactured by FRITSCH), the entire amount of the mixture of the above-described lithium sulfide and the diphosphorus pentasulfide was put thereinto, and the container was completely sealed in an argon atmosphere. The container was set in a planetary ball mill P-7 (product name, manufactured by FRITSCH), mechanical milling was carried out at a temperature of 25° C. and a rotation speed of 510 rpm for 20 hours, thereby obtaining a yellow powder (6.20 g) of a sulfide-based inorganic solid electrolyte (Li—P—S-based glass, hereinafter, may be denoted as LPS). A particle diameter of the Li—P—S-based glass was 15 m.

2. Each of compositions shown in Table 2-1 to Table 2-4 (collectively referred to as Table 2) was prepared as follows.

### <Preparation of Inorganic Solid Electrolyte-Containing Composition>

60 g of zirconia beads having a diameter of 5 mm was put into a 45 mL container made of zirconia (manufactured by FRITSCH), and 9.85 g of LPS synthesized in Synthesis Example A described above, 0.15 g (in terms of solid content mass) of the polymer solution or the dispersion liquid shown in Table 2-1 or Table 2-4, and 10 g (total amount) of butyl butyrate as a dispersion medium were put thereinto. Thereafter, the container was set in a planetary ball mill P-7 (product name). Mixing was carried out at a temperature of 25° C. and a rotation speed of 150 rpm for 5 minutes to prepare each of inorganic solid electrolyte-containing compositions (slurries) K-1 to K-21 and Kc11 to Kc17.

### <Preparation of Positive Electrode Composition>

60 g of zirconia beads having a diameter of 5 mm were put into a 45 mL container made of zirconia (manufactured by FRITSCH), and then 7.81 g of LPS synthesized in Synthesis Example A, and 6.4 g (total amount) of butyl butyrate as a dispersion medium were put into the container. The container was set in a planetary ball mill P-7 (product name) and the components were stirred for 15 minutes at 25° C. and a rotation speed of 200 rpm. Thereafter, into the container, 5.44 g of NMC (manufactured by Sigma-Aldrich Co., LLC) as a positive electrode active material, 0.24 g of acetylene black (AB) as a conductive auxiliary agent, and 0.10 g (in terms of solid content mass) of the polymer solution or the dispersion liquid shown in Table 2-2 or Table 2-4 were put. The container was set in a planetary ball mill P-7 (product name), and mixing was continued for 15 minutes at a temperature of 25° C. and a rotation speed of 200 rpm to prepare each of positive electrode compositions (slurries) PK-1 to PK-21 and PKc21 to PKc27.

### <Preparation of Negative Electrode Composition>

60 g of zirconia beads having a diameter of 5 mm was put into a 45 mL container made of zirconia (manufactured by FRITSCH), and 4.53 g of LPS synthesized in Synthesis Example A, 0.08 g (in terms of solid content mass) of the polymer solution or the dispersion liquid shown in Table 2-3 or Table 2-4, and 10 g (total amount) of butyl butyrate were put thereinto. The container was set in a planetary ball mill P-7 (product name) and the components were mixed for 30 minutes at a temperature of 25° C. and a rotation speed of 300 rpm. Thereafter, 5.0 g of silicon (Si) as a negative electrode active material and 0.40 g of VGCF (manufactured by Showa Denko K.K.) as a conductive auxiliary agent were charged, and the container was set in a planetary ball mill P-7 (product name) in the same manner, and the mixture was stirred at a temperature of 25° C. and a rotation speed of 100 rpm for 5 minutes to prepare each of negative electrode compositions (slurries) NK-1 to NK-21 and NKc21 to NKc27.

In Table 2, the composition content is the content (% by mass) with respect to the total mass of the composition, the solid content is the content (% by mass) with respect to 100% by mass of the solid content of the composition, and the unit is omitted in the table.

### <Evaluation 1: Dispersion Time Test>

Regarding each of the prepared compositions, LPS, the polymer solution, the dispersion medium, the active material, and the conductive auxiliary agent were mixed in the same conditions as the preparation conditions of each composition at the same proportion as the proportion of the composition content and the solid content shown in Table 2, thereby preparing a composition (a slurry) for evaluating dispersibility. Regarding each of the prepared compositions, a grind meter (manufactured by Asahisouken) was used to check whether or not aggregates of solid particles were generated. In the present test, the particle size at which linear marks and granular marks were generated was observed with a grind meter, and a case in which the particle size was 5 m or less was defined as no aggregate. In addition, the evaluation was carried out on whether the composition can be uniformly (without liquid exhaustion and at a constant coating thickness) applied at 25° C. using a baker type applicator (product name: SA-201).

The evaluation (presence or absence of an aggregate and possibility of application) was evaluated by setting the dispersion time in the preparation conditions of each composition as a type condition (Tp), and setting the shortest dispersion time (T) at which the dispersion time was long and the composition could be uniformly applied without the occurrence of an aggregate, and determining which of the following evaluation standards was included in the type condition. The results are shown in Table 2.

In the present test, as the shortest dispersion time (T) was shorter, the dispersion energy applied to the composition could be smaller while maintaining the excellent dispersibility of the solid particles, and it was evaluated as a passing level in a case of “D” or higher.

### Evaluation Standard

$$\begin{matrix}A : T \leq T p \times 1.1 \\ B : Tp \times 1.1 \leq T < T p \times 1.3 \\ C : Tp \times 1.3 \leq T < T p \times 1.5 \\ D : Tp \times 1.5 \leq T < T p \times 2.0 \\ E : Tp \times 2.0 \leq T < T p \times 3.\end{matrix}$$

F: aggregate was present even in a dispersion time of 3.0 times Tp.

### <Evaluation 2: Storage Stability Test (Redispersibility)>

As dispersion stability of each composition prepared as described above, redispersibility (storage stability) that could be re-dispersed into an excellent dispersion state immediately after preparation (initial) was evaluated.

Specifically, regarding each of the prepared compositions, LPS, the polymer solution, the dispersion medium, the active material, and the conductive auxiliary agent were mixed in the same conditions as the preparation conditions of each composition at the same proportion as the proportion of the composition content and the solid content shown in Table 2, thereby preparing a composition (a slurry) for evaluating dispersibility. Regarding each of the prepared compositions, generation (the presence or absence) of aggregates of solid particles was checked using a grind meter (manufactured by Asahisouken). A size of the aggregate in this case was denoted as X (μm) and used as an indicator of the initial dispersibility.

On the other hand, each of the prepared compositions was allowed to stand at 25° C. for 24 hours and then mixed again at a temperature of 25° C. using a planetary ball mill P-7 (product name). The rotation speed and the time at the time of remixing were set to the same as the preparation conditions for each of the inorganic solid electrolyte-contaioning composition, the positive electrode composition, and the negative electrode composition. Regarding the remixed composition, the generation (the presence or absence) of aggregates of solid particles was checked using the above-described grind meter. A size of the aggregate in this case was denoted as Y (μm) and used as an indicator of the redispersibility after storage.

The size of the aggregate was set to a point at which remarkable spots appeared on the coating material applied to the grind meter (see JIS K-5600-2-5 6.6).

Ease of generation of aggregates (aggregating properties or sedimentary properties) was evaluated as the storage stability (the redispersibility of the solid particles) of the solid electrolyte composition by determining where the sizes X and Y of the aggregates are included in any of the following evaluation standards. In the present test, it is indicated that, as the size X of the above-described aggregate was smaller, the initial dispersibility was more excellent, and as the size Y was smaller, the storage stability was more excellent. In the present test, the evaluation standard “D” or higher for the size Y of the aggregates was the pass level, and in a case where the size Y was 8 m or less (the evaluation standard was “C” or higher), the size X of the aggregates was also included in the evaluation. The results are shown in Table 2.

### Evaluation Standard

$$\begin{matrix}A : Y \leq 5 μm and X \leq 5 μm \\ B : 5 μm < Y \leq 8 μm and 5 μm < X \leq 8 μm \\ C : 5 μm < Y \leq 8 μm and 8 μm < X \leq 12 μm \\ D : 8 μm < Y \leq 10 μm \\ E : 10 μm < Y \leq 20 μm \\ F : 20 μm < Y\end{matrix}$$

### <Evaluation 3: Handling Test>

In the same manner as in each of the prepared compositions, the same mixing ratio was used except for the dispersion medium, and the amount of the dispersion medium was reduced, whereby a slurry having a concentration of solid contents of 72% by mass was prepared. A 2 mL poly dropper (manufactured by atect Corporation) was disposed vertically so that 10 mm of the tip thereof was positioned below the slurry interface, and the slurry was aspirated at 25° C. for 10 seconds, and the mass W of the poly dropper containing the aspirated slurry was measured. In a case where the tare weight (the empty weight) of the poly dropper is denoted by W₀, it was determined that the slurry cannot be aspirated by the dropper in a case where the slurry mass W-W₀ is less than 0.1 g. In a case where the slurry could not be aspirated with a dropper, the upper limit of the concentration of solid contents at which the slurry can be aspirated with a dropper was estimated while gradually adding the dispersion medium. The handleability (the extent to which an appropriate viscosity suitable which forms a flat constituent layer having a favorable surface property can be obtained) of each of the composition was evaluated by determining where the obtained upper limit of concentration of solid contents is included in any one of the following evaluation standards. 0.30 g of the prepared slurry was placed on an aluminum cup and heated at 120° C. for 2 hours to distill off the dispersion medium, and the concentration of solid contents was calculated.

In the present test, it is indicated that the higher the upper limit of concentration of solid contents is, the better the handleability is, and it was evaluated as a passing level in a case of “D” or higher. The results are shown in Table 3.

### Evaluation Standard

A: upper limit of concentration of solid contents≥70%
B: 70%>upper limit of concentration of solid contents≥65%
C: 65%>upper limit of concentration of solid contents≥60%
D: 60%>upper limit of concentration of solid contents≥55%
E: 55%>upper limit of concentration of solid contents≥50%
F: 50%>upper limit of concentration of solid contents

TABLE 2

| | | Inorganic solid | | | Polymer solution or | | | Dispersion | | Active | | |
|---|---|---|---|---|---|---|---|---|---|---|---|---|
| | | electrolyte | | | dispersion liquid | | | medium | | material | | |
| | | | Compo- | Solid | | Compo- | Solid | | Compo- | | Compo- | Solid |
| | | | sition | con- | | sition | con- | | sition | | sition | con- |
| | No. | | content | tent | | content | tent | | content | | content | tent |
| Inorganic | K-1 | LPS | 49.3 | 98.5 | B-01 | 0.8 | 1.5 | Butyl | 50.0 | — | — | — |
| solid | | | | | | | | butyrate | | | | |
| electrolyte- | K-2 | LPS | 49.3 | 98.5 | B-02 | 0.8 | 1.5 | Butyl | 50.0 | — | — | — |
| containing | | | | | | | | butyrate | | | | |
| composition | K-3 | LPS | 49.3 | 98.5 | B-03 | 0.8 | 1.5 | Butyl | 50.0 | — | — | — |
| | | | | | | | | butyrate | | | | |
| | K-4 | LPS | 49.3 | 98.5 | B-04 | 0.8 | 1.5 | Butyl | 50.0 | — | — | — |
| | | | | | | | | butyrate | | | | |
| | K-5 | LPS | 49.3 | 98.5 | B-05 | 0.8 | 1.5 | Butyl | 50.0 | — | — | — |
| | | | | | | | | butyrate | | | | |
| | K-6 | LPS | 49.3 | 98.5 | B-06 | 0.8 | 1.5 | Butyl | 50.0 | — | — | — |
| | | | | | | | | butyrate | | | | |
| | K-7 | LPS | 49.3 | 98.5 | B-07 | 0.8 | 1.5 | Butyl | 50.0 | — | — | — |
| | | | | | | | | butyrate | | | | |
| | K-8 | LPS | 49.3 | 98.5 | B-08 | 0.8 | 1.5 | Butyl | 50.0 | — | — | — |
| | | | | | | | | butyrate | | | | |
| | K-9 | LPS | 49.3 | 98.5 | B-09 | 0.8 | 1.5 | Butyl | 50.0 | — | — | — |
| | | | | | | | | butyrate | | | | |
| | K-10 | LPS | 49.3 | 98.5 | B-10 | 0.8 | 1.5 | Butyl | 50.0 | — | — | — |
| | | | | | | | | butyrate | | | | |
| | K-11 | LPS | 49.3 | 98.5 | B-11 | 0.8 | 1.5 | Butyl | 50.0 | — | — | — |
| | | | | | | | | butyrate | | | | |
| | K-12 | LPS | 49.3 | 98.5 | B-12 | 0.8 | 1.5 | Butyl | 50.0 | — | — | — |
| | | | | | | | | butyrate | | | | |
| | K-13 | LPS | 49.3 | 98.5 | B-13 | 0.8 | 1.5 | Butyl | 50.0 | — | — | — |
| | | | | | | | | butyrate | | | | |
| | K-14 | LPS | 49.3 | 98.5 | B-14 | 0.8 | 1.5 | Butyl | 50.0 | — | — | — |
| | | | | | | | | butyrate | | | | |
| | K-15 | LPS | 49.3 | 98.5 | B-15 | 0.8 | 1.5 | Butyl | 50.0 | — | — | — |
| | | | | | | | | butyrate | | | | |
| | K-16 | LPS | 49.3 | 98.5 | B-16 | 0.8 | 1.5 | Butyl | 50.0 | — | — | — |
| | | | | | | | | butyrate | | | | |
| | K-17 | LPS | 49.3 | 98.5 | B-17 | 0.8 | 1.5 | Butyl | 50.0 | — | — | — |
| | | | | | | | | butyrate | | | | |
| | K-18 | LPS | 49.3 | 98.5 | B-18 | 0.8 | 1.5 | Butyl | 50.0 | — | — | — |
| | | | | | | | | butyrate | | | | |
| | K-19 | LPS | 49.3 | 98.5 | B-19 | 0.8 | 1.5 | Butyl | 50.0 | — | — | — |
| | | | | | | | | butyrate | | | | |
| | K-20 | LPS | 49.3 | 98.5 | B-20 | 0.8 | 1.5 | Butyl | 50.0 | — | — | — |
| | | | | | | | | butyrate | | | | |
| | K-21 | LPS | 49.3 | 98.5 | B-21 | 0.8 | 1.5 | Butyl | 50.0 | — | — | — |
| | | | | | | | | butyrate | | | | |
| Positive | PK-1 | LPS | 39.1 | 57.5 | B-01 | 0.5 | 0.8 | Butyl | 32.0 | NMC | 27.2 | 40.0 |
| electrode | | | | | | | | butyrate | | | | |
| composition | PK-2 | LPS | 39.1 | 57.5 | B-02 | 0.5 | 0.8 | Butyl | 32.0 | NMC | 27.2 | 40.0 |
| | | | | | | | | butyrate | | | | |
| | PK-3 | LPS | 39.1 | 57.5 | B-03 | 0.5 | 0.8 | Butyl | 32.0 | NMC | 27.2 | 40.0 |
| | | | | | | | | butyrate | | | | |
| | PK-4 | LPS | 39.1 | 57.5 | B-04 | 0.5 | 0.8 | Butyl | 32.0 | NMC | 27.2 | 40.0 |
| | | | | | | | | butyrate | | | | |
| | PK-5 | LPS | 39.1 | 57.5 | B-05 | 0.5 | 0.8 | Butyl | 32.0 | NMC | 27.2 | 40.0 |
| | | | | | | | | butyrate | | | | |
| | PK-6 | LPS | 39.1 | 57.5 | B-06 | 0.5 | 0.8 | Butyl | 32.0 | NMC | 27.2 | 40.0 |
| | | | | | | | | butyrate | | | | |
| | PK-7 | LPS | 39.1 | 57.5 | B-07 | 0.5 | 0.8 | Butyl | 32.0 | NMC | 27.2 | 40.0 |
| | | | | | | | | butyrate | | | | |
| | PK-8 | LPS | 39.1 | 57.5 | B-08 | 0.5 | 0.8 | Butyl | 32.0 | NMC | 27.2 | 40.0 |
| | | | | | | | | butyrate | | | | |
| | PK-9 | LPS | 39.1 | 57.5 | B-09 | 0.5 | 0.8 | Butyl | 32.0 | NMC | 27.2 | 40.0 |
| | | | | | | | | butyrate | | | | |
| | PK-10 | LPS | 39.1 | 57.5 | B-10 | 0.5 | 0.8 | Butyl | 32.0 | NMC | 27.2 | 40.0 |
| | | | | | | | | butyrate | | | | |
| | PK-11 | LPS | 39.1 | 57.5 | B-11 | 0.5 | 0.8 | Butyl | 32.0 | NMC | 27.2 | 40.0 |
| | | | | | | | | butyrate | | | | |
| | PK-12 | LPS | 39.1 | 57.5 | B-12 | 0.5 | 0.8 | Butyl | 32.0 | NMC | 27.2 | 40.0 |
| | | | | | | | | butyrate | | | | |
| | PK-13 | LPS | 39.1 | 57.5 | B-13 | 0.5 | 0.8 | Butyl | 32.0 | NMC | 27.2 | 40.0 |
| | | | | | | | | butyrate | | | | |
| | PK-14 | LPS | 39.1 | 57.5 | B-14 | 0.5 | 0.8 | Butyl | 32.0 | NMC | 27.2 | 40.0 |
| | | | | | | | | butyrate | | | | |
| | PK-15 | LPS | 39.1 | 57.5 | B-15 | 0.5 | 0.8 | Butyl | 32.0 | NMC | 27.2 | 40.0 |
| | | | | | | | | butyrate | | | | |
| | PK-16 | LPS | 39.1 | 57.5 | B-16 | 0.5 | 0.8 | Butyl | 32.0 | NMC | 27.2 | 40.0 |
| | | | | | | | | butyrate | | | | |
| | PK-17 | LPS | 39.1 | 57.5 | B-17 | 0.5 | 0.8 | Butyl | 32.0 | NMC | 27.2 | 40.0 |
| | | | | | | | | butyrate | | | | |
| | PK-18 | LPS | 39.1 | 57.5 | B-18 | 0.5 | 0.8 | Butyl | 32.0 | NMC | 27.2 | 40.0 |
| | | | | | | | | butyrate | | | | |
| | PK-19 | LPS | 39.1 | 57.5 | B-19 | 0.5 | 0.8 | Butyl | 32.0 | NMC | 27.2 | 40.0 |
| | | | | | | | | butyrate | | | | |
| | PK-20 | LPS | 39.1 | 57.5 | B-20 | 0.5 | 0.8 | Butyl | 32.0 | NMC | 27.2 | 40.0 |
| | | | | | | | | butyrate | | | | |
| | PK-21 | LPS | 39.1 | 57.5 | B-21 | 0.5 | 0.8 | Butyl | 32.0 | NMC | 27.2 | 40.0 |
| | | | | | | | | butyrate | | | | |
| Negative | NK-1 | LPS | 22.6 | 45.3 | B-01 | 0.4 | 0.8 | Butyl | 50.0 | Si | 25.0 | 50.0 |
| electrode | | | | | | | | butyrate | | | | |
| composition | NK-2 | LPS | 22.6 | 45.3 | B-02 | 0.4 | 0.8 | Butyl | 50.0 | Si | 25.0 | 50.0 |
| | | | | | | | | butyrate | | | | |
| | NK-3 | LPS | 22.6 | 45.3 | B-03 | 0.4 | 0.8 | Butyl | 50.0 | Si | 25.0 | 50.0 |
| | | | | | | | | butyrate | | | | |
| | NK-4 | LPS | 22.6 | 45.3 | B-04 | 0.4 | 0.8 | Butyl | 50.0 | Si | 25.0 | 50.0 |
| | | | | | | | | butyrate | | | | |
| | NK-5 | LPS | 22.6 | 45.3 | B-05 | 0.4 | 0.8 | Butyl | 50.0 | Si | 25.0 | 50.0 |
| | | | | | | | | butyrate | | | | |
| | NK-6 | LPS | 22.6 | 45.3 | B-06 | 0.4 | 0.8 | Butyl | 50.0 | Si | 25.0 | 50.0 |
| | | | | | | | | butyrate | | | | |
| | NK-7 | LPS | 22.6 | 45.3 | B-07 | 0.4 | 0.8 | Butyl | 50.0 | Si | 25.0 | 50.0 |
| | | | | | | | | butyrate | | | | |
| | NK-8 | LPS | 22.6 | 45.3 | B-08 | 0.4 | 0.8 | Butyl | 50.0 | Si | 25.0 | 50.0 |
| | | | | | | | | butyrate | | | | |
| | NK-9 | LPS | 22.6 | 45.3 | B-09 | 0.4 | 0.8 | Butyl | 50.0 | Si | 25.0 | 50.0 |
| | | | | | | | | butyrate | | | | |
| | NK-10 | LPS | 22.6 | 45.3 | B-10 | 0.4 | 0.8 | Butyl | 50.0 | Si | 25.0 | 50.0 |
| | | | | | | | | butyrate | | | | |
| | NK-11 | LPS | 22.6 | 45.3 | B-11 | 0.4 | 0.8 | Butyl | 50.0 | Si | 25.0 | 50.0 |
| | | | | | | | | butyrate | | | | |
| | NK-12 | LPS | 22.6 | 45.3 | B-12 | 0.4 | 0.8 | Butyl | 50.0 | Si | 25.0 | 50.0 |
| | | | | | | | | butyrate | | | | |
| | NK-13 | LPS | 22.6 | 45.3 | B-13 | 0.4 | 0.8 | Butyl | 50.0 | Si | 25.0 | 50.0 |
| | | | | | | | | butyrate | | | | |
| | NK-14 | LPS | 22.6 | 45.3 | B-14 | 0.4 | 0.8 | Butyl | 50.0 | Si | 25.0 | 50.0 |
| | | | | | | | | butyrate | | | | |
| | NK-15 | LPS | 22.6 | 45.3 | B-15 | 0.4 | 0.8 | Butyl | 50.0 | Si | 25.0 | 50.0 |
| | | | | | | | | butyrate | | | | |
| | NK-16 | LPS | 22.6 | 45.3 | B-16 | 0.4 | 0.8 | Butyl | 50.0 | Si | 25.0 | 50.0 |
| | | | | | | | | butyrate | | | | |
| | NK-17 | LPS | 22.6 | 45.3 | B-17 | 0.4 | 0.8 | Butyl | 50.0 | Si | 25.0 | 50.0 |
| | | | | | | | | butyrate | | | | |
| | NK-18 | LPS | 22.6 | 45.3 | B-18 | 0.4 | 0.8 | Butyl | 50.0 | Si | 25.0 | 50.0 |
| | | | | | | | | butyrate | | | | |
| | NK-19 | LPS | 22.6 | 45.3 | B-19 | 0.4 | 0.8 | Butyl | 50.0 | Si | 25.0 | 50.0 |
| | | | | | | | | butyrate | | | | |
| | NK-20 | LPS | 22.6 | 45.3 | B-20 | 0.4 | 0.8 | Butyl | 50.0 | Si | 25.0 | 50.0 |
| | | | | | | | | butyrate | | | | |
| | NK-21 | LPS | 22.6 | 45.3 | B-21 | 0.4 | 0.8 | Butyl | 50.0 | Si | 25.0 | 50.0 |
| | | | | | | | | butyrate | | | | |
| Inorganic | Kc11 | LPS | 49.3 | 98.5 | T-1 | 0.8 | 1.5 | Butyl | 50.0 | — | — | — |
| solid | | | | | | | | butyrate | | | | |
| electrolyte- | Kc12 | LPS | 49.3 | 98.5 | T-2 | 0.8 | 1.5 | Butyl | 50.0 | — | — | — |
| containing | | | | | | | | butyrate | | | | |
| composition | Kc13 | LPS | 49.3 | 98.5 | T-3 | 0.8 | 1.5 | Butyl | 50.0 | — | — | — |
| | | | | | | | | butyrate | | | | |
| | Kc14 | LPS | 49.3 | 98.5 | T-4 | 0.8 | 1.5 | Butyl | 50.0 | — | — | — |
| | | | | | | | | butyrate | | | | |
| | Kc15 | LPS | 49.3 | 98.5 | T-5 | 0.8 | 1.5 | Butyl | 50.0 | — | — | — |
| | | | | | | | | butyrate | | | | |
| | Kc16 | LPS | 49.3 | 98.5 | T-6 | 0.8 | 1.5 | Butyl | 50.0 | — | — | — |
| | | | | | | | | butyrate | | | | |
| | Kc17 | LPS | 49.3 | 98.5 | T-7 | 0.8 | 1.5 | Butyl | 50.0 | — | — | — |
| | | | | | | | | butyrate | | | | |
| Positive | PKc21 | LPS | 39.1 | 57.5 | T-1 | 0.5 | 0.8 | Butyl | 32.0 | NMC | 27.2 | 40.0 |
| electrode | | | | | | | | butyrate | | | | |
| composition | PKc22 | LPS | 39.1 | 57.5 | T-2 | 0.5 | 0.8 | Butyl | 32.0 | NMC | 27.2 | 40.0 |
| | | | | | | | | butyrate | | | | |
| | PKc23 | LPS | 39.1 | 57.5 | T-3 | 0.5 | 0.8 | Butyl | 32.0 | NMC | 27.2 | 40.0 |
| | | | | | | | | butyrate | | | | |
| | PKc24 | LPS | 39.1 | 57.5 | T-4 | 0.5 | 0.8 | Butyl | 32.0 | NMC | 27.2 | 40.0 |
| | | | | | | | | butyrate | | | | |
| | PKc25 | LPS | 39.1 | 57.5 | T-5 | 0.5 | 0.8 | Butyl | 32.0 | NMC | 27.2 | 40.0 |
| | | | | | | | | butyrate | | | | |
| | PKc26 | LPS | 39.1 | 57.5 | T-6 | 0.5 | 0.8 | Butyl | 32.0 | NMC | 27.2 | 40.0 |
| | | | | | | | | butyrate | | | | |
| | PKc27 | LPS | 39.1 | 57.5 | T-7 | 0.5 | 0.8 | Butyl | 32.0 | NMC | 27.2 | 40.0 |
| | | | | | | | | butyrate | | | | |
| Negative | NKc21 | LPS | 22.6 | 45.3 | T-1 | 0.4 | 0.8 | Butyl | 50.0 | Si | 25.0 | 50.0 |
| electrode | | | | | | | | butyrate | | | | |
| composition | NKc22 | LPS | 22.6 | 45.3 | T-2 | 0.4 | 0.8 | Butyl | 50.0 | Si | 25.0 | 50.0 |
| | | | | | | | | butyrate | | | | |
| | NKc23 | LPS | 22.6 | 45.3 | T-3 | 0.4 | 0.8 | Butyl | 50.0 | Si | 25.0 | 50.0 |
| | | | | | | | | butyrate | | | | |
| | NKc24 | LPS | 22.6 | 45.3 | T-4 | 0.4 | 0.8 | Butyl | 50.0 | Si | 25.0 | 50.0 |
| | | | | | | | | butyrate | | | | |
| | NKc25 | LPS | 22.6 | 45.3 | T-5 | 0.4 | 0.8 | Butyl | 50.0 | Si | 25.0 | 50.0 |
| | | | | | | | | butyrate | | | | |
| | NKc26 | LPS | 22.6 | 45.3 | T-6 | 0.4 | 0.8 | Butyl | 50.0 | Si | 25.0 | 50.0 |
| | | | | | | | | butyrate | | | | |
| | NKc27 | LPS | 22.6 | 45.3 | T-7 | 0.4 | 0.8 | Butyl | 50.0 | Si | 25.0 | 50.0 |
| | | | | | | | | butyrate | | | | |

| | | Conductive | | | | | | |
|---|---|---|---|---|---|---|---|---|
| | | auxiliary agent | | | | | | |
| | | | Compo- | Solid | Disper- | | Han- | |
| | | | sition | con- | sion | Storage | dleabil- | |
| | No. | | content | tent | time | stability | ity | Remark |
| Inorganic | K-1 | — | — | — | C | C | C | Present |
| solid | | | | | | | | invention |
| electrolyte- | K-2 | — | — | — | C | B | C | Present |
| containing | | | | | | | | invention |
| composition | K-3 | — | — | — | B | B | B | Present |
| | | | | | | | | invention |
| | K-4 | — | — | — | A | A | A | Present |
| | | | | | | | | invention |
| | K-5 | — | — | — | B | B | B | Present |
| | | | | | | | | invention |
| | K-6 | — | — | — | A | A | A | Present |
| | | | | | | | | invention |
| | K-7 | — | — | — | B | B | A | Present |
| | | | | | | | | invention |
| | K-8 | — | — | — | B | A | A | Present |
| | | | | | | | | invention |
| | K-9 | — | — | — | A | A | A | Present |
| | | | | | | | | invention |
| | K-10 | — | — | — | A | B | B | Present |
| | | | | | | | | invention |
| | K-11 | — | — | — | B | B | B | Present |
| | | | | | | | | invention |
| | K-12 | — | — | — | B | B | B | Present |
| | | | | | | | | invention |
| | K-13 | — | — | — | A | A | A | Present |
| | | | | | | | | invention |
| | K-14 | — | — | — | B | B | B | Present |
| | | | | | | | | invention |
| | K-15 | — | — | — | B | B | A | Present |
| | | | | | | | | invention |
| | K-16 | — | — | — | B | A | B | Present |
| | | | | | | | | invention |
| | K-17 | — | — | — | B | B | B | Present |
| | | | | | | | | invention |
| | K-18 | — | — | — | B | B | B | Present |
| | | | | | | | | invention |
| | K-19 | — | — | — | B | B | B | Present |
| | | | | | | | | invention |
| | K-20 | — | — | — | B | B | B | Present |
| | | | | | | | | invention |
| | K-21 | — | — | — | C | C | C | Present |
| | | | | | | | | invention |
| Positive | PK-1 | AB | 1.2 | 1.8 | C | C | C | Present |
| electrode | | | | | | | | invention |
| composition | PK-2 | AB | 1.2 | 1.8 | C | B | C | Present |
| | | | | | | | | invention |
| | PK-3 | AB | 1.2 | 1.8 | B | B | B | Present |
| | | | | | | | | invention |
| | PK-4 | AB | 1.2 | 1.8 | A | A | A | Present |
| | | | | | | | | invention |
| | PK-5 | AB | 1.2 | 1.8 | B | B | B | Present |
| | | | | | | | | invention |
| | PK-6 | AB | 1.2 | 1.8 | A | A | A | Present |
| | | | | | | | | invention |
| | PK-7 | AB | 1.2 | 1.8 | B | B | A | Present |
| | | | | | | | | invention |
| | PK-8 | AB | 1.2 | 1.8 | B | A | A | Present |
| | | | | | | | | invention |
| | PK-9 | AB | 1.2 | 1.8 | A | A | A | Present |
| | | | | | | | | invention |
| | PK-10 | AB | 1.2 | 1.8 | A | B | B | Present |
| | | | | | | | | invention |
| | PK-11 | AB | 1.2 | 1.8 | B | B | B | Present |
| | | | | | | | | invention |
| | PK-12 | AB | 1.2 | 1.8 | B | B | B | Present |
| | | | | | | | | invention |
| | PK-13 | AB | 1.2 | 1.8 | A | A | A | Present |
| | | | | | | | | invention |
| | PK-14 | AB | 1.2 | 1.8 | B | B | B | Present |
| | | | | | | | | invention |
| | PK-15 | AB | 1.2 | 1.8 | B | B | A | Present |
| | | | | | | | | invention |
| | PK-16 | AB | 1.2 | 1.8 | B | A | B | Present |
| | | | | | | | | invention |
| | PK-17 | AB | 1.2 | 1.8 | B | B | B | Present |
| | | | | | | | | invention |
| | PK-18 | AB | 1.2 | 1.8 | B | B | B | Present |
| | | | | | | | | invention |
| | PK-19 | AB | 1.2 | 1.8 | B | B | B | Present |
| | | | | | | | | invention |
| | PK-20 | AB | 1.2 | 1.8 | B | B | B | Present |
| | | | | | | | | invention |
| | PK-21 | AB | 1.2 | 1.8 | C | C | C | Present |
| | | | | | | | | invention |
| Negative | NK-1 | VGCF | 2.0 | 4.0 | C | C | C | Present |
| electrode | | | | | | | | invention |
| composition | NK-2 | VGCF | 2.0 | 4.0 | C | B | C | Present |
| | | | | | | | | invention |
| | NK-3 | VGCF | 2.0 | 4.0 | B | B | B | Present |
| | | | | | | | | invention |
| | NK-4 | VGCF | 2.0 | 4.0 | A | A | A | Present |
| | | | | | | | | invention |
| | NK-5 | VGCF | 2.0 | 4.0 | B | B | B | Present |
| | | | | | | | | invention |
| | NK-6 | VGCF | 2.0 | 4.0 | A | A | A | Present |
| | | | | | | | | invention |
| | NK-7 | VGCF | 2.0 | 4.0 | B | B | A | Present |
| | | | | | | | | invention |
| | NK-8 | VGCF | 2.0 | 4.0 | B | A | A | Present |
| | | | | | | | | invention |
| | NK-9 | VGCF | 2.0 | 4.0 | A | A | A | Present |
| | | | | | | | | invention |
| | NK-10 | VGCF | 2.0 | 4.0 | A | B | B | Present |
| | | | | | | | | invention |
| | NK-11 | VGCF | 2.0 | 4.0 | B | B | B | Present |
| | | | | | | | | invention |
| | NK-12 | VGCF | 2.0 | 4.0 | B | B | B | Present |
| | | | | | | | | invention |
| | NK-13 | VGCF | 2.0 | 4.0 | A | A | A | Present |
| | | | | | | | | invention |
| | NK-14 | VGCF | 2.0 | 4.0 | B | B | B | Present |
| | | | | | | | | invention |
| | NK-15 | VGCF | 2.0 | 4.0 | B | B | A | Present |
| | | | | | | | | invention |
| | NK-16 | VGCF | 2.0 | 4.0 | B | A | B | Present |
| | | | | | | | | invention |
| | NK-17 | VGCF | 2.0 | 4.0 | B | B | B | Present |
| | | | | | | | | invention |
| | NK-18 | VGCF | 2.0 | 4.0 | B | B | B | Present |
| | | | | | | | | invention |
| | NK-19 | VGCF | 2.0 | 4.0 | B | B | B | Present |
| | | | | | | | | invention |
| | NK-20 | VGCF | 2.0 | 4.0 | B | B | B | Present |
| | | | | | | | | invention |
| | NK-21 | VGCF | 2.0 | 4.0 | C | C | C | Present |
| | | | | | | | | invention |
| Inorganic | Kc11 | — | — | — | E | E | F | Comparative |
| solid | | | | | | | | Example |
| electrolyte- | Kc12 | — | — | — | F | F | F | Comparative |
| containing | | | | | | | | Example |
| composition | Kc13 | — | — | — | F | F | F | Comparative |
| | | | | | | | | Example |
| | Kc14 | — | — | — | F | F | F | Comparative |
| | | | | | | | | Example |
| | Kc15 | — | — | — | F | F | F | Comparative |
| | | | | | | | | Example |
| | Kc16 | — | — | — | E | E | E | Comparative |
| | | | | | | | | Example |
| | Kc17 | — | — | — | F | E | E | Comparative |
| | | | | | | | | Example |
| Positive | PKc21 | AB | 1.2 | 1.8 | E | E | E | Comparative |
| electrode | | | | | | | | Example |
| composition | PKc22 | AB | 1.2 | 1.8 | F | F | F | Comparative |
| | | | | | | | | Example |
| | PKc23 | AB | 1.2 | 1.8 | F | F | F | Comparative |
| | | | | | | | | Example |
| | PKc24 | AB | 1.2 | 1.8 | F | F | F | Comparative |
| | | | | | | | | Example |
| | PKc25 | AB | 1.2 | 1.8 | F | F | F | Comparative |
| | | | | | | | | Example |
| | PKc26 | AB | 1.2 | 1.8 | E | E | E | Comparative |
| | | | | | | | | Example |
| | PKc27 | AB | 1.2 | 1.8 | F | E | F | Comparative |
| | | | | | | | | Example |
| Negative | NKc21 | VGCF | 2.0 | 4.0 | E | E | E | Comparative |
| electrode | | | | | | | | Example |
| composition | NKc22 | VGCF | 2.0 | 4.0 | F | F | F | Comparative |
| | | | | | | | | Example |
| | NKc23 | VGCF | 2.0 | 4.0 | F | F | F | Comparative |
| | | | | | | | | Example |
| | NKc24 | VGCF | 2.0 | 4.0 | F | F | F | Comparative |
| | | | | | | | | Example |
| | NKc25 | VGCF | 2.0 | 4.0 | F | F | F | Comparative |
| | | | | | | | | Example |
| | NKc26 | VGCF | 2.0 | 4.0 | E | E | E | Comparative |
| | | | | | | | | Example |
| | NKc27 | VGCF | 2.0 | 4.0 | F | E | E | Comparative |
| | | | | | | | | Example |

<Abbreviations in table>
LPS: LPS synthesized in Synthesis Example A
NMC: LiNi_{1/3}Co_{1/3}Mn_{1/3}O₂
Si: Silicon (APS of 1 to 5 μm, manufactured by Alfa Aesar)
AB: Acetylene black
VGCF: Carbon nanofiber

3. Production of Solid Electrolyte Sheet for all-Solid-State Secondary Battery
<Production of Solid Electrolyte Sheet for all-Solid-State Secondary Battery>

Each of the inorganic solid electrolyte-containing compositions shown in the column of “Solid electrolyte composition No.” of Table 3-1 or Table 3-4 obtained as described above was applied onto an aluminum foil having a thickness of 20 m using a baker type applicator (product name: SA-201, manufactured by Tester Sangyo Co., Ltd.) and heated at 80° C. for 2 hours to dry (to remove the dispersion medium) the inorganic solid electrolyte-containing composition. Thereafter, using a heat press machine, the inorganic solid electrolyte-containing composition which had been dried at a temperature of 120° C. and a pressure of 40 MPa for 10 seconds was heated and pressurized to produce each of solid electrolyte sheets 101 to 121 and c11 to c17 for an all-solid-state secondary battery (in Table 3-1 and Table 3-4, it is indicated as “Solid electrolyte sheet”). A film thickness of the solid electrolyte layer was 40 m.

<Production of Positive Electrode Sheet for all-Solid-State Secondary Battery>

Each of the positive electrode compositions obtained as described above, which is shown in the column of “Electrode composition No.” in Table 3-2 or Table 3-4, was applied onto an aluminum foil having a thickness of 20 m by using a baker type applicator (product name: SA-201), heating was carried out at 80° C. for 1 hour, and then heating was further carried out at 110° C. for 1 hour to dry (to remove the dispersion medium) the positive electrode composition. Thereafter, using a heat press machine, the dried positive electrode composition was pressurized (10 MPa, 1 minute) at 25° C. to produce each of positive electrode sheets 201 to 221, and c21 to c27 for an all-solid-state secondary battery, having a positive electrode active material layer having a film thickness of 70 m (in Table 3-2 and Table 3-4, it is indicated as “Positive electrode sheet”).

<Production of Negative Electrode Sheet for all-Solid-State Secondary Battery>

Each of the negative electrode compositions obtained as described above, which is shown in the column of “Electrode composition No.” in Table 3-3 or Table 3-4, was applied onto a copper foil having a thickness of 20 m by using a baker type applicator (product name: SA-201), heating was carried out at 80° C. for 1 hour, and then heating was further carried out at 110° C. for 1 hour to dry (to remove the dispersion medium) the negative electrode composition. Thereafter, using a heat press machine, the dried negative electrode composition was pressurized (10 MPa, 1 minute) at 25° C. to produce each of negative electrode sheets 301 to 321, and c31 to c37 for an all-solid state secondary battery, having a negative electrode active material layer having a film thickness of 60 μm (in Table 3-3 and Table 3-4, it is indicated as “Negative electrode sheet”).

TABLE 3

| | Inorganic solid | Binder | Electrode | Binder | | |
|---|---|---|---|---|---|---|
| Sheet | electrolyte-containing | polymer | composition | polymer | | |
| No. | composition No. | No. | No. | No. | Remark 1 | Remark 2 |
| 101 | K-1 | B-01 | — | — | Solid | Present |
| | | | | | electrolyte | invention |
| 102 | K-2 | B-02 | — | — | sheet | Present |
| | | | | | | invention |
| 103 | K-3 | B-03 | — | — | | Present |
| | | | | | | invention |
| 104 | K-4 | B-04 | | | | Present |
| | | | | | | invention |
| 105 | K-5 | B-05 | — | — | | Present |
| | | | | | | invention |
| 106 | K-6 | B-06 | — | — | | Present |
| | | | | | | invention |
| 107 | K-7 | B-07 | — | — | | Present |
| | | | | | | invention |
| 108 | K-8 | B-08 | — | — | | Present |
| | | | | | | invention |
| 109 | K-9 | B-09 | — | — | | Present |
| | | | | | | invention |
| 110 | K-10 | B-10 | — | — | | Present |
| | | | | | | invention |
| 111 | K-11 | B-11 | — | — | | Present |
| | | | | | | invention |
| 112 | K-12 | B-12 | — | — | | Present |
| | | | | | | invention |
| 113 | K-13 | B-13 | — | — | | Present |
| | | | | | | invention |
| 114 | K-14 | B-14 | | | | Present |
| | | | | | | invention |
| 115 | K-15 | B-15 | — | — | | Present |
| | | | | | | invention |
| 116 | K-16 | B-16 | — | — | | Present |
| | | | | | | invention |
| 117 | K-17 | B-17 | — | — | | Present |
| | | | | | | invention |
| 118 | K-18 | B-18 | — | — | | Present |
| | | | | | | invention |
| 119 | K-19 | B-19 | — | — | | Present |
| | | | | | | invention |
| 120 | K-20 | B-20 | — | — | | Present |
| | | | | | | invention |
| 121 | K-21 | B-21 | — | — | | Present |
| | | | | | | invention |
| 201 | — | — | PK-1 | B-01 | Positive | Present |
| | | | | | electrode | invention |
| 202 | — | — | PK-2 | B-02 | sheet | Present |
| | | | | | | invention |
| 203 | — | — | PK-3 | B-03 | | Present |
| | | | | | | invention |
| 204 | | | PK-4 | B-04 | | Present |
| | | | | | | invention |
| 205 | — | — | PK-5 | B-05 | | Present |
| | | | | | | invention |
| 206 | — | — | PK-6 | B-06 | | Present |
| | | | | | | invention |
| 207 | — | — | PK-7 | B-07 | | Present |
| | | | | | | invention |
| 208 | — | — | PK-8 | B-08 | | Present |
| | | | | | | invention |
| 209 | — | — | PK-9 | B-09 | | Present |
| | | | | | | invention |
| 210 | — | — | PK-10 | B-10 | | Present |
| | | | | | | invention |
| 211 | — | — | PK-11 | B-11 | | Present |
| | | | | | | invention |
| 212 | — | — | PK-12 | B-12 | | Present |
| | | | | | | invention |
| 213 | — | — | PK-13 | B-13 | | Present |
| | | | | | | invention |
| 214 | — | — | PK-14 | B-14 | | Present |
| | | | | | | invention |
| 215 | — | — | PK-15 | B-15 | | Present |
| | | | | | | invention |
| 216 | — | — | PK-16 | B-16 | | Present |
| | | | | | | invention |
| 217 | — | — | PK-17 | B-17 | | Present |
| | | | | | | invention |
| 218 | — | — | PK-18 | B-18 | | Present |
| | | | | | | invention |
| 219 | — | — | PK-19 | B-19 | | Present |
| | | | | | | invention |
| 220 | — | — | PK-20 | B-20 | | Present |
| | | | | | | invention |
| 221 | — | — | PK-21 | B-21 | | Present |
| | | | | | | invention |
| 301 | — | — | NK-1 | B-01 | Negative | Present |
| | | | | | electrode | invention |
| 302 | — | — | NK-2 | B-02 | sheet | Present |
| | | | | | | invention |
| 303 | — | — | NK-3 | B-03 | | Present |
| | | | | | | invention |
| 304 | — | — | NK-4 | B-04 | | Present |
| | | | | | | invention |
| 305 | — | — | NK-5 | B-05 | | Present |
| | | | | | | invention |
| 306 | — | — | NK-6 | B-06 | | Present |
| | | | | | | invention |
| 307 | — | — | NK-7 | B-07 | | Present |
| | | | | | | invention |
| 308 | — | — | NK-8 | B-08 | | Present |
| | | | | | | invention |
| 309 | — | — | NK-9 | B-09 | | Present |
| | | | | | | invention |
| 310 | — | — | NK-10 | B-10 | | Present |
| | | | | | | invention |
| 311 | — | — | NK-11 | B-11 | | Present |
| | | | | | | invention |
| 312 | — | — | NK-12 | B-12 | | Present |
| | | | | | | invention |
| 313 | — | — | NK-13 | B-13 | | Present |
| | | | | | | invention |
| 314 | — | — | NK-14 | B-14 | | Present |
| | | | | | | invention |
| 315 | — | — | NK-15 | B-15 | | Present |
| | | | | | | invention |
| 316 | — | — | NK-16 | B-16 | | Present |
| | | | | | | invention |
| 317 | — | — | NK-17 | B-17 | | Present |
| | | | | | | invention |
| 318 | — | — | NK-18 | B-18 | | Present |
| | | | | | | invention |
| 319 | — | — | NK-19 | B-19 | | Present |
| | | | | | | invention |
| 320 | — | — | NK-20 | B-20 | | Present |
| | | | | | | invention |
| 321 | — | — | NK-21 | B-21 | | Present |
| | | | | | | invention |
| c11 | Kc11 | T-1 | — | — | Solid | Comparative |
| | | | | | electrolyte | Example |
| c12 | Kc12 | T-2 | — | — | sheet | Comparative |
| | | | | | | Example |
| c13 | Kc13 | T-3 | | | | Comparative |
| | | | | | | Example |
| c14 | Kc14 | T-4 | — | — | | Comparative |
| | | | | | | Example |
| c15 | Kc15 | T-5 | — | — | | Comparative |
| | | | | | | Example |
| c16 | Kc16 | T-6 | | | | Comparative |
| | | | | | | Example |
| c17 | Kc17 | T-7 | — | — | | Comparative |
| | | | | | | Example |
| c21 | — | — | PKc21 | T-1 | Positive | Comparative |
| | | | | | electrode | Example |
| c22 | — | — | PKc22 | T-2 | sheet | Comparative |
| | | | | | | Example |
| c23 | — | — | PKc23 | T-3 | | Comparative |
| | | | | | | Example |
| c24 | — | — | PKc24 | T-4 | | Comparative |
| | | | | | | Example |
| c25 | — | — | PKc25 | T-5 | | Comparative |
| | | | | | | Example |
| c26 | — | — | PKc26 | T-6 | | Comparative |
| | | | | | | Example |
| c27 | — | — | PKc27 | T-7 | | Comparative |
| | | | | | | Example |
| c31 | — | — | NKc21 | T-1 | Negative | Comparative |
| | | | | | electrode | Example |
| c32 | — | — | NKc22 | T-2 | sheet | Comparative |
| | | | | | | Example |
| c33 | — | — | NKc23 | T-3 | | Comparative |
| | | | | | | Example |
| c34 | — | — | NKc24 | T-4 | | Comparative |
| | | | | | | Example |
| c35 | — | — | NKc25 | T-5 | | Comparative |
| | | | | | | Example |
| c36 | — | — | NKc26 | T-6 | | Comparative |
| | | | | | | Example |
| c37 | — | — | NKc27 | T-7 | | Comparative |
| | | | | | | Example |

4. Production of all-Solid-State Secondary Battery

First, each of a positive electrode sheet for an all-solid-state secondary battery, including a solid electrolyte layer, and a negative electrode sheet for an all-solid-state secondary battery, including a solid electrolyte layer, which would be used for manufacturing an all-solid-state secondary battery, was produced.

Production of Positive Electrode Sheet for all-Solid-State Secondary Battery, Including Solid Electrolyte Layer

The solid electrolyte sheet shown in the column of “Solid electrolyte layer (sheet No.)” of Table 4-1 and Table 4-3, prepared as described above, was overlaid on the positive electrode active material layer of each of the positive electrode sheets for an all-solid-state secondary battery shown in the column of “Electrode active material layer (sheet No.)” of Table 4-1 and Table 4-3 so that it came into contact with the positive electrode active material layer, transferred (laminated) by being pressurized at 50 MPa and 25° C. using a press machine, and then pressurized at 600 MPa and at 25° C., whereby each of positive electrode sheet Nos. 201 to 221, and c21 to c27 for an all-solid-state secondary battery having a thickness of 25 μm (thickness of positive electrode active material layer: 50 μm) was produced.

Production of Negative Electrode Sheet for all-Solid-State Secondary Battery, Including Solid Electrolyte Layer

Next, the solid electrolyte sheet shown in the column of “Solid electrolyte layer (sheet No.)” of Table 4-2 and Table 4-3, prepared as described above, was overlaid on the negative electrode active material layer of each of the negative electrode sheets for an all-solid-state secondary battery shown in the column of “Electrode active material layer (sheet No.)” of Table 4-2 and Table 4-3 so that it came into contact with the negative electrode active material layer, transferred (laminated) by being pressurized at 50 MPa and 25° C. using a press machine, and then pressurized at 600 MPa and at 25° C., whereby each of negative electrode sheets 301 to 321, and c31 to c37 for an all-solid-state secondary battery having a film thickness of 25 μm (thickness of negative electrode active material layer: 40 μm) was produced.

An all-solid-state secondary battery No. 401 having a layer configuration shown in FIG. 1 was produced as follows.

The positive electrode sheet No. 201 for an all-solid-state secondary battery (the aluminum foil of the solid electrolyte-containing sheet had been peeled off), which included the solid electrolyte layer obtained as described above, was cut out into a disk shape having a diameter of 14.5 mm and placed, as illustrated in FIG. 2, in a stainless 2032-type coin case 11 into which a spacer and a washer (not illustrated in FIG. 2) had been incorporated. Next, a lithium foil cut out in a disk shape having a diameter of 15 mm was overlaid on the solid electrolyte layer. After further overlaying a stainless steel foil thereon, the 2032-type coin case 11 was crimped to produce an all-solid-state secondary battery 13 (No. 401), shown in FIG. 2.

The all-solid-state secondary battery manufactured in this manner has a layer configuration illustrated in FIG. 1 (however, the lithium foil corresponds to a negative electrode active material layer 2 and a negative electrode collector 1).

All-solid-state secondary batteries No. 402 to 421 and c101 to c107 were produced as follows.

Each of all-solid state secondary batteries Nos. 402 to 421 and c101 to c107 was manufactured in the same manner as in the manufacturing of the all-solid-state secondary battery No. 401, except that in the manufacturing of the all-solid-state secondary battery No. 401, a negative electrode sheet for an all-solid-state secondary battery, which had a solid electrolyte layer and is indicated by No. shown in the column of “Electrode active material layer (sheet No.)” of Table 4-1 and Table 4-3 was used instead of the positive electrode sheet No. 201 for a secondary battery, which has a solid electrolyte layer.

An all-solid-state secondary battery No. 501 having a layer configuration illustrated in FIG. 1 was manufactured as follows.

The negative electrode sheet No. 301 for an all-solid-state secondary battery (the aluminum foil of the solid electrolyte-containing sheet had been peeled off), which included the solid electrolyte obtained as described above, was cut out into a disk shape having a diameter of 14.5 mm and placed, as shown in FIG. 2, in a stainless 2032-type coin case 11 into which a spacer and a washer (not illustrated in FIG. 2) had been incorporated. Next, a positive electrode sheet (a positive electrode active material layer) punched out from the positive electrode sheet for an all-solid-state secondary battery produced below into a disk shape having a diameter of 14.0 mm was overlaid on the solid electrolyte layer. A stainless steel foil (a positive electrode collector) was further layered thereon to form a laminate 12 for an all-solid-state secondary battery (a laminate consisting of stainless steel foil—aluminum foil—positive electrode active material layer—solid electrolyte layer—negative electrode active material layer—copper foil). Thereafter, the 2032-type coin case 11 was crimped to manufacture an all-solid-state secondary battery No. 501 shown in FIG. 2.

A positive electrode sheet for a solid state secondary battery to be used in the manufacturing of the all-solid-state secondary battery No. 501 was prepared as follows.

### Preparation of Positive Electrode Composition

180 beads of zirconia beads having a diameter of 5 mm were put into a 45 mL container made of zirconia (manufactured by Fritsch Japan Co., Ltd.), 2.7 g of LPS synthesized in the above Synthesis Example A, and 0.3 g of KYNAR FLEX 2500-20 (product name, PVdF-HFP: polyvinylidene fluoride—hexafluoropropylene copolymer, manufactured by Arkema S.A.) in terms of solid content mass and 22 g of butyl butyrate were put into the above container. The container was set in a planetary ball mill P-7 (product name, manufactured by Fritsch Japan Co., Ltd.) and the components were stirred for 60 minutes at 25° C. and a rotation speed of 300 rpm. Thereafter, 7.0 g of LiNi_{1/3}Co_{1/3}Mn_{1/3}O₂ (NMC) was put into the container as the positive electrode active material, and similarly, the container was set in a planetary ball mill P-7, mixing was continued at 25° C. and a rotation speed of 100 rpm for 5 minutes to prepare a positive electrode composition.

### Production of Positive Electrode Sheet for Solid State Secondary Battery

The positive electrode composition obtained as described above was applied onto an aluminum foil (a positive electrode collector) having a thickness of 20 m with a baker type applicator (product name: SA-201, manufactured by Tester Sangyo Co., Ltd.), heating was carried out at 100° C. for 2 hours to dry (to remove the dispersion medium) the positive electrode composition. Thereafter, using a heat press machine, the dried positive electrode composition was pressurized (10 MPa, 1 minute) at 25° C. to produce each of positive electrode sheets for an all-solid-state secondary battery, having a positive electrode active material layer having a film thickness of 80 m.

All-solid-state secondary batteries No. 502 to 521 and c201 to c207 were produced as follows.

Each of all-solid state secondary batteries Nos. 502 to 521 and c201 to c207 was manufactured in the same manner as in the manufacturing of the all-solid-state secondary battery No. 501, except that in the manufacturing of the all-solid-state secondary battery No. 501, a positive electrode sheet for an all-solid-state secondary battery, which had a solid electrolyte layer and is indicated by No. shown in the column of “Electrode active material layer (sheet No.)” of Table 4-2 and Table 4-3 was used instead of the negative electrode sheet No. 301 for a secondary battery, which had a solid electrolyte layer.

### <Evaluation 4: Measurement of Resistance>

Ion conductivity of each of the produced all-solid-state secondary batteries was measured to evaluate a resistance. Specifically, each of the all-solid-state secondary batteries was used as a sample for measuring ion conductivity, and an alternating current impedance was measured at a voltage amplitude of 5 mV and a frequency of 1 MHz to 1 Hz using 1255B FREQUENCY RESPONSE ANALYZER (product name, manufactured by Solartron Analytical) in a constant-temperature tank at 25° C. From the measurement result, a resistance of the sample for measuring ion conductivity in the layer thickness direction was determined, and the ion conductivity was determined by the calculation according to Expression (C1). The results are shown in Tables 4-1 to Table 4-3 (collectively referred to as Table 4).

Ion conductivity σ (mS/cm)=1000×Sample layer thickness (cm)/[Resistance (Ω)×Sample area (cm²)] Expression (C1)

In Expression (C1), the sample layer thickness is a value obtained by measuring the thickness before placing the laminate 12 in the 2032-type coin case 11 and subtracting the thickness of the collector (the total layer thickness of the solid electrolyte layer and the electrode active material layer). The sample area is the area of the disk-shaped sheet having a diameter of 14.5 mm.

It was determined where the obtained ion conductivity a was included in any of the following evaluation standards.

In the present test, the ion conductivity a was evaluated as a passing level in a case of “D” or higher. A large ion conductivity a means a small resistance, which is evident from Expression (C1).

### Evaluation Standard

$$\begin{matrix}A : 0.3 \leq σ \\ B : 0.25 \leq σ < 0. 30 \\ C : 0.2 \leq σ < 0.25 \\ D : 0.15 \leq σ < 0. 20 \\ E : 0.1 \leq σ < 0. 15 \\ F : σ < 0.1\end{matrix}$$

### <Evaluation 5: Cycle Characteristics>

A discharge capacity retention rate of each of the produced all-solid state secondary batteries was measured using a charging and discharging evaluation device TOSCAT-3000 (product name, manufactured by Toyo System Corporation).

Specifically, each of the all-solid state secondary batteries was charged in an environment of 25° C. at a current density of 0.1 mA/cm² until the battery voltage reached 4.3 V. Thereafter, the battery was discharged at a current density of 0.1 mA/cm² until the battery voltage reached 2.5 V. One charging operation and one discharging operation were set as one cycle of charging and discharging, and 3 cycles of charging and discharging were repeated under the same conditions to carry out initialization. Thereafter, the above-described charging and discharging cycle was repeated, and the discharge capacity of each of the all-solid state secondary batteries was measured at each time after the charging and discharging cycle was carried out with a charging and discharging evaluation device: TOSCAT-3000 (product name).

In a case where the discharge capacity (initial discharge capacity) of the first charging and discharging cycle after initialization is set to 100%, the battery characteristics (cycle characteristics) were evaluated by determining whether the number of charging and discharging cycles in a case where the discharge capacity retention rate (the discharge capacity with respect to the initial discharge capacity) reaches 80% was included in any of the following evaluation standards. In the present test, as the evaluation standard was higher, the battery characteristics (cycle characteristics) were more excellent, and the initial battery characteristics could be maintained even in a case where a plurality of times of charging and discharging are repeated (even in a case of the long-term use). In the present test, the cycle characteristics were evaluated as a passing level in a case of “C” or higher. The results are shown in Table 4.

All of the all-solid state secondary batteries Nos. 401 to 421 and 501 to 521 exhibited initial discharge capacity values sufficient for functioning as an all-solid-state secondary battery.

### Evaluation Standard

A: 600 cycles or more
B: 450 cycles or more and less than 600 cycles
C: 300 cycles or more and less than 450 cycles
D: 150 cycles or more and less than 300 cycles
E: 80 cycles or more and less than 150 cycles
F: 40 cycles or more and less than 80 cycles

TABLE 4

| | Layer configuration | | | | |
|---|---|---|---|---|---|
| | Electrode | Solid | | | |
| | active | electrolyte | | Cycle | |
| | material layer | layer | | charac- | |
| No. | (sheet No.) | (sheet No.) | Resistance | teristics | Remark |
| 401 | 201 | 101 | C | C | Present |
| | | | | | invention |
| 402 | 202 | 102 | B | B | Present |
| | | | | | invention |
| 403 | 203 | 103 | B | B | Present |
| | | | | | invention |
| 404 | 204 | 104 | A | A | Present |
| | | | | | invention |
| 405 | 205 | 105 | B | B | Present |
| | | | | | invention |
| 406 | 206 | 106 | A | A | Present |
| | | | | | invention |
| 407 | 207 | 107 | A | A | Present |
| | | | | | invention |
| 408 | 208 | 108 | A | A | Present |
| | | | | | invention |
| 409 | 209 | 109 | A | A | Present |
| | | | | | invention |
| 410 | 210 | 110 | A | B | Present |
| | | | | | invention |
| 411 | 211 | 111 | B | B | Present |
| | | | | | invention |
| 412 | 212 | 112 | B | B | Present |
| | | | | | invention |
| 413 | 213 | 113 | A | A | Present |
| | | | | | invention |
| 414 | 214 | 114 | B | B | Present |
| | | | | | invention |
| 415 | 215 | 115 | A | B | Present |
| | | | | | invention |
| 416 | 216 | 116 | A | A | Present |
| | | | | | invention |
| 417 | 217 | 117 | B | B | Present |
| | | | | | invention |
| 418 | 218 | 118 | B | B | Present |
| | | | | | invention |
| 419 | 219 | 119 | B | B | Present |
| | | | | | invention |
| 420 | 220 | 120 | B | B | Present |
| | | | | | invention |
| 421 | 221 | 121 | C | C | Present |
| | | | | | invention |
| 501 | 301 | 101 | C | C | Present |
| | | | | | invention |
| 502 | 302 | 102 | B | B | Present |
| | | | | | invention |
| 503 | 303 | 103 | B | B | Present |
| | | | | | invention |
| 504 | 304 | 104 | A | A | Present |
| | | | | | invention |
| 505 | 305 | 105 | B | B | Present |
| | | | | | invention |
| 506 | 306 | 106 | A | A | Present |
| | | | | | invention |
| 507 | 307 | 107 | A | A | Present |
| | | | | | invention |
| 508 | 308 | 108 | A | A | Present |
| | | | | | invention |
| 509 | 309 | 109 | A | A | Present |
| | | | | | invention |
| 510 | 310 | 110 | A | B | Present |
| | | | | | invention |
| 511 | 311 | 111 | B | B | Present |
| | | | | | invention |
| 512 | 312 | 112 | B | B | Present |
| | | | | | invention |
| 513 | 313 | 113 | A | A | Present |
| | | | | | invention |
| 514 | 314 | 114 | B | B | Present |
| | | | | | invention |
| 515 | 315 | 115 | A | B | Present |
| | | | | | invention |
| 516 | 316 | 116 | A | A | Present |
| | | | | | invention |
| 517 | 317 | 117 | B | B | Present |
| | | | | | invention |
| 518 | 318 | 118 | B | B | Present |
| | | | | | invention |
| 519 | 319 | 119 | B | B | Present |
| | | | | | invention |
| 520 | 320 | 120 | B | B | Present |
| | | | | | invention |
| 521 | 321 | 121 | C | C | Present |
| | | | | | invention |
| c101 | c21 | c11 | E | D | Comparative |
| | | | | | Example |
| c102 | c22 | c12 | F | F | Comparative |
| | | | | | Example |
| c103 | c23 | c13 | F | F | Comparative |
| | | | | | Example |
| c104 | c24 | c14 | F | F | Comparative |
| | | | | | Example |
| c105 | c25 | c15 | F | F | Comparative |
| | | | | | Example |
| c106 | c26 | c16 | E | D | Comparative |
| | | | | | Example |
| c107 | c27 | c17 | E | E | Comparative |
| | | | | | Example |
| c201 | c31 | c11 | E | D | Comparative |
| | | | | | Example |
| c202 | c32 | c12 | F | F | Comparative |
| | | | | | Example |
| c203 | c33 | c13 | F | F | Comparative |
| | | | | | Example |
| c204 | c34 | c14 | F | F | Comparative |
| | | | | | Example |
| c205 | c35 | c15 | F | F | Comparative |
| | | | | | Example |
| c206 | c36 | c16 | E | D | Comparative |
| | | | | | Example |
| c207 | c37 | c17 | E | E | Comparative |
| | | | | | Example |

The following facts could be found from the results of Table 1 to Table 4.

In a case where a polymer other than the polymer which had the constitutional component (X) including a polymerized chain and having a molecular weight of 400 or more, and had a viscosity of 0.10 to 10,000 Pa·s at a temperature of 25° C. and a shear rate of 1 s⁻¹ was used in combination with the solid particles, the dispersion time of the solid particles could not be shortened, and the obtained inorganic solid electrolyte-containing composition was deteriorated in dispersion stability and handleability. The all-solid-state secondary battery produced using such an inorganic solid electrolyte-containing composition was deteriorated in battery resistance and cycle characteristics.

On the other hand, in a case where the polymer according to the embodiment of the present invention, which had the constitutional component (X) including a polymerized chain and having a molecular weight of 400 or more, and had a viscosity of 0.10 to 10,000 Pa·s at a temperature of 25° C. and a shear rate of 1 s⁻¹, was used in combination with the solid particles, the dispersion time of the solid particles could be shortened, and the solid particles could be dispersed in the dispersion medium as desired, and an inorganic solid electrolyte-containing composition having excellent dispersion stability and handleability could be prepared. The all-solid-state secondary battery produced using such an inorganic solid electrolyte-containing composition having excellent dispersion characteristics had a small battery resistance (conductivity) and excellent cycle characteristics.

The present invention has been described with the embodiments thereof, any details of the description of the present invention are not limited unless otherwise specified, and it is obvious that the present invention is widely construed without departing from the gist and scope of the present invention described in the accompanying claims.

The present application claims the priority of JP2023-108490 filed in Japan on Jun. 30, 2023, the contents of which are incorporated herein by reference, as a part of the description of the present specification.

### EXPLANATION OF REFERENCES

1: negative electrode collector
2: negative electrode active material layer
3: solid electrolyte layer
4: positive electrode active material layer
5: positive electrode collector
6: operation portion
10: all-solid-state secondary battery
11: 2032-type coin case
12: laminate for all-solid-state secondary battery
13: coin-type all-solid-state secondary battery

What is claimed is:

1. A dispersant polymer for a non-aqueous secondary battery, comprising:
a constitutional component (X) which includes a polymerized chain and has a molecular weight of 400 or more,
wherein a viscosity at a temperature of 25° C. and a shear rate of 1 s⁻¹ is 0.10 to 10,000 Pa·s.

2. The dispersant polymer for a non-aqueous secondary battery according to claim 1, further comprising:
a constitutional component (A) which has at least one polar functional group of the following group (a) of functional groups,
<Group (a) of functional groups>
a sulfonic acid group, a phosphoric acid group, a phosphonic acid group, a hydroxy group, a carboxy group, an oxetane group, an epoxy group, a dicarboxylic acid group, a thiol group, an ether group, a thioether group, a thioester group, an ester group, an amide group, a urethane group, a urea group, an imide group, a fluoroalkyl group, and salts of these groups.

3. The dispersant polymer for a non-aqueous secondary battery according to claim 1,
wherein an SP value of a polymer chain in the dispersant polymer for a non-aqueous secondary battery is 15.0 to 25.0 MPa^{1/2}.

4. The dispersant polymer for a non-aqueous secondary battery according to claim 1,
wherein the dispersant polymer has a multibranched structure having a core portion and at least three polymeric arm portions.

5. The dispersant polymer for a non-aqueous secondary battery according to claim 1,
wherein the dispersant polymer is a multibranched polymer represented by Formula (1), 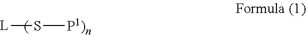
in Formula (1), L represents an n-valent linking group,
P¹ represents a polymer chain, where n pieces of P¹'s may be the same or different from each other, and
n represents an integer of 3 or more.

6. A composition for a non-aqueous secondary battery, comprising:
the dispersant polymer for a non-aqueous secondary battery according to claim 1.

7. The composition for a non-aqueous secondary battery according to claim 6, further comprising:
an inorganic solid electrolyte having ionic conductivity of a metal belonging to Group 1 or Group 2 in the periodic table.

8. The composition for a non-aqueous secondary battery according to claim 7,
wherein the inorganic solid electrolyte is a sulfide-based inorganic solid electrolyte.

9. The composition for a non-aqueous secondary battery according to claim 6, further comprising:
an active material.

10. A sheet for an all-solid-state secondary battery, comprising:
a layer formed of the composition for a non-aqueous secondary battery according to claim 6.

11. A sheet for an all-solid-state secondary battery, comprising:
a layer formed of the composition for a non-aqueous secondary battery according to claim 7.

12. An all-solid-state secondary battery comprising, in the following order:
a positive electrode active material layer;
a solid electrolyte layer; and
a negative electrode active material layer,
wherein at least one of the positive electrode active material layer, the solid electrolyte layer, or the negative electrode active material layer is a layer formed of the composition for a non-aqueous secondary battery according to claim 6.

13. An all-solid-state secondary battery comprising, in the following order:
a positive electrode active material layer;
a solid electrolyte layer; and
a negative electrode active material layer,
wherein at least one of the positive electrode active material layer, the solid electrolyte layer, or the negative electrode active material layer is a layer formed of the composition for a non-aqueous secondary battery according to claim 7.

14. A manufacturing method of a sheet for an all-solid-state secondary battery, comprising:
forming the composition for a non-aqueous secondary battery according to claim 6 into a film.

15. A manufacturing method of an all-solid-state secondary battery, comprising:
manufacturing an all-solid-state secondary battery through the manufacturing method according to claim 14.

16. The dispersant polymer for a non-aqueous secondary battery according to claim 2,
wherein the constitutional component (A) has at least one polar functional group of a sulfonic acid group, a phosphoric acid group, a phosphonic acid group, a hydroxy group, an oxetane group, an epoxy group, a thiol group, a thioether group, a thioester group, an amide group, a urethane group, a urea group, an imide group, a fluoroalkyl group, and salts of these groups.

17. The dispersant polymer for a non-aqueous secondary battery according to claim 2,
wherein the constitutional component (A) has an amide group.

18. The dispersant polymer for a non-aqueous secondary battery according to claim 1,
wherein the dispersant polymer has a graft structure.
